(19) United States
(12) Patent Application Publication
(10) Pub. No.: US 2025/0363841 A1
(43) Pub. Date: Nov. 27, 2025

(54) TRAVEL STORAGE SYSTEM, TRAVEL STORAGE METHOD, AND VIDEO RECORDING SYSTEM

(71) Applicant: DENSO CORPORATION, Kariya-city (JP)

(72) Inventors: Yotaro MOTEGI, Nisshin-city (JP); Jingyu XIANG, Nisshin-city (JP); Yu MAEDA, Nisshin-city (JP); Taiki KAWANO, Nisshin-city (JP); Hiroyuki OSAWA, Kariya-city (JP)

(21) Appl. No.: 19/293,816

(22) Filed: Aug. 7, 2025

Related U.S. Application Data
(63) Continuation of application No. 17/647,936, filed on Jan. 13, 2022.
Application No. 17/647,936 is a continuation of application No. PCT/JP2020/027374, filed on Jul. 14, 2020.

(30) Foreign Application Priority Data
Jul. 15, 2019 (JP) 2019-130771
Jul. 16, 2019 (JP) 2019-131256

(51) Int. Cl. G07C 5/08; B60W 40/04; B60W 60/00; G06V 20/56; G06V 20/59

(52) U.S. Cl. CPC G07C 5/0866; B60W 40/04; B60W 60/005; G06V 20/56; G06V 20/59; B60W 2420/403; B60W 2554/4041; B60W 2554/4046

(57) ABSTRACT

A travel storage system includes: a target vehicle behavior determination unit that is configured to: acquire a sensor value indicative of a behavior of each of surrounding vehicles around the host vehicle; and sequentially determine a relative behavior of a target vehicle with respect to the host vehicle based on the sensor value; a rule acquisition unit that acquires an accident liability rule in a current position of the host vehicle; a potential accident liability information determination unit that sequentially determines, using liability determination information, potential accident liability information indicative of whether the host vehicle is liable for a potentially assumed accident between the target vehicle and the host vehicle; and a storage unit that stores the potential accident liability information and the liability determination information in association with each other or in associable with each other.

### CROSS REFERENCE TO RELATED APPLICATION

This application is a continuation application U.S. patent application Ser. No. 17/647,936 filed on Jan. 13, 2022, which is a continuation application of International Patent Application No. PCT/JP2020/027374 filed on Jul. 14, 2020, which designated the U.S. and claims the benefit of priority from Japanese Patent Application No. 2019-130771 filed on Jul. 15, 2019 and Japanese Patent Application No. 2019-131256 filed on Jul. 16, 2019. The entire disclosure of all of the above applications is incorporated herein by reference.

### TECHNICAL FIELD

This disclosure relates to a travel storage system, a travel storage method, and a video recording system.

### BACKGROUND

There has been known a device which calculates a potential accident liability value (hereinafter referred to as a potential accident liability value) by estimating the driving state of a target vehicle and comparing the driving state with a driving rule. This device stores the calculated potential accident liability value and outputs the same after an accident.

There has been also known a technique of capturing and saving an image in front of a vehicle in its traveling direction by a camera when it is detected that a collision has occurred or the possibility of the collision is high in order to make it possible to specify the accident cause of the vehicle. Further, automatic driving which automates the driving operation of a vehicle has been known. In regard to the degree of automatic driving, there may be a plurality of stages, for example, as defined by the Society of Automotive Engineers (SAE). For example, in a vehicle in which the driving operation is fully automated, it is assumed that an occupant will no longer take legal responsibility as a driver, such as the obligation to monitor the safety of the surrounding area. The description contents of the prior art document are incorporated by reference as an explanation of the technical elements in the present specification.

### SUMMARY

According to one aspect of the present disclosure, a travel storage system mounted in a host vehicle includes: a target vehicle behavior determination unit that is configured to: acquire a sensor value from a sensor, the sensor value indicative of a behavior of each of surrounding vehicles around the host vehicle; and sequentially determine a relative behavior of a target vehicle selected from the surrounding vehicles with respect to the host vehicle based on the sensor value; a rule acquisition unit that is configured to acquire an accident liability rule in a current position of the host vehicle; a potential accident liability information determination unit that is configured to sequentially determine, using liability determination information, potential accident liability information indicative of whether the host vehicle is liable for a potentially assumed accident between the target vehicle and the host vehicle based on the relative behavior of the target vehicle and the accident liability rule acquired by the rule acquisition unit; and a storage unit that is configured to store the potential accident liability information and the liability determination information in association with each other or in associable with each other.

### BRIEF DESCRIPTION OF DRAWINGS

FIG. 1 is a diagram showing a configuration of a potential accident liability value determination device of a first embodiment.

FIG. 2 is a flowchart showing processing executed by the potential accident liability value determination device.

FIG. 3 is a flowchart showing processing of taking out potential accident information.

FIG. 4 is a diagram showing a configuration of a potential accident liability value determination device of a second embodiment.

FIG. 5 is a diagram showing processing executed by the potential accident liability value determination device.

FIG. 6 is a diagram showing a configuration of a potential accident liability value determination device of a third embodiment.

FIG. 7 is a diagram showing processing executed by the potential accident liability value determination device.

FIG. 8 is a diagram showing processing executed by a wireless communication unit 360 when other vehicle potential accident information is received.

FIG. 9 is a diagram showing a configuration of a potential accident liability value determination device of a fourth embodiment.

FIG. 10 is a diagram showing processing executed by the potential accident liability value determination device.

FIG. 11 is a diagram showing a configuration of a potential accident liability value determination device of a fifth embodiment.

FIG. 12 is a diagram describing related surrounding vehicles.

FIG. 13 is a diagram showing an example of processing executed by a peripheral information acquisition unit.

FIG. 14 is a diagram showing processing when a host vehicle and a peripheral vehicle perform time synchronization.

FIG. 15 is a diagram showing processing executed by a potential accident liability value determination device of a sixth embodiment.

FIG. 16 is a diagram processing executed by a liability value server in the sixth embodiment.

FIG. 17 is a diagram showing a potential accident liability value determination device 700 of a seventh embodiment.

FIG. 18 is a diagram showing time correction processing executed by a time correction unit.

FIG. 19 is a diagram showing processing executed by a target vehicle behavior determination unit.

FIG. 20 is a diagram showing processing executed by a potential accident liability value determination unit.

FIG. 21 is a diagram showing a configuration of a potential accident liability value determination device of an eighth embodiment.

FIG. 22 is a flowchart showing processing executed by the potential accident liability value determination device.

FIG. 23 is a flowchart showing detailed processing of S132 in FIG. 22.

FIG. 24 is a diagram showing a schematic configuration of a vehicle system and an automatic driving device.

FIG. 25 is a diagram showing an example of the arrangement of a vehicle external camera.

FIG. 26 is a diagram showing a schematic configuration of a video processing device.

FIG. 27 is a diagram showing an example of the flow of video storage related processing in the video processing device.

FIG. 28 is a diagram showing an example of a schematic configuration of a video processing device.

FIG. 29 is a diagram showing a configuration of a vehicle system of a twenty first embodiment.

FIG. 30 is a diagram showing a configuration that a video processing device of FIG. 29 has.

FIG. 31 is a diagram showing a configuration of a travel storage system of a thirty first embodiment.

### DETAILED DESCRIPTION

To begin with, a relevant technology of the present disclosure will be described only for understanding the following embodiments.

In the event of an accident, the potential accident liability value can be used when determining liability of the accident for a vehicle involved in the accident. In order to use the potential accident liability value to determine the liability of the accident for the vehicle involved in the accident, the potential accident liability value must be high in reliability. However, the potential accident liability value is just a scalar value and may be tampered with. It is thus desirable to be able to confirm the reliability of the potential accident liability value. Further, even if the potential accident liability value has not been tampered with, the algorithm for determining the potential accident liability value may differ where the manufacturer, version, etc. of a device are different. Then, even in the same situation, the value of the potential accident liability value may differ depending on the manufacturer, version, etc. of the device. Therefore, it is desired that the reliability of the potential accident liability value can be confirmed later by another device.

Further, the potential accident liability value is a value determined by a predetermined determination method. On the other hand, there are various situations in which an actual accident occurs. Thus, even if the potential accident liability value has not been tampered with, it is possible that the potential accident liability value does not properly represent the liability of the vehicle that has caused the accident when considering the surrounding conditions. Even in this respect, it is desirable to be able to confirm whether the potential accident liability value is reliable. Further, it is desirable to be able to confirm whether or not the presence or absence of the liability that can be determined from the potential accident liability value is also reliable. In the following, the concept including the potential accident liability value and the presence or absence of the liability that can be determined from the potential accident liability value is assumed to be potential accident liability information.

In a relevant technique, when the occurrence of a collision or the high possibility of a collision is detected, the image in front of the vehicle in its traveling direction is stored. However, when the host vehicle is a vehicle capable of switching the degree of automatic driving (hereinafter referred to as an automatic driving level), it is difficult to distinguish between the traveling image during automatic driving and the traveling image during non-automatic driving from the stored image. Thus, in the event of an accident, it is difficult to prove from the stored image that there is no liability for the automatic driving of the host vehicle. Further, even when an accident occurs between vehicles around the host vehicle, it is difficult to prove from the stored image that there is no liability for the automatic driving of the host vehicle.

One objective of this disclosure is to provide a travel storage system, a potential accident liability determination device, a travel recording method, and a potential accident liability determination method which enable confirmation of the reliability of potential accident liability information. Another objective of this disclosure is to provide a video recording system, an automatic driving system, and a video recording method capable of making it easier to prove that the automatic driving is not liable for the occurrence of an accident in a vehicle that can switch between automatic driving and non-automatic driving which does not perform the automatic driving.

The above objectives are achieved by a combination of the features described in the independent claims, and the sub-claims provide further advantageous specific examples.

As described above, the one aspect of the present disclosure is a travel storage system mounted in a host vehicle includes: a target vehicle behavior determination unit that is configured to: acquire a sensor value from a sensor, the sensor value indicative of a behavior of each of surrounding vehicles around the host vehicle; and sequentially determine a relative behavior of a target vehicle selected from the surrounding vehicles with respect to the host vehicle based on the sensor value; a rule acquisition unit that is configured to acquire an accident liability rule in a current position of the host vehicle; a potential accident liability information determination unit that is configured to sequentially determine, using liability determination information, potential accident liability information indicative of whether the host vehicle is liable for a potentially assumed accident between the target vehicle and the host vehicle based on the relative behavior of the target vehicle and the accident liability rule acquired by the rule acquisition unit; and a storage unit that is configured to store the potential accident liability information and the liability determination information in association with each other or in associable with each other.

In another aspect of the present disclosure, a travel storage method includes the steps of: acquiring a sensor value from a sensor, the sensor value indicative of a behavior of each of surrounding vehicles around a host vehicle; sequentially determining, based on the sensor value, a relative behavior of a target vehicle selected from the surrounding vehicles with respect to the host vehicle; acquiring an accident liability rule in a current position of the host vehicle; sequentially determining, based on both the relative behavior of the target vehicle and the accident liability rule, potential accident liability information using liability determination information, the potential accident liability information being indicative of whether the host vehicle is liable for a potentially assumed accident between the target vehicle and the host vehicle; and storing the potential accident liability information and the liability determination information in a storage unit in association with each other or in associable with each other.

In this travel storage system and travel storage method, the liability determination information is stored in association with or in associable with the potential accident liability information. By doing so, it is possible to determine the potential accident liability information ex post by using the liability determination information. The potential accident liability information determined ex post is stored in association with the liability determination information. Alternatively, by comparing the liability determination information with the potential accident liability information stored associable therewith, the reliability of the potential accident liability information can be confirmed later.

In yet another aspect of the present disclosure, a potential accident liability determination device includes a liability determination information acquisition unit which acquires liability determination information being information used to determine potential accident liability information indicating the presence or absence of liability of a liability determination vehicle being a vehicle to determine the potential accident liability information with respect to a potentially assumed accident between the liability determination vehicle and a target vehicle selected from surrounding vehicles existing around the liability determination vehicle; and a potential accident liability information determination unit which determines the potential accident liability information, based a preset relationship which determines the potential accident liability information from the liability determination information, and the liability determination information acquired by the liability determination information acquisition unit. The potential accident liability determination device is installed outside the liability determination vehicle.

In yet another aspect of the present disclosure, a potential accident liability determination method is executed outside a liability determination vehicle. The method includes the steps of: acquiring liability determination information being information used to determine potential accident liability information indicating the presence or absence of liability of the liability determination vehicle for a potentially assumed accident between the liability determination vehicle and a target vehicle selected from surrounding vehicles existing around the liability determination vehicle; and determining the potential accident liability information, based on a preset relationship which determines the potential accident liability information from the liability determination information, and the acquired liability determination information.

This potential accident liability determination device and potential accident liability determination method can acquire liability determination information and determine potential accident liability information, based on the liability determination information. Therefore, when the potential accident liability determination device acquires the liability determination information ex post, and when the liability determination information is acquired ex post by the potential accident liability determination method, the potential accident liability information can be determined ex post. By comparing the potential accident liability information determined ex post with the potential accident liability information determined by a device other than this potential accident liability determination device or the device that executes this potential accident liability determination method, the reliability of the potential accident liability information can be confirmed later. As the device other than the potential accident liability determination device or the device that executes the potential accident liability determination method, for example, when the potential accident liability determination device or the device that executes the potential accident liability determination method is installed other than the liability determination vehicle, the device installed in the liability determination vehicle can be exemplified.

In yet another aspect of the present disclosure, a potential accident liability determination device includes: a liability determination information acquisition unit which acquires liability determination information being information used to determine potential accident liability information indicating the presence or absence of liability of a liability determination vehicle being a vehicle to determine the potential accident liability information with respect to a potentially assumed accident between the liability determination vehicle and a target vehicle selected from surrounding vehicles existing around the liability determination vehicle; a potential accident liability information determination unit which determines the potential accident liability information, based a preset relationship which determines the potential accident liability information from the liability determination information, and the liability determination information acquired by the liability determination information acquisition unit; and a peripheral information acquisition unit which acquires from each of the related surrounding vehicles each being the peripheral vehicle other than the target vehicle among the surrounding vehicles, peripheral liability determination information used to determine peripheral potential accident liability information indicating the presence or absence of liability of the related peripheral vehicle for a potentially assumed accident between the related peripheral vehicle and each vehicle existing around the related peripheral vehicle.

In yet another aspect of the present disclosure, a potential accident liability determination method includes the steps of: acquiring liability determination information being information used to determine potential accident liability information indicating the presence or absence of liability of the liability determination vehicle for a potentially assumed accident between the liability determination vehicle and a target vehicle selected from surrounding vehicles existing around the liability determination vehicle; determining the potential accident liability information, based on a preset relationship which determines the potential accident liability information from the liability determination information, and the acquired liability determination information; and acquiring from each of the related surrounding vehicles each being the peripheral vehicle other than the target vehicle among the surrounding vehicles, peripheral liability determination information used to determine peripheral potential accident liability information indicating the presence or absence of liability of the related peripheral vehicle for a potentially assumed accident between the related peripheral vehicle and each vehicle existing around the related peripheral vehicle.

According to this potential accident liability determination device and potential accident liability determination method, it is possible to directly determine whether or not the situation is such that it can be recognized that there are many parts of the cause of the accident in the behavior of the related surrounding vehicles even if there is an accident problem in the behavior of the liability determination vehicle. As a result of the determination, it is possible to confirm whether or not the potential accident liability information appropriately represents the liability of the accident for the liability determination vehicle, that is, the reliability of the potential accident liability information.

In yet another aspect of the present disclosure, a video recording system is used for a vehicle that is configured to switch a driving state between automatic driving and non-automatic driving. The system includes: a video acquisition unit that is configured to sequentially acquire an accident confirmation image from an in-vehicle camera, the accident confirmation image being used to confirm a situation of an accident when the accident occurs against, or around, the host vehicle; a driving specifying unit that is configured to specify, using driving state specifying information, the driving state of the vehicle at a timing the accident confirmation image is acquired; and a storage processing unit that is configured to store the accident confirmation image and the driving state specifying information in association with each other or in associable with each other.

In yet another aspect of the present disclosure, a video recording method is used in a vehicle capable of switching between automatic driving and non-automatic driving which does not perform the automatic driving. The method includes the steps of: sequentially acquiring an accident confirmation image from an in-vehicle camera which shoots the accident confirmation image being an image having a possibility of being capable of, when an accident occurs in or around the vehicle, confirming the situation of the accident; specifying whether or not the vehicle is in a driving state of either the automatic driving or the non-automatic driving; and storing the sequentially-acquired accident confirmation image and information capable of specifying the driving state of the vehicle at the time when the accident confirmation image is acquired, in association with each other or in associable with each other in a recording device.

According to the above video recording system and video recording method, an accident confirmation image being an image that may be able to confirm the accident situation when an accident occurs in or around the vehicle, is stored in the recording device. Therefore, it becomes easier to investigate the cause of the accident based on the accident confirmation image.

Further, the accident confirmation image is associated with information that can specify whether the driving state of the vehicle at the time when the accident confirmation image is acquired is automatic driving or non-automatic driving. Therefore, it is possible to specify whether the driving state of the vehicle at the time when the accident confirmation image is acquired is the automatic driving or the non-automatic driving. Thus, when it can be confirmed from the accident confirmation image that an accident has occurred, it becomes easy to distinguish whether the accident is during the automatic driving or the non-automatic driving. Therefore, even if it is determined from the accident confirmation image that the host vehicle is liable for the occurrence of the accident, it is possible to prove that the host vehicle is not liable for the autonomous driving by distinguishing whether the accident confirmation image is for the automatic driving or the non-automatic driving. As a result, in each vehicle that can switch between the automatic driving and the non-automatic driving which does not perform this automatic driving, it becomes possible to make it easier to prove that the automatic driving is not liable for the occurrence of the accident.

In yet another aspect of the present disclosure, an automatic driving system is used in a vehicle capable of switching between automatic driving and non-automatic driving which does not perform the automatic driving. The system includes: a video recording system; a traveling environment recognition unit which recognizes a traveling environment of the vehicle by using the result of detection by a peripheral monitoring sensor monitoring the periphery of the vehicle; a traveling planning unit which, using the traveling environment recognized by the traveling environment recognition unit, generates a traveling plan for driving the vehicle in the automatic driving; and an automatic driving function unit which causes driving control of the vehicle to be performed according to the traveling plan generated by the traveling planning unit.

According to this, since the above-mentioned video recording system is included, it becomes possible to make it easier to prove that the automatic driving is not liable for the occurrence of an accident in a vehicle that can switch between automatic driving and non-automatic driving.

Hereinafter, embodiments will be described based on the drawings.

### First Embodiment

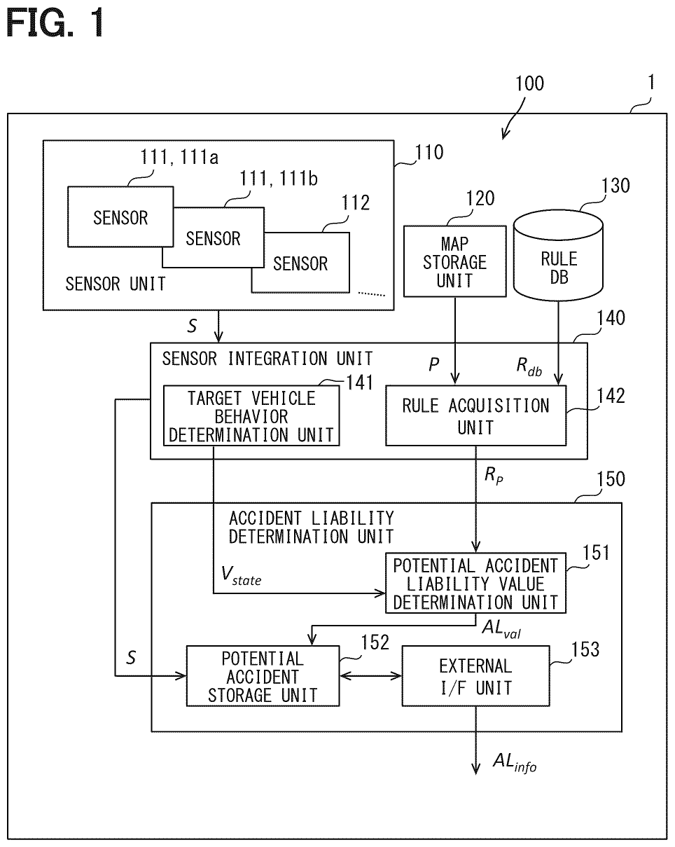

FIG. 1 is a diagram showing a configuration of a potential accident liability value determination device 100 of a first embodiment. The potential accident liability value determination device 100 also has functions as a travel storage device and a travel storage system. The potential accident liability value determination device 100 is mounted on a host vehicle 1. When using a certain potential accident liability value determination device 100 as a reference, the host vehicle 1 is a vehicle on which this potential accident liability value determination device 100 is mounted.

The vehicle is not limited in particular as long as it is a vehicle traveling on the road. Vehicles include ordinary passenger cars, trucks, and buses. The potential accident liability value determination device 100 sequentially determines a potential accident liability value ALᵥₐₗ. The potential accident liability value ALᵥₐₗ is a scalar value indicating the extent of liability of the host vehicle 1 in the event that an accident occurs between a target vehicle selected from surrounding vehicles existing around the host vehicle 1 and the host vehicle 1. Since it means “when an accident occurs”, no accident has occurred yet. Since this accident is an accident that has not occurred yet, it is a potentially possible accident. By comparing this potential accident liability value ALᵥₐₗ and a predetermined threshold value for determining the presence or absence of liability with each other, the presence or absence of liability of the host vehicle 1 can be known. Accordingly, the potential accident liability value ALᵥₐₗ is information indicating the presence or absence of the liability of the host vehicle 1. That is, the potential accident liability value ALᵥₐₗ is an example of the potential accident liability information indicating the presence or absence of the liability of the host vehicle 1. The above threshold value is, for example, 0. The potential accident liability value ALᵥₐₗ is determined for each of a plurality of surrounding vehicles existing around the host vehicle 1.

The potential accident liability value determination device 100 is also mounted on a vehicle other than the host vehicle 1. The potential accident liability value determination device 100 is mounted on a plurality of vehicles. Each potential accident liability value determination device 100 sequentially determines the potential accident liability value ALᵥₐₗ with the vehicle equipped with the potential accident liability value determination device 100 as the host vehicle 1.

The potential accident liability value determination device 100 includes a sensor unit 110, a map storage unit 120, a rule DB storage unit 130, a sensor integration unit 140, and an accident liability determination unit 150.

The sensor unit 110 includes a plurality of sensors 111 and 112. The sensor 111 is a sensor which detects a behavior of the peripheral vehicle. The sensor 111 outputs a sensor value S indicating the behavior of the peripheral vehicle. The sensor 111 can include a camera. Other than the above, the sensor 111 can also include a millimeter-wave radar and LIDAR. In FIG. 1, there are shown sensors 111a and 111b as the sensors 111. When these sensors 111a and 111b are not distinguished, they are described as the sensor 111. Further, the sensor 111 may be of one type or a plurality of three or more types.

The sensor 112 is a host vehicle behavior sensor which detects the position of the host vehicle 1 and the behavior of the host vehicle 1. If the current position (hereinafter referred to as the host vehicle position) P of the host vehicle 1 can be sequentially detected, the speed and the traveling direction of the host vehicle 1, which are the behavior of the host vehicle 1, can be determined. Therefore, the sensor 112 may be only a sensor which detects the current host vehicle position P. The sensor 112 can also include a GNSS receiver for detecting the position of the host vehicle 1. In addition to the above, the sensor 112 can include a vehicle speed sensor, a yaw rate sensor, an acceleration sensor, and the like. Although one sensor 112 is shown in FIG. 1, the number of sensors 112 may be plural. Further, the current host vehicle position P can be detected by collating a shape around the host vehicle 1 detected by LIDAR or the like with a high-precision map. In this case, the sensor 111 is also used as the sensor 112. Thus, the sensor 111 may be utilized as the sensor 112 without providing a dedicated sensor 112.

The map storage unit 120 is a storage unit which stores a digital road map. The digital road map may be the above-mentioned high-precision map, or may be a normal road map which is not the high-precision map. The high-precision map is a map which also shows the positions of road markings such as lanes lying on the road, the types and positions of road signs, and three-dimensional objects around the road, etc. In the present specification, the storage unit includes a tangible storage medium which can be read by a computer. As the storage medium, for example, a flash memory can be used. The rule DB storage unit 130 is a storage unit in which a rule database (hereinafter referred to as rule DB) is stored. The rule DB is a database in which driving rules for each location are stored. The driving rules for each location include traffic directions such as a one-way traffic, speed limits, and a distinction between priority and non-priority, etc.

The sensor integration unit 140 and the potential accident liability value determination unit 151 of the accident liability determination unit 150 can be realized by a configuration including at least one processor. For example, the sensor integration unit 140 and the potential accident liability value determination unit 151 can be realized by a computer including a CPU, a ROM, a RAM, I/O, and a bus line connecting these configurations, etc. The ROM stores a program for causing a general-purpose computer to function as the sensor integration unit 140 and the potential accident liability value determination unit 151. When the CPU executes the program stored in the ROM while using a temporary storage function of the RAM, the computer functions as the sensor integration unit 140 and the potential accident liability value determination unit 151. The execution of these functions means that a method corresponding to the program is executed.

The sensor integration unit 140 includes a target vehicle behavior determination unit 141 and a rule acquisition unit 142. The target vehicle behavior determination unit 141 acquires the sensor value S from the sensor unit 110. Then, a relative behavior Vₛₜₐₜₑ of the target vehicle is sequentially determined based on the acquired sensor value S.

The target vehicle is a vehicle selected from the surrounding vehicles existing around the host vehicle 1. Whether or not a certain vehicle exists around the host vehicle 1 can be determined, for example, depending on whether or not the vehicle is located in a peripheral area determined with the host vehicle 1 as the reference. The peripheral area can be set as a rectangular area centered on the host vehicle 1 and having sides parallel to the front-rear direction and the left-right direction of the vehicle. The size of the rectangle can be made such that the front direction of the vehicle is about the stopping distance of the vehicle. The rear of the vehicle may be the same as the front direction of the vehicle, or may be shorter than that. The size of the rectangle in the left-right direction of the vehicle can be taken as the length of one lane. The size of the peripheral area can be set in various ways. Further, the shape of the peripheral area can also be set in various ways. For example, the shape of the peripheral area may be a true circle shape or an elliptical shape.

Vehicles other than the host vehicle 1 (hereinafter referred to as other vehicles) existing in the peripheral area, i.e., other vehicles in each of which another vehicle does not exist between the host vehicle 1 and each of other vehicles are taken to be target vehicles. Further, other vehicles in each of which another vehicle exists between the host vehicle 1 and each of other vehicles may also be taken as target vehicles as long as they exist in the peripheral area.

The relative behavior Vₛₜₐₜₑ includes a relative position and a relative velocity. The relative position can be represented by a relative distance and a relative orientation. The relative behavior Vₛₜₐₜₑ can also be determined from changes in the position of the host vehicle 1 and the position of the target vehicle. The position of the target vehicle may be detected by the sensor 112 mounted on the target vehicle, and the position thereof may be acquired by the potential accident liability value determination device 100 of the host vehicle 1 by wireless communication. In this case, the target vehicle behavior determination unit 141 acquires the sensor value S detected by the sensor unit 110 mounted on the target vehicle, and determines the relative behavior Vₛₜₐₜₑ of the target vehicle based on the sensor value S.

The rule acquisition unit 142 acquires an accident liability rule at the current host vehicle position P. The accident liability rule includes traffic rules which differ depending on the position and rules which do not depend on the position. The rule acquisition unit 142 specifies the position of the host vehicle 1 on the road on the basis of the host vehicle position P determined based on the sensor value S and the road map stored in the map storage unit 120 in order to acquire the traffic rules each different depending on the position. Then, the traffic rule determined based on the specified position on the road is acquired from the rule DB storage unit 130. The traffic rule acquired from the rule DB storage unit 130 is a traffic rule (hereinafter referred to as peripheral traffic rule R_{db}) around the host vehicle position P, including the host vehicle position P.

The reason for acquiring the peripheral traffic rule R_{db} is to prevent the traffic rule from being frequently acquired from the rule DB storage unit 130 every time the host vehicle position P changes. The position-independent rule is, for example, a required inter-vehicle distance determined according to the speed. The position-independent rule may also be stored in a predetermined storage area of the rule DB storage unit 130. Hereinafter, the traffic rule for the host vehicle position P and its surroundings and the position-independent rule are collectively referred to as a peripheral traffic rule R_{db}.

The accident liability determination unit 150 is a part which in the case where an accident related to the host vehicle 1 occurs, determines the liability of the host vehicle 1 for the accident. The accident liability determination unit 150 includes a potential accident liability value determination unit 151, a potential accident storage unit 152, and an external I/F unit 153.

The potential accident liability value determination unit 151 is an example of a potential accident liability information determination unit and determines the potential accident liability value ALᵥₐₗ which is an example of the potential accident liability information. The potential accident liability value ALᵥₐₗ is a value indicating the extent of liability of the host vehicle 1 when an accident occurs between the target vehicle and the host vehicle 1. The potential accident liability value determination unit 151 determines the potential accident liability value ALᵥₐₗ on the basis of the relative behavior Vₛₜₐₜₑ of the target vehicle determined by the target vehicle behavior determination unit 141 and the accident liability rule acquired by the rule acquisition unit 142.

A change in the position of the target vehicle with respect to the host vehicle 1 can be understood from the relative behavior Vₛₜₐₜₑ of the target vehicle. Therefore, by comparing the relative behavior Vₛₜₐₜₑ of the target vehicle with the traffic rule included in the accident liability rule, it is possible to determine whether or not the target vehicle is traveling in compliance with the traffic rule. When an accident occurs between the target vehicle and the host vehicle 1 in the case where the target vehicle is traveling without observing the traffic rule, the target vehicle must bear most of the liability for the accident.

Further, it can be seen from the relative behavior Vₛₜₐₜₑ of the target vehicle that the target vehicle has suddenly decelerated, the target vehicle has suddenly accelerated, the target vehicle has moved closer to the host vehicle 1, and others have occurred. When an accident occurs between the target vehicle and the host vehicle 1 in a state in which the target vehicle are performing behaviors such as sudden acceleration, sudden deceleration, closer moving, etc., the target vehicle may have to bear most of the liability for the accident.

Thus, from the relative behavior Vₛₜₐₜₑ of the target vehicle and the accident liability rule, it is possible to determine the extent of liability for the accident of the target vehicle when the accident occurs between the target vehicle and the host vehicle 1. If the extent of liability for the accident of the target vehicle is expressed by a numerical value such as a %, the extent of liability of the host vehicle 1 in the case where an accident occurs between the target vehicle and the host vehicle 1 can also be expressed by a numerical value such as 100−α (%). This numerical value is the potential accident liability value ALᵥₐₗ.

The behavior of the host vehicle 1 is reflected in the relative behavior Vₛₜₐₜₑ of the target vehicle. Therefore, it is possible to determine the potential accident liability value ALᵥₐₗ without using the behavior of the host vehicle 1. However, the potential accident liability value may be determined by using the behavior of the host vehicle 1 as well in addition to the relative behavior Vₛₜₐₜₑ of the target vehicle.

There is no particular limitation on a specific method of determining the potential accident liability value ALᵥₐₗ. For example, it is possible to determine the potential accident liability value ALᵥₐₗ by using a map in which the potential accident liability value ALᵥₐₗ is determined from the relative behavior Vₛₜₐₜₑ of the target vehicle and the accident liability rule. Besides that, a plurality of functions determined from the accident liability rule are prepared, and a function for determining the potential accident liability value ALᵥₐₗ is selected from the accident liability rule acquired by the rule acquisition unit 142 this time. Then, the potential accident liability value ALᵥₐₗ may be determined from the selected function and the relative behavior Vₛₜₐₜₑ of the target vehicle determined by the target vehicle behavior determination unit 141 this time. The above map and function have a preset relationship that determines the potential accident liability value ALᵥₐₗ. The potential accident liability value determination unit 151 stores the determined potential accident liability value ALᵥₐₗ in the potential accident storage unit 152.

The potential accident storage unit 152 includes a writable non-volatile storage medium. The sensor value S used for determining the potential accident liability value ALᵥₐₗ is stored in the potential accident storage unit 152 together with the potential accident liability value ALᵥₐₗ. A set of these potential accident liability value ALᵥₐₗ and sensor value S is defined as potential accident information AL_{info}. The sensor value S is an example of liability value determination information R_{info}, which is information used to determine the potential accident liability value ALᵥₐₗ. Further, since the potential accident liability value ALᵥₐₗ is an example of the potential accident liability information, the liability value determination information R_{info} is an example of information used for determining the potential accident liability information, that is, the liability determination information.

The sensor value S is, in detail, a value used to determine the relative behavior Vₛₜₐₜₑ of the target vehicle used to determine the potential accident liability value ALᵥₐₗ. The potential accident liability value determination unit 151 can acquire the sensor value S from the target vehicle behavior determination unit 141, and then store the acquired sensor value S in the potential accident storage unit 152. Further, the potential accident liability value determination unit 151 may instruct the target vehicle behavior determination unit 141 to store the sensor value S in the potential accident storage unit 152.

The external I/F unit 153 can be connected to an external device lying outside the potential accident liability value determination device 100. The external I/F unit 153 has a signal transmission/reception function. The potential accident information AL_{info} stored in the potential accident storage unit 152 is output to the external device connected to the external I/F unit 153 via the external I/F unit 153.

### [Processing Until Potential Accident Information AL_{Val} is Stored]

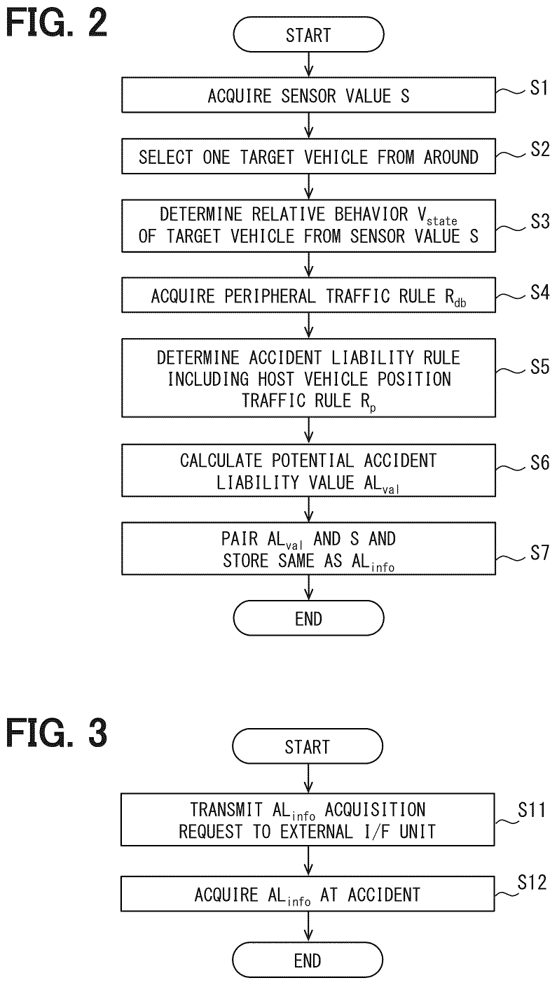

Next, the processing until the potential accident liability value determination device 100 stores the potential accident information AL_{info} in the potential accident storage unit 152 will be described. The potential accident liability value determination device 100 periodically executes the processing shown in FIG. 2 while the host vehicle 1 is traveling. The execution of the processing shown in FIG. 2 corresponds to the execution of a travel storage method. An execution cycle of the processing can be 100 ms or less. However, it does not necessarily have to be 100 ms or less, and may be longer than 100 ms.

In Step (hereinafter, Step is omitted) S1, the target vehicle behavior determination unit 141 acquires the sensor value S from the sensor unit 110. The target vehicle behavior determination unit 141 also executes S2 and S3. In S2, one target vehicle is selected from around the host vehicle 1. The target vehicle selected here can be a vehicle different from the surrounding vehicles which is selected in the previous processing of FIG. 2. However, when one peripheral vehicle is in a situation in which it requires special attention compared to other surrounding vehicles, the frequency of selecting the peripheral vehicle that requires special attention as the target vehicle may be made higher than that of other surrounding vehicles. In S3, the relative behavior Vₛₜₐₜₑ of the target vehicle is determined using the sensor value S.

The rule acquisition unit 142 executes S4 and S5. In S4, the peripheral traffic rule Rab is acquired from the rule DB storage unit 130 based on the host vehicle position P included in the sensor value S acquired in S1. In S5, the traffic rule at the host vehicle position P is determined based on the host vehicle position P and the peripheral traffic rule R_{db} acquired in S4. The accident liability rule to be used in the next S6 is determined by combining the traffic rule at the host vehicle position P and the position-independent rule.

S6 and S7 are executed by the potential accident liability value determination unit 151. In S6, the potential accident liability value ALᵥₐₗ is calculated based on the relative behavior Vₛₜₐₜₑ of the target vehicle determined in S3 and the accident liability rule determined in S5. In S7, the potential accident liability value ALᵥₐₗ calculated in S6 and the sensor value S acquired in S1 are taken as a set and stored in the potential accident storage unit 152 as the potential accident information AL_{info}. The potential accident information AL_{info} can include the host vehicle position P and the current time.

### [Processing of Taking Out Potential Accident Information AL_{Info}]

FIG. 3 shows processing of taking out the potential accident information AL_{info} from the potential accident liability value determination device 100. The processing shown in FIG. 3 is executed by an external device having a function of being able to connect to the external I/F unit 153. The external device is, for example, a portable information reading device. This information reading device is owned by, for example, a police officer and an employee of an insurance company.

When the external device executes the processing shown in FIG. 3, there is a case where an accident related to the host vehicle 1 occurs and the potential accident liability value ALᵥₐₗ is submitted from the potential accident liability value determination device 100 mounted on the host vehicle 1. The external device executes the processing shown in FIG. 3 in order to verify the potential accident liability value ALᵥₐₗ submitted from the potential accident liability value determination device 100. The processing shown in FIG. 3 is started when the operator of the external device performs a predetermined acquisition start operation in a state where the I/F unit of the external device is connected to the external I/F unit 153. The external device includes an arithmetic device such as a computer, which is capable of executing the processing shown in FIG. 3.

In S11, the external device transmits an acquisition request to the external I/F unit 153. This acquisition request is a signal requesting the acquisition of the potential accident information AL_{info}. The acquisition request can include accident specification information for limiting the requested potential accident information AL_{info} to the potential accident information AL_{info} for the accident. The accident specification information can be the position and time when the accident has occurred. Upon receiving this request, the external I/F unit 153 reads the potential accident information AL_{info} from the potential accident storage unit 152 and transmits it to the external device.

In S12, the potential accident information AL_{info} at the time of the accident transmitted from the external I/F unit 153 is acquired. The potential accident information AL_{info} acquired in S12 is provided to a potential accident liability value determination device different from the potential accident liability value determination device 100 of the first embodiment, which is able to determine the potential accident liability value ALᵥₐₗ. Of course, the external device itself may be the potential accident liability value determination device. The potential accident liability value determination device to which the potential accident information AL_{info} is provided determines the potential accident liability value ALᵥₐₗ using the provided potential accident information AL_{info}. The processing of determining the potential accident liability value ALᵥₐₗ by the potential accident liability value determination device provided with the potential accident information AL_{info}, and the like will be described in detail in a second embodiment.

### Summary of First Embodiment

The potential accident liability value determination device 100 of the first embodiment stores the sensor value S in the potential accident storage unit 152 in association with the potential accident liability value ALᵥₐₗ. By reading this sensor value S from the potential accident storage unit 152, the potential accident liability value ALᵥₐₗ can be determined after the fact. By comparing the potential accident liability value ALᵥₐₗ determined after the fact with the potential accident liability value ALᵥₐₗ stored in association with the sensor value S, the reliability of the stored potential accident liability value ALᵥₐₗ can be confirmed later. Thus, it is possible to confirm whether or not the potential accident liability value ALᵥₐₗ has been tampered with.

In addition, potential accident liability values ALᵥₐₗ that differ even with the same sensor value S may be determined due to differences in the version of the potential accident liability value determination device 100 and differences in manufacturers. However, the potential accident liability value determination device 100 of the first embodiment can read the potential accident information AL_{info}, and the sensor value S is contained in the potential accident information AL_{info}. Therefore, when an accident occurs, the sensor value S is read from each of a plurality of vehicles involved in the accident, and the potential accident liability value ALᵥₐₗ of each of the plurality of vehicles involved in the accident can be determined by the same potential accident liability value determination method.

Further, the sensor value S and the potential accident liability value ALᵥₐₗ are stored as the set, thereby making it also possible to confirm whether the potential accident liability value ALᵥₐₗ is an abnormal value due to an abnormal sensor value S.

### Second Embodiment

Next, the second embodiment will be described. In the following description of the second embodiment, the elements having the codes of the same numbers as the codes used so far are the same as the elements having the same codes in the previous embodiment, unless otherwise specified. Further, when only a part of the configuration is described, the embodiment described previously can be applied to the other parts of the configuration.

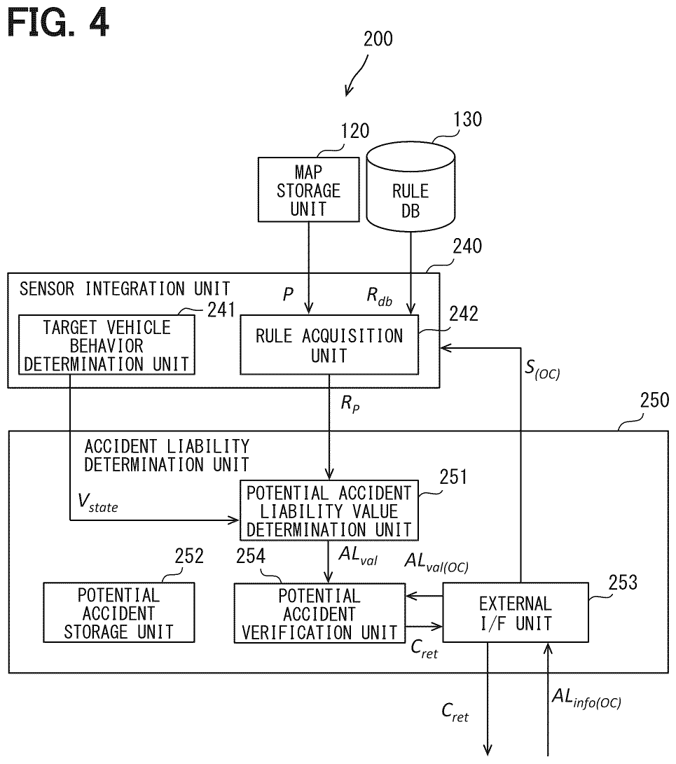

FIG. 4 is a diagram showing a configuration of a potential accident liability value determination device 200 of the second embodiment. The potential accident liability value determination device 200 is an example of a potential accident liability determination device. The potential accident liability value determination device 200 is a device which verifies the reliability of the potential accident liability value ALᵥₐₗ determined by the potential accident liability value determination device 100 mounted on the host vehicle 1 described in the first embodiment. Therefore, the potential accident liability value ALᵥₐₗ is determined in the same manner as the potential accident liability value determination device 100. Since the potential accident liability value determination device 200 is not mounted on the host vehicle 1, the host vehicle 1 is defined as a liability value determination vehicle in the second embodiment. The liability value determination vehicle corresponds to a liability determination vehicle. The potential accident liability value determination device 200 is installed outside the liability value determination vehicle. The potential accident liability value determination device 200 of the second embodiment does not need to be mounted on the vehicle. For example, the potential accident liability value determination device 200 can be a fixed type installed at a police station or an insurance company.

The potential accident liability value determination device 200 is not provided with the sensor unit 110. A sensor integration unit 240 includes a target vehicle behavior determination unit 241 and a rule acquisition unit 242. Processing executed by these target vehicle behavior determination unit 241 and rule acquisition unit 242 are the same as those of the target vehicle behavior determination unit 141 and the rule acquisition unit 142 of the first embodiment.

The difference between the target vehicle behavior determination unit 241 and the target vehicle behavior determination unit 141 resides in that the target vehicle behavior determination unit 141 uses the sensor value S, whereas the target vehicle behavior determination unit 241 uses the other vehicle sensor value S_{(OC)}. Further, the difference between the rule acquisition unit 242 and the rule acquisition unit 142 also resides in that the rule acquisition unit 142 uses the sensor value S, whereas the rule acquisition unit 242 uses the other vehicle sensor value S_{(OC)}.

The accident liability determination unit 250 includes a potential accident liability value determination unit 251, a potential accident storage unit 252, an external I/F unit 253, and a potential accident verification unit 254. Of these, the potential accident storage unit 252 is the same as the potential accident storage unit 152 of the first embodiment.

The external I/F unit 253 is the same in function as the external I/F unit 153 of the first embodiment. Other vehicle potential accident information AL_{info(OC)} is input to the external I/F unit 253. The other vehicle potential accident information AL_{info(OC)} is potential accident information AL_{info} determined by a device other than the potential accident liability value determination device 200, such as the potential accident liability value determination device 100 of the first embodiment. That is, the external I/F unit 253 acquires the other vehicle potential accident information AL_{info(OC)}.

The other vehicle potential accident information AL_{info(OC)} of the second embodiment is the potential accident information AL_{info} described in the first embodiment in regard to the content of information. Therefore, the sensor value S is included in the other vehicle potential accident information AL_{info(OC)}. The sensor value S included in the other vehicle potential accident information AL_{info(OC)} is an example of the liability value determination information R_{info} as described in the first embodiment, and the liability value determination information R_{info} is an example of the liability determination information. Therefore, the external I/F unit 253 which acquires the sensor value S is a liability determination information acquisition unit. Further, the sensor value S and the potential accident liability value ALᵥₐₗ included in the other vehicle potential accident information AL_{info(OC)} are defined as the other vehicle sensor value S_{(OC)} and the other vehicle potential accident liability value AL_{val(OC)}, respectively. The external I/F unit 253 inputs the other vehicle sensor value S_{(OC)} included in the input other vehicle potential accident information AL_{info(OC)} to the sensor integration unit 240.

The target vehicle behavior determination unit 241 of the sensor integration unit 240 determines a relative behavior Vₛₜₐₜₑ of a subject vehicle from the input other vehicle sensor value S_{(OC)} in a manner similar to the target vehicle behavior determination unit 141 of the first embodiment. The rule acquisition unit 242 of the sensor integration unit 240 includes the host vehicle position P in the input other vehicle sensor value S_{(OC)}. Therefore, the rule acquisition unit 242 acquires the accident liability rule at the host vehicle position P from the rule DB storage unit 130 on the basis of the host vehicle position P as with the rule acquisition unit 142 of the first embodiment.

The processing executed by the potential accident liability value determination unit 251 is the same as that of the potential accident liability value determination unit 151. The potential accident liability value determination unit 251 is an example of a potential accident liability information determination unit. The potential accident liability value determination unit 251 determines a potential accident liability value ALᵥₐₗ of a liability value determination vehicle for the target vehicle from the accident liability rule acquired from the rule acquisition unit 242 and the relative behavior Vₛₜₐₜₑ of the target vehicle acquired from the target vehicle behavior determination unit 241. The determined potential accident liability value ALᵥₐₗ is input to the potential accident verification unit 254.

The potential accident verification unit 254 is input with other vehicle potential accident liability value AL_{val(OC)} included in the other vehicle potential accident information AL_{info(OC)} acquired by the external I/F unit 253 in addition to the potential accident liability value ALᵥₐₗ determined by the potential accident liability value determination unit 251. The potential accident verification unit 254 compares these potential accident liability value ALᵥₐₗ and other vehicle potential accident liability value AL_{val(OC)} with each other to verify whether the other vehicle potential accident liability value AL_{val(OC)} is reliable. The potential accident verification unit 254 outputs a verification result (hereinafter referred to as verification result Cret) to the external device via the external I/F unit 253.

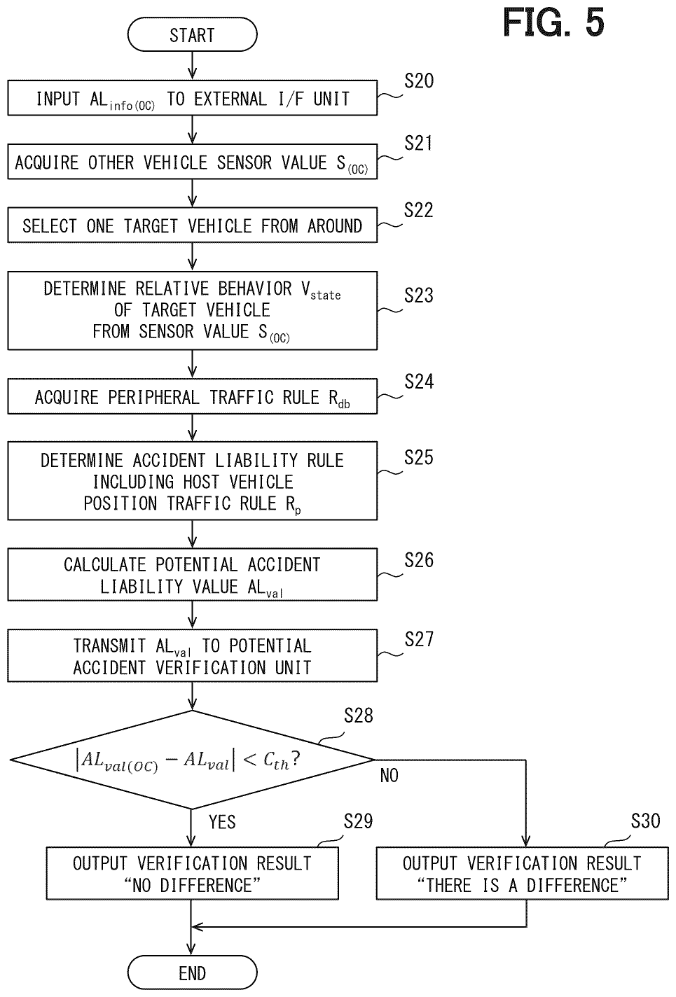

FIG. 5 shows processing executed by the potential accident liability value determination device 200. The execution of the processing shown in FIG. 5 corresponds to the execution of the potential accident liability determination method. The potential accident liability value determination device 200 executes the processing shown in FIG. 5 when the other vehicle potential accident information AL_{info(OC)} is input.

In S20, the other vehicle potential accident information AL_{info(OC)} is input to the external I/F unit 253. For ease of understanding, this processing is shown as S20 in FIG. 5, but S20 can also be considered as a condition for starting the processing of FIG. 5.

The target vehicle behavior determination unit 241 executes S21 to S23. In S21, an other vehicle sensor value S_{(OC)} is acquired from the external I/F unit 253. In S22, one target vehicle is selected from around the liability value determination vehicle in the same manner as in S2. In S23, a relative behavior Vₛₜₐₜₑ of the target vehicle is determined using the other vehicle sensor value S_{(OC)} in the same manner as in S3.

The rule acquisition unit 242 executes S24 and S25. In S24, the host vehicle position P included in the other vehicle sensor value S_{(OC)} acquired in S21 is set as the position of the liability value determination vehicle, and a peripheral traffic rule R_{db} is acquired from the rule DB storage unit 130 based on the position. In S25, a traffic rule at the position of the liability value determination vehicle is determined based on the position of the liability value determination vehicle and the peripheral traffic rule R_{db} acquired in S24. An accident liability rule to be used in the next S26 is determined by combining the traffic rule at the position of the liability value determination vehicle and the rule that does not depend on the position.

The potential accident liability value determination unit 251 executes S26 and S27. In S26, a potential accident liability value ALᵥₐₗ is calculated based on the relative behavior Vₛₜₐₜₑ of the target vehicle determined in S23 and the accident liability rule determined in S25. In S27, the potential accident liability value ALᵥₐₗ calculated in S26 is transmitted to the potential accident verification unit 254.

The potential accident verification unit 254 executes S28 to S30. In S28, the potential accident verification unit 254 acquires other vehicle potential accident liability value AL_{val(OC)} from the external I/F unit 253 and determines whether or not the absolute value of the difference between the other vehicle potential accident liability value AL_{val(OC)} and the potential accident liability value ALᵥₐₗ transmitted in S27 is smaller than a threshold value Cₜₕ. The threshold value Cₜₕ is a value set in advance.

When the absolute value of the above difference is smaller than the threshold value Cₜₕ, the determination result in S28 becomes YES, and the processing proceeds to S29. In S29, the verification result Cret that “there is no difference” is output to the external I/F unit 253. When the absolute value of the above difference is greater than the threshold value Cₜₕ, the determination result in S28 becomes NO and the processing proceeds to S30. In S30, the verification result Cret that “there is a difference” is output to the external I/F unit 253. The external I/F unit 253 outputs this verification result to the external device connected to the external I/F unit 253.

### Summary of Second Embodiment

The potential accident liability value determination device 200 acquires the other vehicle sensor value S_{(OC)} (S21), and determines the potential accident liability value ALᵥₐₗ, based on the other vehicle sensor value S_{(OC)} (S26). Then, the determined potential accident liability value ALᵥₐₗ is compared with the other vehicle potential accident liability value AL_{val(OC)} determined by the potential accident liability value determination device 100, which is a device different from the potential accident liability value determination device 200. Consequently, the reliability of the other vehicle potential accident liability value AL_{val(OC)} determined by the potential accident liability value determination device 100 can be confirmed later.

### Third Embodiment

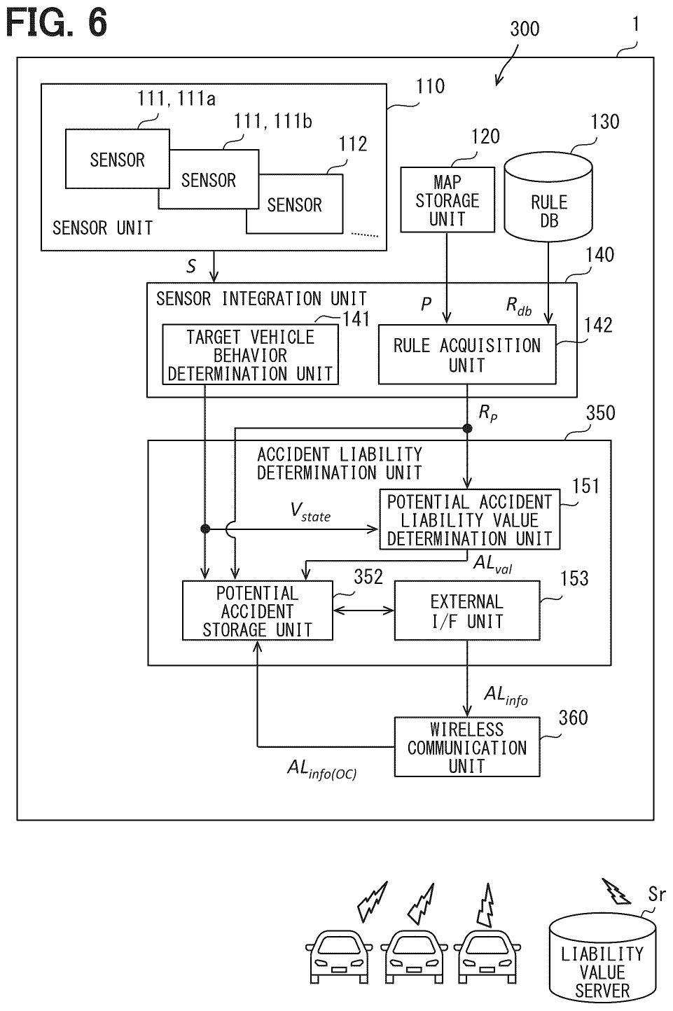

FIG. 6 is a diagram showing a configuration of a potential accident liability value determination device 300 of a third embodiment. The potential accident liability value determination device 300 includes the same sensor unit 110, map storage unit 120, rule DB storage unit 130, and sensor integration unit 140 as those in the potential accident liability value determination device 100 of the first embodiment. The potential accident liability value determination device 300 includes an accident liability determination unit 350. The accident liability determination unit 350 includes the same potential accident liability value determination unit 151 and external I/F unit 153 as those in the potential accident liability value determination device 100. Besides, the accident liability determination unit 350 includes a potential accident storage unit 352. Further, the potential accident liability value determination device 300 includes a wireless communication unit 360.

The potential accident storage unit 352 includes a writable storage medium. The potential accident storage unit 352 stores together with a potential accident liability value ALᵥₐₗ, a relative behavior Vₛₜₐₜₑ of a target vehicle and an accident liability rule thereof used to determine the potential accident liability value ALᵥₐₗ. In the third embodiment, a set of these potential accident liability value ALᵥₐₗ, relative behavior Vₛₜₐₜₑ of the target vehicle, and accident liability rule is set as potential accident information AL_{info}. The relative behavior Vₛₜₐₜₑ of the target vehicle and the accident liability rule are an example of liability value determination information R_{info}, which is information used to determine the potential accident liability value ALᵥₐₗ.

The wireless communication unit 360 has a configuration including a wireless communication circuit and a control unit that controls the wireless communication circuit. The wireless communication unit 360 is connected to the external I/F unit 153 and the potential accident storage unit 352. Although the wireless communication unit 360 and the potential accident storage unit 352 are directly connected in FIG. 6, the wireless communication unit 360 and the potential accident storage unit 352 may be connected via the external I/F unit 153.

The wireless communication unit 360 wirelessly communicates with the outside of the host vehicle 1. The control unit included in the wireless communication unit 360 also has a function of reading information from the potential accident storage unit 352. The wireless communication unit 360 sequentially wirelessly transmits the potential accident information AL_{info} stored in the potential accident storage unit 352 to the outside. Further, when the wireless communication unit 360 receives the other vehicle potential accident information AL_{info(OC)} transmitted from the outside of the host vehicle 1, the wireless communication unit 360 stores the other vehicle potential accident information AL_{info(OC)} in the potential accident storage unit 352. The potential accident storage unit 352 that stores the other vehicle potential accident information AL_{info(OC)} corresponds to an external information storage unit.

### [Processing Until Transmission of Potential Accident Information AL_{Info}]

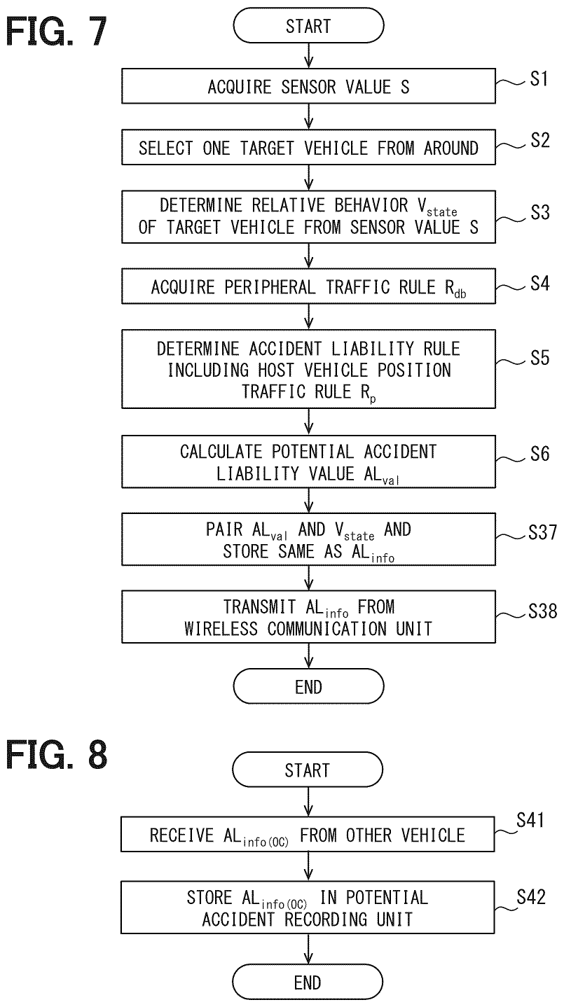

Next, the processing until the potential accident liability value determination device 300 transmits the potential accident information AL_{info} to the outside will be described. The potential accident liability value determination device 300 periodically executes the processing shown in FIG. 7 while the host vehicle 1 is traveling. An execution cycle thereof can be the same as that for the processing shown in FIG. 2 of the first embodiment.

In FIGS. 7, S1 to S6 are the same as S1 to S6 in FIG. 2. In FIG. 7, after executing S6, S37 is executed. In S37, the potential accident liability value ALᵥₐₗ calculated in S6, the relative behavior Vₛₜₐₜₑ of the target vehicle determined in S3, and the accident liability rule determined in S5 are made as a set and stored in the potential accident storage unit 352 as the potential accident information AL_{info}. The potential accident information AL_{info} can include the host vehicle position P and the current time therein. In addition, information that specifies the host vehicle 1 (for example, a vehicle ID, etc.) can also be included in the potential accident information AL_{info}. The potential accident liability value determination unit 151, the target vehicle behavior determination unit 141, and the rule acquisition unit 142 respectively having determined the potential accident liability value ALᵥₐₗ, the relative behavior Vₛₜₐₜₑ of the target vehicle, and the accident liability rule store them in the potential accident storage unit 352.

S38 is executed by the wireless communication unit 360. In S38, the potential accident information AL_{info} stored in the potential accident storage unit 352 in S37 is transmitted from the wireless communication unit 360 to the outside. There is no particular limitation on the destination of transmission of the potential accident information AL_{info}. The transmission destination includes, for example, the liability value server Sr (refer to FIG. 6), a roadside communication device, each peripheral vehicle existing around the host vehicle 1, and the like, and the potential accident information AL_{info} can be transmitted to one or more of them. Further, the potential accident information AL_{info} may be transmitted by a broadcast method that does not specify a transmission party.

[Processing when Other Vehicle Potential Accident Information AL_{info(OC)} is Received]

FIG. 8 is a flowchart showing processing when the wireless communication unit 360 receives the other vehicle potential accident information AL_{info(OC)} from the other vehicle. If the potential accident liability value determination device 300 is mounted on the other vehicle, the potential accident liability value determination device 300 mounted on the other vehicle executes FIG. 7 to sequentially transmit the potential accident information AL_{info}.

When the host vehicle 1 is located near the other vehicle, the potential accident liability value determination device 300 mounted on the host vehicle 1 receives the potential accident information AL_{info} from the other vehicle. In the third embodiment, in order to distinguish from the potential accident information AL_{info} transmitted by the host vehicle 1, the potential accident information AL_{info} transmitted by the potential accident liability value determination device 300 mounted on the other vehicle is set as the other vehicle potential accident information AL_{info(OC)}.

In FIG. 8, in S41, the wireless communication unit 360 receives the other vehicle potential accident information AL_{info(OC)} transmitted from the other vehicle. In S42, the wireless communication unit 360 stores the received other vehicle potential accident information AL_{info(OC)} in the potential accident storage unit 352.

### Summary of Third Embodiment

The potential accident liability value determination device 300 of the third embodiment also stores the potential accident information AL_{info} in a manner similar to the potential accident liability value determination device 100 of the first embodiment. However, in the potential accident information AL_{info} in the third embodiment, the liability value determination information R_{info} is not the sensor value S but the relative behavior Vₛₜₐₜₑ of the target vehicle and the accident liability rule. The amount of data of the sensor value S tends to be larger than the amount of data of the relative behavior Vₛₜₐₜₑ of the target vehicle and the accident liability rule. Particularly, when the sensor value S is image data or when relative behaviors obtained from a plurality of types of sensor values S are fusioned to determine the final relative behavior Vₛₜₐₜₑ of the target vehicle, the amount of data of the sensor value S becomes larger than the amount of data of the relative behavior Vₛₜₐₜₑ of the target vehicle and the accident liability rule.

In other words, as in the third embodiment, the liability value determination information R_{info} included in the potential accident information AL_{info} is set as the relative behavior Vₛₜₐₜₑ of the target vehicle and the accident liability rule, so that the amount of data of the potential accident information AL_{info} can be made small. In the third embodiment, the small data amount of the potential accident information AL_{info} is utilized and the potential accident information AL_{info} is sequentially wirelessly transmitted from the wireless communication unit 360. Since the amount of data of the potential accident information AL_{info} is small, the degree to which other communication is restricted is reduced even if the potential accident information AL_{info} is sequentially transmitted from the wireless communication unit 360.

Then, by sequentially wirelessly transmitting the potential accident information AL_{info} to the outside, the other vehicle that directly or indirectly acquires the potential accident information AL_{info} is capable of acquiring the potential accident liability value ALᵥₐₗ of the host vehicle 1 in the state in which reliability can be verified.

It can also be said that the potential accident liability value ALᵥₐₗ indicates whether or not to be the vehicle behavior prone to accidents. Therefore, the other vehicle which has acquired the potential accident information AL_{info} can acquire whether or not the host vehicle 1 has a vehicle behavior in which an accident is likely to occur, in the state in which the reliability can be verified, and perform driving.

In addition, the potential accident information AL_{info(OC)} transmitted while the other vehicle is traveling is sequentially stored in the potential accident storage unit 352, thereby making it possible to strongly prevent the potential accident information AL_{info(OC)} from being tampered with.

It is also possible to provide only a predetermined device such as the liability value server Sr with a function of storing the potential accident information AL_{info(OC)} transmitted while the vehicle is traveling. Some or all of the plurality of potential accident liability value determination devices 300 mounted on the plurality of vehicles use the potential accident information AL_{info} transmitted while the other vehicle is traveling, to determine whether or not the other vehicle has the vehicle behavior in which it is likely to cause an accident. That is, some or all of the plurality of potential accident liability value determination devices 300 mounted on the plurality of vehicles do not have to use the potential accident information AL_{info} transmitted while the other vehicle is traveling, for the prevention of tampering of the potential accident information AL_{info}. In this case, the potential accident storage unit 352 included in the potential accident liability value determination device 300 can also be a volatile storage medium.

### Fourth Embodiment

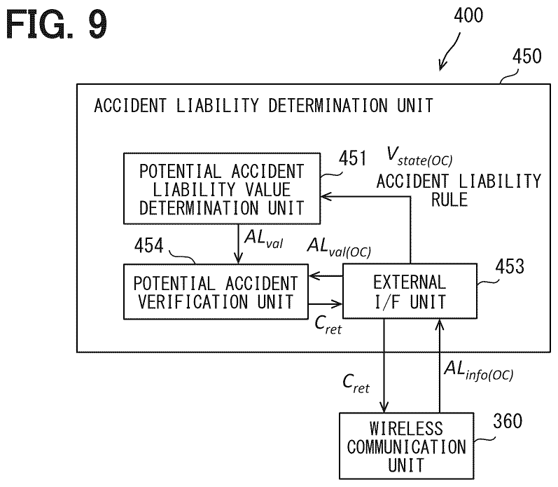

FIG. 9 is a diagram showing a configuration of a potential accident liability value determination device 400 of a fourth embodiment. The potential accident liability value determination device 400 has a configuration including an accident liability determination unit 450 and a wireless communication unit 360. As with the potential accident liability value determination device 200, the potential accident liability value determination device 400 acquires other vehicle potential accident information AL_{info(OC)} from the outside and verifies a potential accident liability value ALᵥₐₗ included in the other vehicle potential accident information AL_{info(OC)}. The potential accident liability value determination device 400 is also an example of a potential accident liability determination device. As with the potential accident liability value determination device 200, the potential accident liability value determination device 400 does not need to be mounted on the vehicle. For example, the potential accident liability value determination device 400 can be a fixed type installed at a police station or an insurance company.

However, the other vehicle potential accident information AL_{info(OC)} received by the potential accident liability value determination device 400 has been described in the third embodiment. Therefore, the other vehicle potential accident information AL_{info(OC)} received by the potential accident liability value determination device 400 includes the relative behavior Vₛₜₐₜₑ of the subject vehicle and the accident liability rule. Thus, the potential accident liability value determination device 400 does not include the target vehicle behavior determination unit 241 and the rule acquisition unit 242, which are the parts for determining these.

The accident liability determination unit 450 includes a potential accident liability value determination unit 451, an external I/F unit 453, and a potential accident verification unit 454. The potential accident liability value determination unit 451 is the same as the potential accident liability value determination unit 251 of the second embodiment, and is an example of a potential accident liability information determination unit. The potential accident verification unit 454 is the same as the potential accident verification unit 254 of the second embodiment.

The external I/F unit 453 is connected to the wireless communication unit 360 and acquires the other vehicle potential accident information AL_{info(OC)} received by the wireless communication unit 360. Since the other vehicle potential accident information AL_{info(OC)} includes liability value determination information R_{info}, the external I/F unit 453 is a liability determination information acquisition unit.

The relative behavior Vₛₜₐₜₑ of the target vehicle and the accident liability rule included in the other vehicle potential accident information AL_{info(OC)} are output to the potential accident liability value determination unit 451. Further, the external I/F unit 453 outputs an other vehicle potential accident liability value AL_{val(OC)} included in the other vehicle potential accident information AL_{info(OC)} to the potential accident verification unit 454.

The potential accident liability value determination unit 451 determines the potential accident liability value ALᵥₐₗ from those target vehicle relative behavior Vₛₜₐₜₑ and accident liability rule. The potential accident verification unit 454 compares the potential accident liability value ALᵥₐₗ with the other vehicle potential accident information AL_{info(OC)}. Then, the potential accident verification unit 454 outputs a verification result Cret that has verified whether or not the other vehicle potential accident information AL_{info(OC)} is reliable, to the wireless communication unit 360 via the external I/F unit 453. The wireless communication unit 360 wirelessly transmits the verification result Cret to the outside.

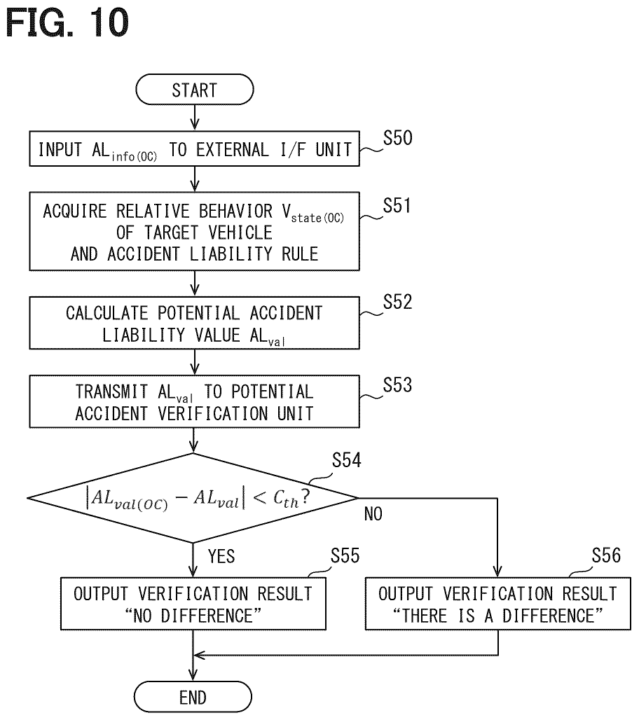

FIG. 10 shows processing executed by the potential accident liability value determination device 400. The potential accident liability value determination device 400 executes the processing shown in FIG. 10 where the wireless communication unit 360 receives the other vehicle potential accident information AL_{info(OC)}.

In S50, the other vehicle potential accident information AL_{info(OC)} received by the wireless communication unit 360 is input to the external I/F unit 453. S51 to S53 are executed by the potential accident liability value determination unit 451. In S51, the potential accident liability value determination unit 451 acquires the relative behavior V_{state(OC)} of the target vehicle and the accident liability rule included in the other vehicle potential accident information AL_{info(OC)} from the external I/F unit 453. In S52, the potential accident liability value ALᵥₐₗ is calculated based on the relative behavior V_{state(OC)} of the target vehicle and the accident liability rule acquired in S51. In S53, the potential accident liability value ALᵥₐₗ calculated in S52 is transmitted to the potential accident verification unit 454.

S54 to S56 are executed by the potential accident verification unit 454. In S54, the potential accident verification unit 454 acquires the other vehicle potential accident liability value AL_{val(OC)} from the external I/F unit 453 and determines whether or not the absolute value of the difference between the other vehicle potential accident liability value AL_{val(OC)} and the potential accident liability value ALᵥₐₗ transmitted in S53 is smaller than a threshold value Cₜₕ.

When the absolute value of the above difference is smaller than the threshold value Cₜₕ, the determination result in S54 becomes YES and the processing proceeds to S55. In S55, the verification result Cret that “there is no difference” is output to the external I/F unit 453. When the absolute value of the above difference is greater than the threshold value Cₜₕ, the determination result of S54 becomes NO and the processing proceeds to S56. In S56, the verification result Cᵣₑₜ that “there is a difference” is output to the external I/F unit 453. The external I/F unit 453 transmits this verification result to the wireless communication unit 360. The wireless communication unit 360 wirelessly transmits the verification result to the outside.

### Summary of Fourth Embodiment

The potential accident liability value determination device 400 of the fourth embodiment acquires the relative behavior Vₛₜₐₜₑ of the target vehicle and the accident liability rule included in the other vehicle potential accident information AL_{info(OC)} (S51) and determines the potential accident liability value ALᵥₐₗ, based on those target vehicle relative behavior Vₛₜₐₜₑ and accident liability rule (S52). Then, the determined potential accident liability value ALᵥₐₗ is compared with the other vehicle potential accident liability value AL_{val(OC)} included in the other vehicle potential accident information AL_{info(OC)}. Consequently, the reliability of the other vehicle potential accident liability value AL_{val(OC)} determined by the other vehicle can be confirmed.

Further, the relative behavior Vₛₜₐₜₑ of the target vehicle and the accident liability rule are included as the liability value determination information R_{info} in the other vehicle potential accident information AL_{info(OC)} received by the potential accident liability value determination device 400. The other vehicle potential accident information AL_{info(OC)} can be reduced in data amount as compared with the other vehicle potential accident information of the second embodiment. Therefore, the other vehicle potential accident information AL_{info(OC)} including the relative behavior Vₛₜₐₜₑ of the target vehicle and the accident liability rule is easy to send sequentially during traveling.

The potential accident liability value determination device 400 receives the other vehicle potential accident information AL_{info(OC)} transmitted sequentially and sequentially verifies the reliability of the other vehicle potential accident liability value AL_{val(OC)} included in the other vehicle potential accident information AL_{info(OC)}. Thus, since the reliability of the potential accident liability value ALᵥₐₗ can be verified at an early stage, it is possible to determine at an early stage whether or not the device having determined the other vehicle potential accident liability value AL_{val(OC)} is out of order.

### Fifth Embodiment

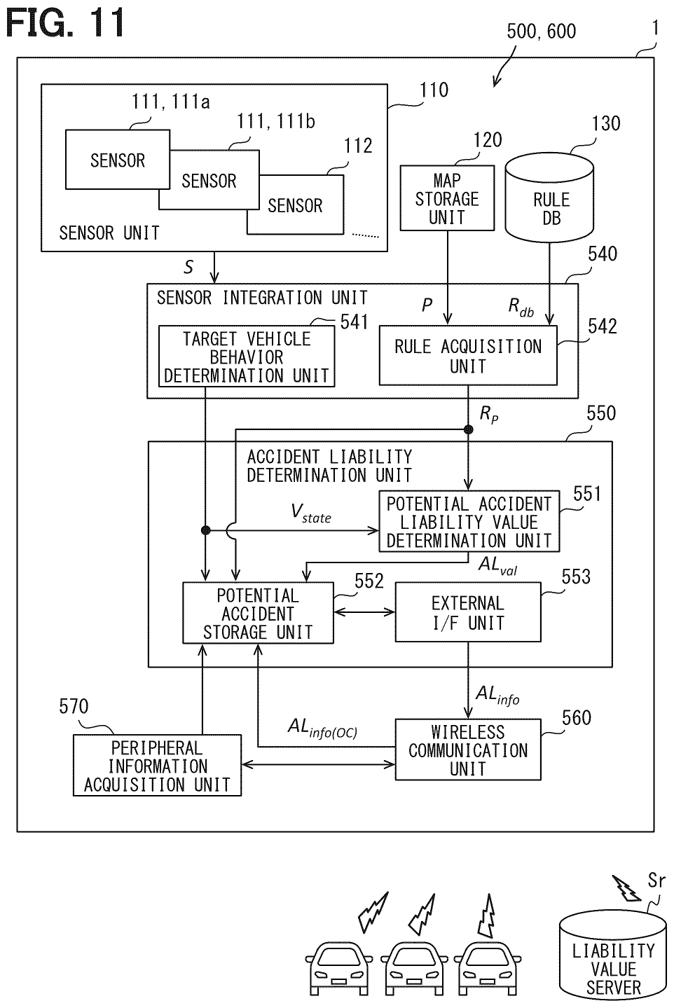

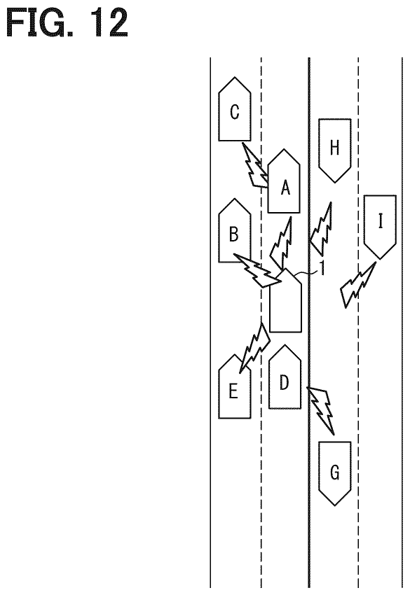

FIG. 11 shows a potential accident liability value determination device 500 of a fifth embodiment. The potential accident liability value determination device 500 of the fifth embodiment includes the same sensor unit 110, map storage unit 120, and rule DB storage unit 130 as in the first embodiment.

Further, the potential accident liability value determination device 500 includes a sensor integration unit 540, an accident liability determination unit 550, a wireless communication unit 560, and a peripheral information acquisition unit 570. Although the reference numerals are made different for convenience of explanation, the sensor integration unit 540 and the accident liability determination unit 550 are the same as the sensor integration unit 140 of the first embodiment and the accident liability determination unit 350 of the third embodiment. Further, the wireless communication unit 560 is the same as the wireless communication unit 360 of the third embodiment.

There are provided the sensor integration unit 540, a target vehicle behavior determination unit 541, and a rule acquisition unit 542. These target vehicle behavior determination unit 541 and rule acquisition unit 542 are the same as the target vehicle behavior determination unit 141 and the rule acquisition unit 142 of the first embodiment, respectively. The target vehicle behavior determination unit 541 is the liability determination information acquisition unit. The accident liability determination unit 550 includes a potential accident liability value determination unit 551, a potential accident storage unit 552, and an external I/F unit 553. The potential accident liability value determination unit 551, the potential accident storage unit 552, and the external I/F unit 553 are the same as the potential accident liability value determination unit 151, the potential accident storage unit 352, and the external I/F unit 153 included in the accident liability determination unit 350 of the third embodiment, respectively. The potential accident liability value determination unit 551 is an example of the potential accident liability information determination unit as with the potential accident liability value determination unit 151.

The peripheral information acquisition unit 570 can be realized by a computer. The peripheral information acquisition unit 570 acquires peripheral liability value determination information RS_{info} being peripheral liability determination information from related surrounding vehicles among surrounding vehicles existing around the host vehicle 1 and stores the peripheral liability value determination information RS_{info} in the potential accident storage unit 552. The timing to acquire the peripheral liability value determination information RS_{info} can be the time when the host vehicle 1 has an accident. Further, the peripheral liability value determination information RS_{info} may be acquired periodically regardless of whether or not the host vehicle 1 has caused an accident.

The related surrounding vehicles are surrounding vehicles other than the target vehicle among the surrounding vehicles. In an example shown in FIG. 12, when a vehicle A is a target vehicle, vehicles B, C, D, E, F, G, H, and I are related surrounding vehicles.

The peripheral liability value determination information RS_{info} is information in which the subject of the liability value determination information R_{info} for the host vehicle 1 already described is set as the related peripheral vehicle. That is, the peripheral liability value determination information RS_{info} is information used to determine a peripheral potential accident liability value indicating the extent of liability of the related peripheral vehicle in the event that an accident occurs between the related peripheral vehicle and each vehicle existing around the related peripheral vehicle. The peripheral potential accident liability value is an example of peripheral potential accident liability information. The vehicles existing around the related peripheral vehicle may include the host vehicle 1.

Specifically, the peripheral liability value determination information RS_{info} can include liability value determination information R_{info} for determining a potential accident liability value ALᵥₐₗ for the target vehicle for the related peripheral vehicle. Further, in regard to the peripheral liability value determination information RS_{info}, the potential accident liability value ALᵥₐₗ for the target vehicle for the related peripheral vehicle can also be included in the peripheral liability value determination information RS_{info}. Further, as the peripheral liability value determination information RS_{info}, only either one of those liability value determination information R_{info} and potential accident liability value ALᵥₐₗ can be used.

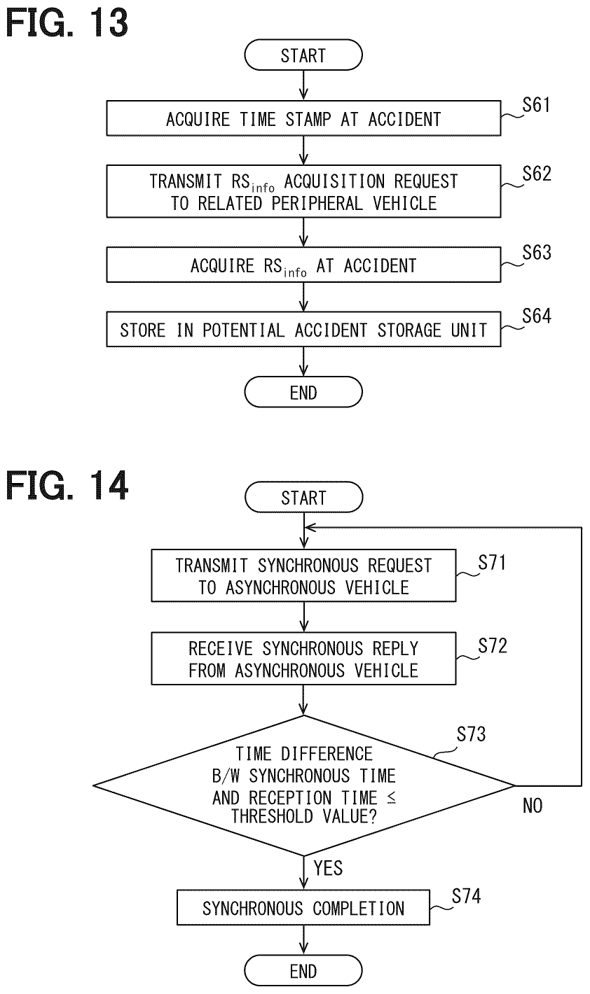

FIG. 13 shows an example of processing executed by the peripheral information acquisition unit 570. The processing shown in FIG. 13 is started on condition that the host vehicle 1 has caused an accident. Whether or not the host vehicle 1 has caused the accident can be detected when the acceleration generated in the host vehicle 1 exceeds a predetermined threshold value.

In S61, a time stamp at the time of the accident is acquired. The time stamp at the time of the accident indicates the time when the host vehicle 1 caused an accident. For example, the target vehicle behavior determination unit 541 that acquires a sensor value S can determine that the accident has occurred. Further, a device other than the potential accident liability value determination device 500 may detect that the accident has occurred, and the peripheral information acquisition unit 570 may acquire a time stamp at the time of the accident from the other device.

In S62, the wireless communication unit 560 transmits a request for acquisition of the peripheral liability value determination information RS_{info} to each related peripheral vehicle. When executing S62, the related surrounding vehicles exist around the host vehicle 1. Therefore, by transmitting the acquisition request of the peripheral liability value determination information RS_{info} to the surrounding of the host vehicle 1 by short-range wireless communication, the above acquisition request can be transmitted to the related surrounding vehicles. In this case, a communication method can be a broadcast method. However, the communication method is not limited to the broadcast method, and the above acquisition request may be transmitted by a unicast method or a multicast method. When transmitting the acquisition request by the unicast method or the multicast method, the above acquisition request may be transmitted by wide-area communication.

This acquisition request includes a message requesting the peripheral liability value determination information RS_{info} at the time indicated by the time stamp acquired in S61 (that is, the time when the accident occurred). The vehicle that has received the acquisition request transmits the peripheral liability value determination information RS_{info} for the time included in the acquisition request to the host vehicle 1. In consideration of a time error, the peripheral liability value determination information RS_{info} for a fixed period of time before and after the accident inclusive of the accident time may be transmitted to the host vehicle 1. In S63, the peripheral liability value determination information RS_{info} transmitted from the related peripheral vehicle at the time of the accident is acquired via the wireless communication unit 360.

In S64, the peripheral liability value determination information RS_{info} acquired in S63 is stored in the potential accident storage unit 552 together with potential accident information AL_{info}.

FIG. 14 shows processing when the host vehicle 1 and each peripheral vehicle synchronize the time. The processing shown in FIG. 14 is executed by, for example, the peripheral information acquisition unit 570. The processing shown in FIG. 14 is periodically executed at each time synchronization cycle set in advance.

In S71, a synchronous request is transmitted to asynchronous vehicles. By executing the processing of FIG. 14, the vehicle is regarded as a synchronized vehicle for a predetermined period after mutual time synchronization is completed. The asynchronous vehicles are vehicles that are not synchronized within the surrounding vehicles. Before executing S71, when it is possible to mutually communicate with the surrounding vehicles and determine whether the vehicle is an asynchronous vehicle or a synchronized vehicle for each peripheral vehicle, the asynchronous vehicle is specified and the synchronous request can be transmitted. However, it is also possible to determine the necessity of synchronization in each vehicle that has received the synchronous request. Therefore, in S71, the synchronous request may be transmitted to the surroundings without specifying the transmission party.

The synchronous request includes the time used in the host vehicle 1. This time is the time when the synchronous request is generated. When the asynchronous vehicle receives the synchronous request, the time used in the surrounding vehicles that have received the synchronous request is corrected based on the time included in the synchronous request. The post-correction time may be the time included in the synchronous request, or can also be the time obtained by adding the processing time in the host vehicle 1, the propagation time of the synchronous request, and the processing time in the surrounding vehicles to the time included in the synchronous request. When considering the processing time in the host vehicle 1, the processing time in the host vehicle 1 is included in the synchronous request. As to the propagation time of the synchronous request, the distance from the host vehicle to the peripheral vehicle is calculated from the position of the host vehicle 1 and the position of the peripheral vehicle, and the propagation time is calculated on the basis of the distance. The processing time in the peripheral vehicle is set in advance in the potential accident liability value determination device mounted on the peripheral vehicle.

The peripheral vehicle which was the asynchronous vehicle performs time synchronization and then sends a synchronous reply to the host vehicle 1. The synchronous reply includes execution of the time synchronization, the ID of the peripheral vehicle, and a synchronous reply generation time after the time synchronization. In S72, the synchronous reply transmitted by the asynchronous vehicle is received. In S73, it is determined whether or not the time difference between the synchronous reply generation time included in the synchronous reply and the time of the host vehicle 1 when the synchronous reply is received is equal to or less than the threshold value.

When the determination result of S73 is NO, it means that the time is not synchronized with the peripheral vehicle that has sent the synchronous reply. Thus, when the determination result of S73 is NO, the processing returns to S71. On the other hand, when the determination result of S73 is YES, the processing proceeds to S74. In S74, the synchronization is completed with the peripheral vehicle that has sent the synchronous reply. When the synchronization is completed, the surrounding vehicles each having sent the synchronous reply are considered to be synchronized vehicles. Further, the setting of the peripheral vehicle as the synchronized vehicle may be transmitted to each peripheral vehicle taken to be the synchronized vehicle.

### Summary of Fifth Embodiment

In the potential accident liability value determination device 500 of the fifth embodiment described above, the peripheral information acquisition unit 570 acquires the peripheral liability value determination information RS_{info} of each related peripheral vehicle (S63). Then, the peripheral liability value determination information RS_{info} is stored in the potential accident storage unit 552 together with the potential accident information AL_{info}.

Consequently, the peripheral liability value determination information RS_{info} can be analyzed together with the potential accident information AL_{info}. From this analysis, it is possible to directly determine whether or not the situation is such that it can be recognized that there are many parts of the cause of the accident in the behavior of the related surrounding vehicles even if there is an accident problem in the behavior of the host vehicle 1 being the liability value determination vehicle.

This will be described specifically. For example, in the situation shown in FIG. 12, it is assumed that the host vehicle 1 moves to the left and collides with the vehicle B. In this case, the potential accident liability value ALᵥₐₗ of the host vehicle 1 with respect to the vehicle B becomes a high value. However, it is assumed that at the accident, the vehicle H traveling in the opposite lane has crossed the center line and entered the lane in which the host vehicle 1 is traveling. Then, it is assumed that the host vehicle 1 is in a situation of colliding with the vehicle H if it is traveling as it is. Therefore, the host vehicle 1 changed the lane in order to avoid a collision with the vehicle H, and collided with the vehicle B. It is difficult to understand that such a situation is found only by the potential accident information AL_{info}. However, it can be easily clarified by analyzing the peripheral liability value determination information RS_{info}.

The above is an example, and there may exist accident liability other than the vehicle that caused the accident. The peripheral liability value determination information RS_{info} is acquired by wireless communication. Therefore, by analyzing the peripheral liability value determination information RS_{info}, it is possible to analyze the behavior of each peripheral vehicle that cannot be directly seen from the host vehicle 1 and determine the cause of the accident.

### Sixth Embodiment

As shown in FIG. 11, a potential accident liability value determination device 600 of a sixth embodiment has the same hardware configuration as the potential accident liability value determination device 500 of the fifth embodiment. As with the potential accident liability value determination device 300 of the third embodiment, the potential accident liability value determination device 600 executes FIG. 7 to periodically transmit the potential accident information AL_{info} of the host vehicle to the outside. The destination for transmission is each peripheral vehicle and the liability value server Sr.

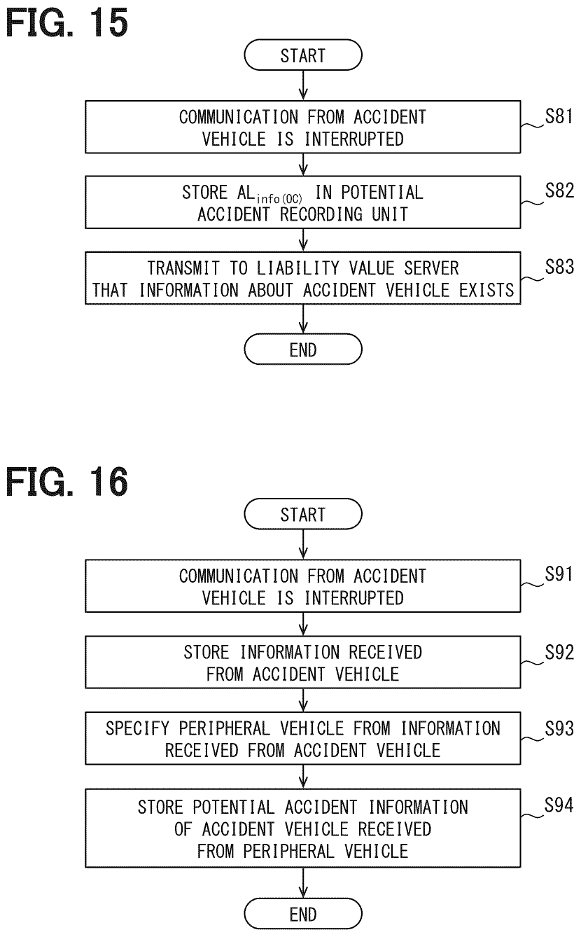

The potential accident liability value determination device 600 also executes processing shown in FIG. 15. The processing shown in FIG. 15 is executed by the wireless communication unit 560. In S81, it is detected that the communication from an accident vehicle is interrupted. When the potential accident information AL_{info} of the host vehicle (that is, its peripheral vehicle) for the peripheral vehicle, which has been periodically transmitted from the peripheral vehicle, cannot be received, the vehicle that was sending the potential accident information AL_{info} of the peripheral vehicle is regarded as the accident vehicle.

In S82, the potential accident information AL_{info} of the accident vehicle received last from the accident vehicle is stored in the potential accident storage unit 552. In S83, the wireless communication unit transmits to the liability value server Sr that it has information about the accident vehicle. Specifically, the information regarding the accident vehicle is the potential accident information AL_{info} of the accident vehicle transmitted by the accident vehicle.

The liability value server Sr periodically executes processing shown in FIG. 16. In S91, it is detected that the communication from the accident vehicle is interrupted. In S92, the potential accident information AL_{info} of the accident vehicle received last from the accident vehicle is stored in a predetermined accident information storage unit. This potential accident information AL_{info} includes the position of the accident vehicle. In S93, each peripheral vehicle existing around the accident vehicle is specified from the position of the accident vehicle contained in the potential accident information AL_{info} stored in S92, and potential accident information AL_{info} of other vehicles, which are also transmitted sequentially from the other vehicles. The potential accident information AL_{info} of other vehicles includes the positions of other vehicles. From the positions of the other vehicles and the position of the accident vehicle included in the potential accident information AL_{info} stored in S92, each peripheral vehicle that existed around the accident vehicle can be specified.

In S94, the peripheral vehicle specified in S93 is requested to transmit the potential accident information AL_{info} of the accident vehicle, and the potential accident information AL_{info} of the accident vehicle transmitted by the peripheral vehicle in response to the request is stored in the accident information storage unit.

The liability value server Sr which performs the above processing is provided with a liability determination information acquisition unit. Further, the liability value server Sr includes a potential accident liability value determination unit. The potential accident liability value determination unit of the liability value server Sr determines a potential accident liability value ALᵥₐₗ of the accident vehicle instead of the accident vehicle by using the acquired potential accident information AL_{info} of the accident vehicle.

### Summary of Sixth Embodiment

In the sixth embodiment, the liability value server Sr stores the potential accident information AL_{info} of the accident vehicle received last from the accident vehicle (S92) when the communication from the accident vehicle is interrupted (S61), and also acquires the potential accident information AL_{info} transmitted by the accident vehicle even from the periphery of the accident vehicle (S94). By doing so, even when the potential accident information AL_{info} of the accident vehicle cannot be extracted from the accident vehicle after the accident, the liability value server Sr can determine the potential accident liability value ALᵥₐₗ of the accident vehicle.

### Seventh Embodiment

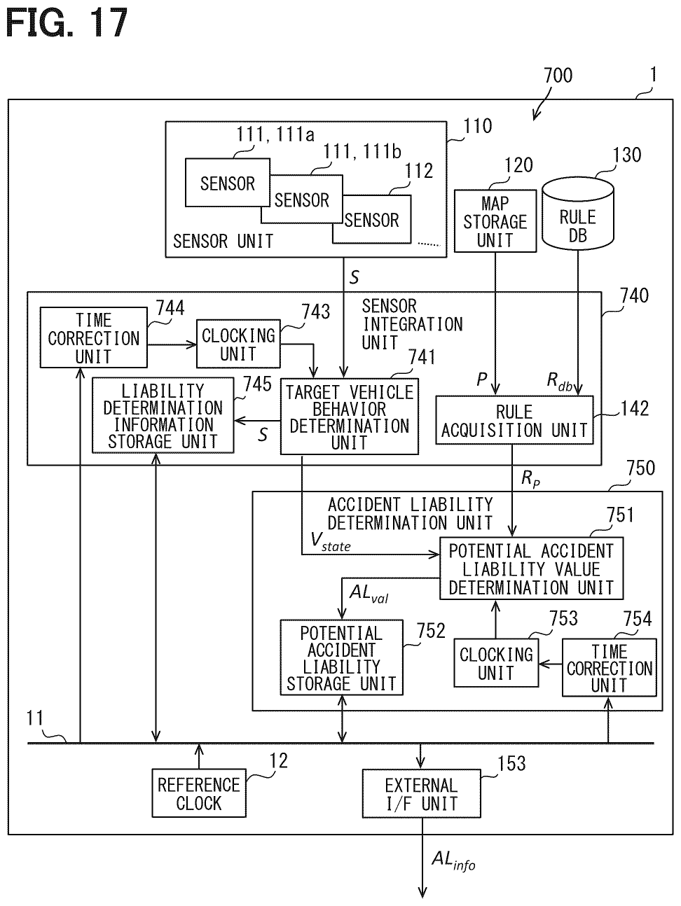

FIG. 17 shows a potential accident liability value determination device 700 of a seventh embodiment. The potential accident liability value determination device 700 has a function as a travel recording system. The potential accident liability value determination device 700 of the seventh embodiment includes the same sensor unit 110, map storage unit 120, and rule DB storage unit 130 as in the first embodiment. Further, the potential accident liability value determination device 700 includes a sensor integration unit 740 and an accident liability determination unit 750.

Further, a host vehicle 1 equipped with the potential accident liability value determination device 700 is provided with an in-vehicle LAN 11 and a reference clock 12. The in-vehicle LAN 11 is a communication network constructed inside the host vehicle 1, and has a configuration including a plurality of network lines. Various elements included in the potential accident liability value determination device 700 can transmit and receive signals to and from other devices mounted on the host vehicle 1 via the in-vehicle LAN 11. Further, the transmission/reception of signals between the elements included in the potential accident liability value determination device 700 may be performed by the in-vehicle LAN 11.

The reference clock 12 measures a time as a reference (hereinafter referred to as a reference time). When the host vehicle 1 is equipped with a GNSS receiver, a clock having built the GNSS receiver therein can be used as the reference clock 12. The clock with the GNSS receiver built therein is sequentially corrected based on the time transmitted by a GNSS artificial satellite. However, as the reference clock 12, a clock that does not have a function of correcting the clock based on the time acquired from the outside of the host vehicle 1 may be used. The reference clock 12 is connected to the in-vehicle LAN 11 and can transmit a signal indicating the reference time to another device mounted on the host vehicle 1 via the in-vehicle LAN 11.

### [Explanation of Sensor Integration Unit 740]

The sensor integration unit 740 includes a target vehicle behavior determination unit 741, the same rule acquisition unit 142 as in the first embodiment, a clocking unit 743, a time correction unit 744, and a liability determination information storage unit 745.

The clocking unit 743 measures the current time. Hereinafter, the time measured by the clocking unit 743 will be referred to as a measurement time. As a method for measuring the time by the clocking unit 743, various methods such as a method for measuring the time by a counter value of a timer and a method including a clock generator, for measuring the time by measuring the number of clocks can be adopted.

The time correction unit 744 can be realized as the function of a computer. The time correction unit 744 acquires the reference time from the reference clock 12, and corrects the measurement time measured by the clocking unit 743 to the reference time acquired from the reference clock 12. The cycle of correcting the time can be defined as a constant cycle set in advance. Further, the time correction unit 744 may correct the time when a predetermined event that occurs irregularly such as when the sensor integration unit 740 is started occurs. In addition, the time point when the measurement time is corrected may be determined by combining a constant cycle and the time when an irregular event occurs.

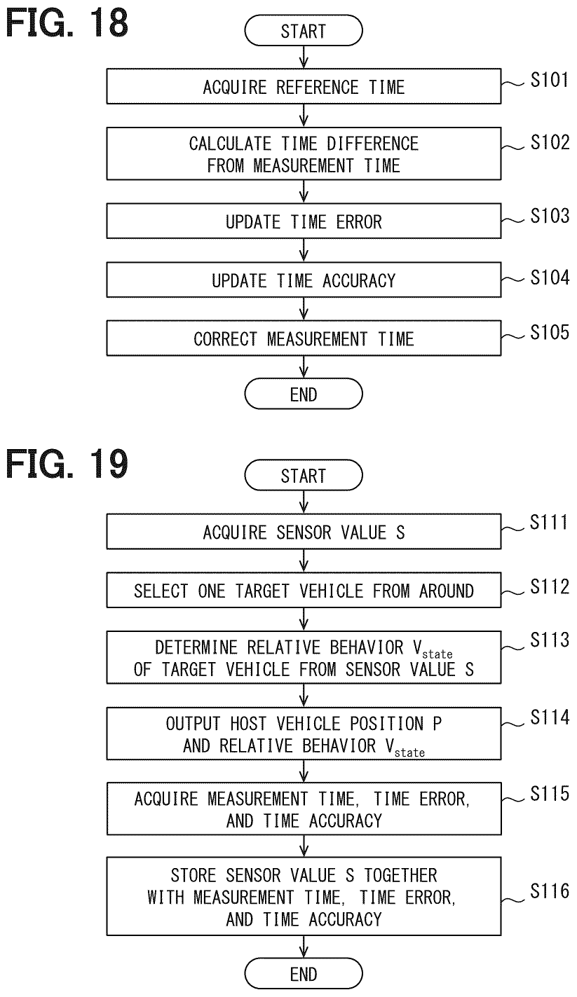

FIG. 18 shows time correction processing executed by the time correction unit 744. In S101, the reference time is acquired from the reference clock 12. In S102, the measurement time is acquired from the clocking unit 743, and the time difference between the measurement time and the reference time is calculated. In S103, a time error per unit elapsed time after the measurement time is corrected is updated based on the time difference calculated in S102. The time error of this time can be calculated by dividing the time difference calculated in S102 of this time by the elapsed time after the measurement time is corrected. Then, the average value is calculated by using the time error calculated up to the previous time and the time error calculated this time as a population. This average value is the time error after the updating.

In S104, the time accuracy of the measurement time is updated. The time accuracy can be taken as a standard deviation of the above population. The updated time error and measured accuracy of time are stored in a predetermined memory provided in the sensor integration unit 740.

In S105, the measurement time of the clocking unit 743 is corrected to be the reference time acquired in S101. Thus, the time correction unit 744 of the seventh embodiment not only corrects the measurement time, but also updates the time error and the time accuracy.

The description is returned to FIG. 17. The target vehicle behavior determination unit 741 in the seventh embodiment also executes the following processing in addition to the processing executed by the target vehicle behavior determination unit 141 in the first embodiment. The target vehicle behavior determination unit 741 executes processing of acquiring a measurement time from the clocking unit 743 and storing a sensor value S in the liability determination information storage unit 745 with the measurement time as a time stamp. The target vehicle behavior determination unit 741 periodically executes this processing while the host vehicle 1 is traveling. An execution cycle can be the same as the cycle for storing the potential accident information AL_{info} in the first embodiment.

Further, the target vehicle behavior determination unit 741 also stores the latest time error and time accuracy updated by the time correction unit 744 in the liability determination information storage unit 745 together with the measurement time. The liability determination information storage unit 745 is configured to include a writable non-volatile memory.

FIG. 19 shows processing executed by the target vehicle behavior determination unit 741. S111 is the same processing as S1 and acquires a sensor value S. S112 is the same processing as S2, and one target vehicle is selected from around the host vehicle 1. S113 is the same processing as S3, and a relative behavior Vₛₜₐₜₑ of the target vehicle is determined using the sensor value S acquired in S111. In S114, a host vehicle position P included in the sensor value S acquired in S111 and the relative behavior Vₛₜₐₜₑ determined in S113 are output to the potential accident liability value determination unit 751.

In S115, the measurement time is acquired from the clocking unit 743, and the time error and time accuracy updated by the time correction unit 744 are also acquired. In S116, the sensor value S acquired in S111 is stored in the liability determination information storage unit 745 together with the measurement time, time error, and time accuracy acquired in S115.

### [Description of Accident Liability Determination Unit 750]

Next, the accident liability determination unit 750 will be described. The accident liability determination unit 750 is realized by a computer different from that for the sensor integration unit 740. The accident liability determination unit 750 includes a potential accident liability value determination unit 751, a potential accident liability storage unit 752, a clocking unit 753, and a time correction unit 754. The accident liability determination unit 750 does not include the external I/F unit 153 and is connected to the external I/F unit 153 via the in-vehicle LAN 11.

The clocking unit 753 measures the current time. The clocking unit 753 can have the same configuration as the clocking unit 743. The time correction unit 754 can be realized as a function of a computer. The time correction unit 754 has the same function as the time correction unit 744, and executes the processing shown in FIG. 18 to correct the measurement time with respect to the clocking unit 753 and update the time error and the time accuracy.

The potential accident liability value determination unit 751 calculates a potential accident liability value ALᵥₐₗ in the same manner as the potential accident liability value determination unit 151 of the first embodiment. Also, the potential accident liability value determination unit 751 executes processing of acquiring a measurement time from the clocking unit 753 and storing the potential accident liability value ALᵥₐₗ in the potential accident liability storage unit 752 with the measurement time as a time stamp. The potential accident liability value determination unit 751 periodically executes this processing while the host vehicle 1 is traveling. An execution cycle is preferably the same as that of the target vehicle behavior determination unit 741.

Further, the potential accident liability value determination unit 751 also stores the latest time error and time accuracy updated by the time correction unit 754 in the potential accident liability storage unit 752 together with the measurement time. The potential accident liability storage unit 752 is configured to have a writable non-volatile memory. Since the sensor integration unit 740 and the accident liability determination unit 750 are separate computers, the potential accident liability storage unit 752 is hardware different from the liability determination information storage unit 745.

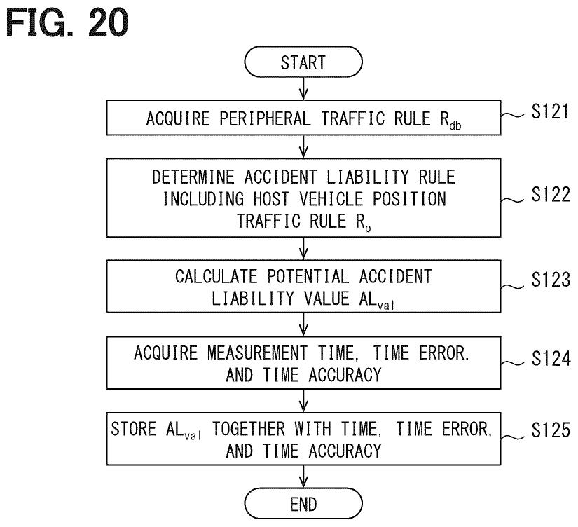

FIG. 20 shows processing executed by the potential accident liability value determination unit 751. S121 is the same processing as S4 in FIG. 2 and acquires a peripheral traffic rule Rab around the host vehicle position P. S122 is the same processing as S5 and determines a traffic rule at the host vehicle position P. S123 is the same processing as S6 and calculates the potential accident liability value ALᵥₐₗ.

In S124, the measurement time is acquired from the clocking unit 753, and the time error and time accuracy updated by the time correction unit 754 are also acquired. In S125, the potential accident liability value ALᵥₐₗ calculated in S123 is stored in the potential accident liability storage unit 752 together with the measurement time, time error, and time accuracy acquired in S124.

The set of the sensor value S and the measurement time stored in the liability determination information storage unit 745 is taken as a sensor value S with time. The set of the potential accident liability value ALᵥₐₗ and the measurement time stored in the potential accident liability storage unit 752 is taken as a potential accident liability value ALᵥₐₗ with time. Also, in the seventh embodiment, the sensor value S with time also includes the time error and time accuracy, and the potential accident liability value ALᵥₐₗ with time also includes the time error and time accuracy. The sensor value S with time and the potential accident liability value ALᵥₐₗ with time can be output to an external device via the external I/F unit 153.

### Summary of Seventh Embodiment

In the seventh embodiment, the sensor value S which is the liability determination information is stored in the liability determination information storage unit 745 together with the measurement time. The potential accident liability value ALᵥₐₗ is stored together with the measurement time in the potential accident liability storage unit 752 which is a storage unit different from the liability determination information storage unit 745. The sensor value S and the potential accident liability value ALᵥₐₗ are stored together with the measurement time, so that the time stamp is given. The time stamp only indicates the time when for the sensor value S and the potential accident liability value ALᵥₐₗ, they have been acquired or calculated. However, the potential accident liability value ALᵥₐₗ and the sensor value S used for calculating the potential accident liability value ALᵥₐₗ can be associated ex post facto by the time stamp. It can be said that the time stamp is an association index which enables the potential accident liability value ALᵥₐₗ and the sensor value S to be associated with each other.

In the next embodiment, description will be made as to an embodiment for verifying the potential accident liability value ALᵥₐₗ stored in the potential accident liability storage unit 752 using the sensor value S stored in the liability determination information storage unit 745.

The potential accident liability value ALᵥₐₗ with the time specified by the time when verification is required is output to the external device. In addition, a sensor value S with the time in a predetermined time range including the same time as the potential accident liability value ALᵥₐₗ with the time is outputted to the external device. The time range is set so as to include the sensor value S used for calculating the potential accident liability value ALᵥₐₗ with the time, even if the time error or the time error and the time accuracy are taken into consideration.

At the moment when the time correction units 744 and 754 correct the measurement times measured by the clocking units 743 and 753, it can be considered that the measurement times measured by the two clocking units 743 and 753 are synchronized.

However, as the elapsed time since the correction becomes longer, the difference between the measurement times measured by the two clocking units 743 and 753 becomes larger. Therefore, the external device acquires not only the sensor value S with the time at the same time as the potential accident liability value ALᵥₐₗ with the time, but also the sensor value S with the time in the predetermined time range including that time. The time range can be set in advance. Also, the above time range may be determined by referring to the time error included in the potential accident liability value ALᵥₐₗ with the time.

### Eighth Embodiment

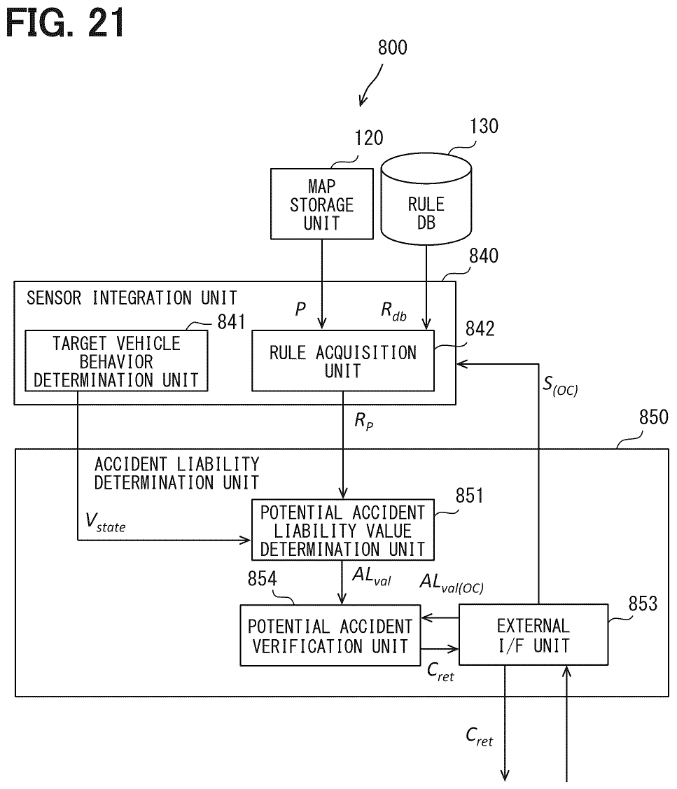

FIG. 21 is a diagram showing a configuration of a potential accident liability value determination device 800 of an eighth embodiment. The potential accident liability value determination device 800 is a device which verifies the reliability of the potential accident liability value ALᵥₐₗ determined by the potential accident liability value determination device 700 mounted on the host vehicle 1 described in the seventh embodiment. The potential accident liability value determination device 800 has a configuration similar to that of the potential accident liability value determination device 200 of the second embodiment. The potential accident liability value determination device 800 is also an example of a potential accident liability determination device. The potential accident liability value determination device 800 can be a fixed type installed at a police station or an insurance company.

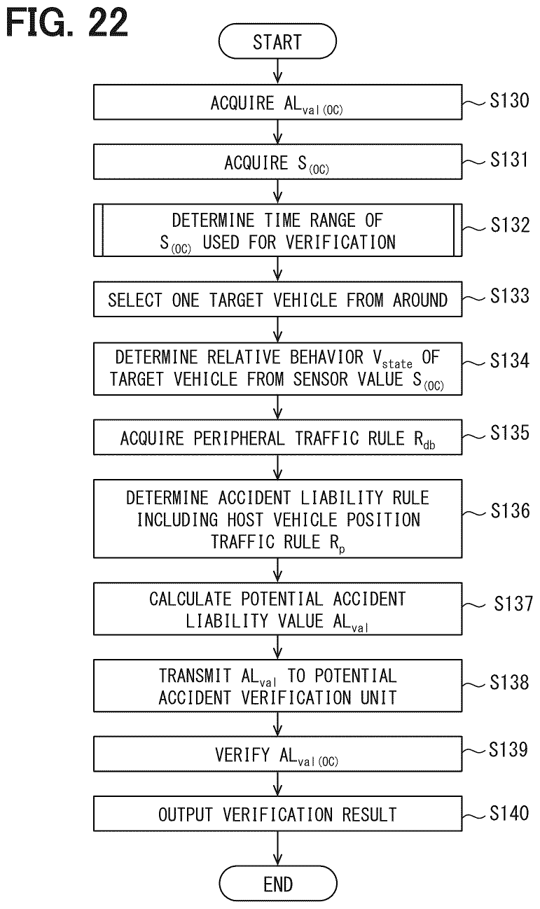

The potential accident liability value determination device 800 includes a map storage unit 120, a rule DB storage unit 130, a sensor integration unit 840, and an accident liability determination unit 850. The sensor integration unit 840 includes a target vehicle behavior determination unit 841 and a rule acquisition unit 842. The accident liability determination unit 850 includes a potential accident liability value determination unit 851, an external I/F unit 853, and a potential accident verification unit 854. The external I/F unit 853 is the same as the external I/F unit 153. Among the elements included in the sensor integration unit 840 and the accident liability determination unit 850, the elements other than the external I/F unit 853 will be described using a flowchart shown in FIG. 22.

In the seventh embodiment, the external I/F unit 853 is connected with an external device which has read out the sensor value S with the time and the potential accident liability value ALᵥₐₗ with the time. The sensor value S with the time input to the external I/F unit 853 is the other vehicle sensor value S_{(OC)} as with the sensor value S input to the external I/F unit 153 in the second embodiment. Further, the potential accident liability value ALᵥₐₗ with the time input to the external I/F unit 853 is the other vehicle potential accident liability value AL_{val(OC)} as with the potential accident liability value ALᵥₐₗ input to the external I/F unit 153 in the second embodiment.

Next, a flowchart of FIG. 22 will be described. Processing shown in this flowchart is started when a predetermined start condition is established after the external device is connected to the external I/F unit 853. The predetermined start condition is, for example, that a user has performed a start operation.

S130 is processing executed by the potential accident verification unit 854 and acquires the potential accident liability value ALᵥₐₗ with the time at the time when verification is required, from the external device via the external I/F unit 853. The potential accident liability value ALᵥₐₗ acquired here is set as the other vehicle potential accident liability value AL_{val(OC)}. The time when the verification is required is not limited to one time alone, and may be a time in a certain range. The range of the time when the verification is required can be set by the user who operates the potential accident liability value determination device 800, depending on the situation of the accident and the like. The following processing is executed for the potential accident liability value ALᵥₐₗ with each time included in the time range where this verification is required.

The target vehicle behavior determination unit 841 executes S131 to S134. In S131, the sensor value S with the time in the above time range is acquired from the external device via the external I/F unit 853. The sensor value S with the time acquired from the external device is the other vehicle sensor value S_{(OC)} with the time.

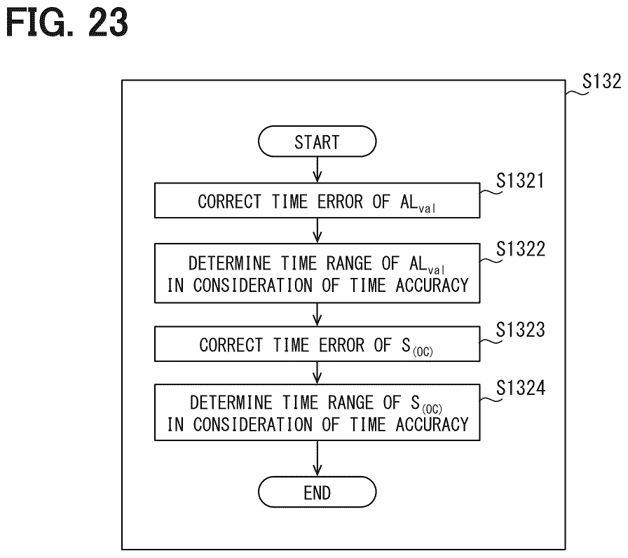

In S132, the time range of the other vehicle sensor value S_{(OC)} used for verification is determined. The processing of S132 is shown in detail in FIG. 23. In FIG. 23, in S1321, the measurement time when the potential accident liability value ALᵥₐₗ with the time acquired in S130 is measured is corrected by a time error.

In S1322, the time range of the potential accident liability value ALᵥₐₗ to be verified by the sensor value S is determined based on the time accuracy included in the potential accident liability value ALᵥₐₗ with the time acquired in S130. For example, the range of ±σ centered on the time when the potential accident liability value ALᵥₐₗ after correction in S1321 is measured is set as the time range of the potential accident liability value ALᵥₐₗ verified by the sensor value S. It is to be noted that σ is the standard deviation.

In S1323, the measurement time obtained by measuring the sensor value S with the time acquired in S131 is corrected by the time error. In S1324, the time range of the other vehicle sensor value S_{(OC)} used for verification is determined based on the time accuracy included in the sensor value S with the time acquired in S131. For example, the time obtained by further subtracting −σ of the sensor value S from the minimum value in the time range determined in S1322 is set as the minimum value of the other vehicle sensor value S_{(OC)} used for verification. Then, the time obtained by further adding σ of the sensor value S to the maximum value in the time range determined in S1322 is set as the maximum value of the other vehicle sensor value S_{(OC)} used for verification.

The description is returned to FIG. 22. S133 is the same as S22 in FIG. 5, and one target vehicle is selected from around the liability value determination vehicle. In S134, the relative behavior Vₛₜₐₜₑ of the target vehicle at each time included in the time range determined in S132 is determined with respect to the target vehicle selected in S133 by using the other vehicle sensor value S_{(OC)} acquired in S131.

The rule acquisition unit 842 executes S135 and S136. In S135, the host vehicle position P included in the other vehicle sensor value S_{(OC)} acquired in S131 is set as the position of the liability value determination vehicle, and the peripheral traffic rule R_{db} is acquired from the rule DB storage unit 130 based on that position. In S136, the traffic rule at the position of the liability value determination vehicle is determined based on the position of the liability value determination vehicle and the peripheral traffic rule R_{db} acquired in S135. An accident liability rule to be used in the next S137 is determined by combining the traffic rule at the position of the liability value determination vehicle and the rule not depending on the position.

S137 and S138 are executed by the potential accident liability value determination unit 851. In S137, the potential accident liability value ALᵥₐₗ at each time is calculated based on the relative behavior Vₛₜₐₜₑ of the target vehicle at each time determined in S134 and the accident liability rule determined in S136. In S138, the potential accident liability value ALᵥₐₗ at each time calculated in S137 is transmitted to the potential accident verification unit 854.

S139 and S140 are executed by the potential accident verification unit 854. In S139, it is verified whether or not the other vehicle potential accident liability value AL_{val(OC)} acquired in S130 is reliable. In S137, the potential accident liability values ALᵥₐₗ at a plurality of times are calculated for one other vehicle potential accident liability value AL_{val(OC)} to be verified. This is because the time accuracy of the two clocking units 743 and 753 has been taken into consideration.

Various methods can be adopted as specific methods for verification. For example, the differences between all the potential accident liability values ALᵥₐₗ calculated in S137 and the other vehicle potential accident liability value AL_{val(OC)} are calculated. When the differences calculated for all the potential accident liability values ALᵥₐₗ are all smaller than the threshold value Cₜₕ, the verification results are regarded as no difference.

Further, the verification result may be determined individually by the same method as in the second embodiment with respect to the potential accident liability value ALᵥₐₗ at each time calculated in S137. When the verification result is determined individually, the reliability of the verification result may be added according to the time difference from the measurement time when the measurement error is only corrected.

In S140, the verification result determined in S139 is output to a predetermined output target device such as an external device connected to the external I/F unit 853.

### Summary of Eighth Embodiment

Even if the relative position between the host vehicle 1 and the target vehicle differs by several tens of centimeters or less in the case where an accident occurs, it greatly affects the degree of the accident. This degree of difference can occur even in as little as about 10 milliseconds.

Thus, the potential accident liability value determination device 700 of the seventh embodiment described above stores the time error and time accuracy of the clocking unit 743 together with the sensor value S and the measurement time. Also, the potential accident liability value determination device 700 stores the time error and time accuracy of the clocking unit 753 together with the potential accident liability value ALᵥₐₗ and the measurement time.

Then, in this potential accident liability value determination device 800, the time range of the other vehicle sensor value S_{(OC)} used for verification is determined in consideration of the time error and time accuracy of the clocking unit 743 and the time error and time accuracy of the clocking unit 753. By doing so, even if the sensor value S and the potential accident liability value ALᵥₐₗ are stored separately, the potential accident liability value ALᵥₐₗ can be verified with high reliability.

### Ninth Embodiment

A modification of the seventh and eighth embodiments will be described as a ninth embodiment. In the eighth embodiment, the time range of the other vehicle sensor value S_{(OC)} used for verification has been determined in consideration of the time error and time accuracy of the clocking unit 743 and the time error and time accuracy of the clocking unit 753, i.e., the four factors in total.

It is however not necessary to consider all of these four factors. The time range may be determined in consideration of any three, any two, and any one of these four. Thus, in the potential accident liability value determination device 700, only any three, any two, and any one of these four may be stored together with the sensor value S and the potential accident liability value ALᵥₐₗ.

For example, the time range of the other vehicle sensor value S_{(OC)} used for verification may be determined in consideration of only the time error of the clocking unit 743 and the time error of the clocking unit 753. In this case, the liability determination information storage unit 745 stores the measurement error of the clocking unit 743 together with the sensor value S and the measurement time of the clocking unit 743. The potential accident liability storage unit 752 stores the measurement error of the clocking unit 753 together with the potential accident liability value ALᵥₐₗ and the measurement time of the clocking unit 753.

When only the time error is taken into consideration, the time error is corrected, and the other vehicle sensor value S_{(OC)} in which the measurement time after the correction matches the measurement time given to the potential accident liability value ALᵥₐₗ is determined to be the other vehicle sensor value S_{(OC)} used for verification.

Further, the time range of the other vehicle sensor value S_{(OC)} used for verification may be determined considering only the accuracy, i.e., only either one or both of the time accuracy of the clocking unit 743 and the time accuracy of the clocking unit 753 and without considering the time error. In this case, the liability determination information storage unit 745 stores the measurement accuracy of the clocking unit 743 together with the sensor value S and the measurement time of the clocking unit 743. The potential accident liability storage unit 752 stores the measurement accuracy of the clocking unit 753 together with the potential accident liability value ALᵥₐₗ and the measurement time of the clocking unit 753.

### Tenth Embodiment

A tenth embodiment is a modification of the seventh and ninth embodiments. In the seventh and ninth embodiments, there has been described the embodiment in which at least one of the time error and time accuracy of the measurement time is stored together with the measurement time.

However, neither the time error of the measurement time nor the time accuracy thereof needs to be stored. If done in this way, the reliability of the verification result in which the potential accident liability value ALᵥₐₗ is verified is inferior to the eighth and ninth embodiments, but it is possible to verify the potential accident liability value ALᵥₐₗ.

### Eleventh Embodiment

In each embodiment so far, the potential accident liability information stored in each of the storage units 152, 252, 352, 552, and 752 was the potential accident liability value ALᵥₐₗ. However, the presence or absence of liability obtained by comparing the potential accident liability value ALᵥₐₗ with a predetermined threshold value for determining the presence or absence of liability may be stored instead of the potential accident liability value ALᵥₐₗ. Further, the presence or absence of the above liability may be stored together with the potential accident liability value ALᵥₐₗ.

In addition, even in the second, fourth, and eighth embodiments, the potential accident liability information output to the potential accident verification units 254, 454, and 854 may be the presence or absence of the above liability.

### Twelfth Embodiment

In the third embodiment, the relative behavior Vₛₜₐₜₑ of the target vehicle and the accident liability rule are included in the potential accident information AL_{info} as the liability value determination information R_{info}. However, the accident liability rule can be obtained from the rule DB storage unit 130 if the position can be specified. Accordingly, when the potential accident information AL_{info} includes information that can determine the position, the liability value determination information R_{info} does not have to include the accident liability rule.

### Thirteenth Embodiment

In the fifth embodiment, the potential accident liability value determination device 500 have periodically transmitted the peripheral liability value determination information RS_{info}. However, the potential accident liability value determination device 500 may transmit the peripheral liability value determination information RS_{info} after the accident according to the request from the liability value server Sr or the like. When done in this way, the amount of communication data can be reduced as compared with the case where the peripheral liability value determination information RS_{info} is periodically transmitted. Thus, the present embodiment is particularly effective when the data amount of the peripheral liability value determination information RS_{info} is large, such as when image data is included in the peripheral liability value determination information RS_{info}.

### Fourteenth Embodiment

In the first embodiment, the liability value determination information R_{info} included in the potential accident information AL_{info} was the sensor value S. Further, in the third embodiment, the liability value determination information R_{info} included in the potential accident information AL_{info} was the relative behavior Vₛₜₐₜₑ of the target vehicle and the accident liability rule thereof. However, the sensor value S, and the relative behavior Vₛₜₐₜₑ of the target vehicle and the accident liability rule thereof may both be included in the potential accident information AL_{info}.

### Fifteenth Embodiment

In the first embodiment, it has been described that the host vehicle position P may be included in the sensor value S which is the liability value determination information. In addition to or instead of that, the detected value detected by the sensor 112, which is the host vehicle behavior sensor detecting the behavior of the host vehicle 1 may be included in the potential accident information AL_{info}. The detected value detected by the sensor 112 includes, for example, a vehicle speed, a yaw rate, and acceleration. Further, the detected value detected by the sensor 112 may include various values related to the behavior of the host vehicle 1, such as a steering angle, steering torque, brake oil pressure, an accelerator opening degree, and control required values, in addition to those described above.

When the detected value detected by the sensor 112 which is included in the potential accident information AL_{info} is included in the liability value determination information, the detected value detected by the sensor 112 is associated with the potential accident liability value ALᵥₐₗ and the sensor value S.

Further, the behavior of the host vehicle 1 determined from the detected value detected by the sensor 112 may be included in the potential accident information AL_{info} Of the third embodiment, i.e., the potential accident information AL_{info} including the relative behavior Vₛₜₐₜₑ and accident liability rule of the target vehicle in place of the sensor values S.

When the behavior of the host vehicle 1 is included in the potential accident information AL_{info}, the behavior of the host vehicle 1 is associated with the potential accident liability value ALᵥₐₗ and the relative behavior Vₛₜₐₜₑ of the target vehicle.

In addition, in the seventh embodiment, the detected value detected by the sensor 112 may be included in the sensor value S stored together with the measurement time. In this case, the detected value detected by the sensor 112 is associated with the sensor value S detected by the sensor 111, that is, the liability value determination information, and is stored so as to correspond to the potential accident liability value ALᵥₐₗ.

### Sixteenth Embodiment

In the embodiments so far, the potential accident liability information and the accident liability determination information used for determining the potential accident liability information are associated with each other or stored so as to be associated with each other. On the other hand, in the following embodiments, instead of the potential accident liability information, a video that can be an example of the potential accident liability information is stored. Further, instead of the accident liability determination information that can be used as information indicating the liability of the accident during automatic driving, a driving state indicating whether the vehicle is in automatic driving or non-automatic driving is stored. Due to these differences, the system configuration is different from the embodiments so far.

### [Schematic Configuration of Vehicle System 1001]

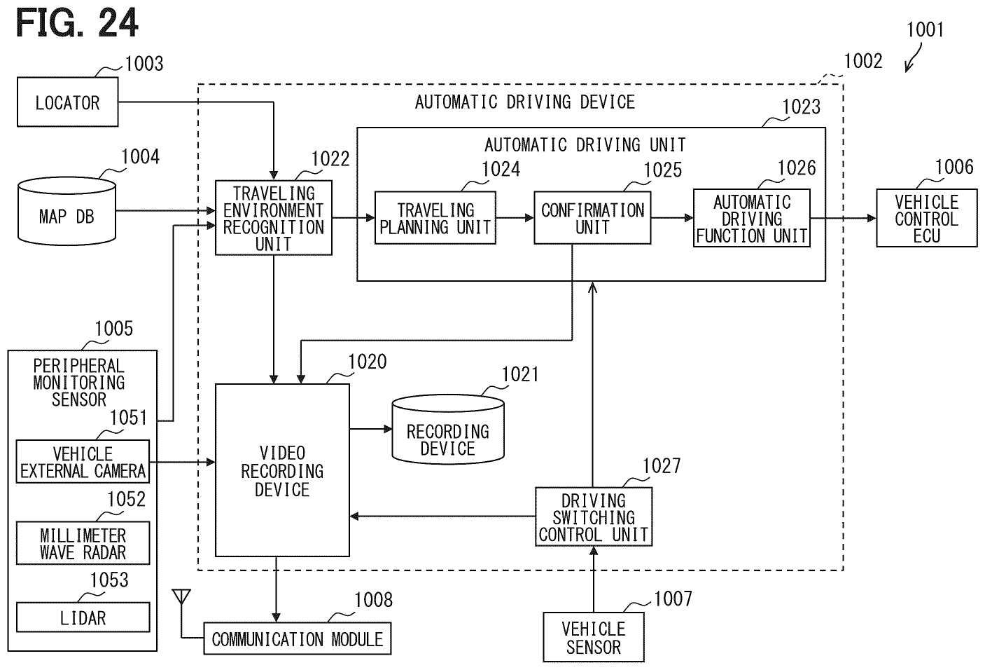

Hereinafter, the sixteenth embodiment of the present disclosure will be described using the drawings. The vehicle system 1001 shown in FIG. 24 is used in a vehicle in which the degree of automatic driving can be switched, and includes an automatic driving device 1002, a locator 1003, a map database (hereinafter referred to as map DB) 1004, a peripheral monitoring sensor 1005, a vehicle control ECU 1006, a vehicle sensor 1007, and a communication module 1008. The vehicle using the vehicle system 1001 is not necessarily limited to an automobile, but the case where it is used for an automobile will be described below by way of example. Hereinafter, the vehicle using the vehicle system 1001 is referred to as a host vehicle.

The host vehicle may be a vehicle that can be switched between automatic driving to the extent that it is stipulated to be legally liable for accidents and non-automatic driving which does not perform this automatic driving. As the degree of automatic driving (hereinafter referred to as automation level), there may exist a plurality of levels as defined by SAE, for example. The automation level is classified into levels 0 to 5 as follows, for example, in the definition of SAE.

The level 0 is a level at which a driver performs all driving tasks without the intervention of the system. The driving tasks include, for example, steering and acceleration/deceleration. The level 0 corresponds to a so-called manual operation. The level 1 is a level at which the system supports either steering or acceleration/deceleration. The level 2 is a level at which the system supports both steering and acceleration/deceleration. The levels 1 and 2 correspond to a so-called driving support.

The level 3 is a level at which the system can perform all driving tasks in a specific place such as a highway, and the driver performs driving operations in an emergency. At the level 3, the driver is required to be able to respond promptly when the system requests a change of driving. The level 3 corresponds to so-called conditional automatic driving. The level 4 is a level at which the system can perform all driving tasks except under specific circumstances such as unresponsive roads and extreme environments. The level 4 corresponds to so-called advanced automatic driving. The level 5 is a level at which the system can perform all driving tasks under any environment. The level 5 corresponds to so-called fully automatic driving. The levels 3 to 5 correspond to so-called automatic driving.

Here, the automatic driving with the degree that it is stipulated to be legally liable for an accident is determined in accordance with the law, and may be, for example, automatic driving with an automation level of the level 3 or higher, or may be automatic driving with an automatic level of the level 4 or higher. The non-automatic driving may be manual driving of the level 0 or may include driving support of the level 2 or less. In the present embodiment, as an example, description will be continued assuming that the host vehicle can be switched between automatic driving of the automation level 3 or higher (hereinafter simply referred to as automatic driving) and manual driving of the level 0 (hereinafter simply referred to as manual driving).

The locator 1003 is equipped with a GNSS (Global Navigation Satellite System) receiver and an inertial sensor. The GNSS receiver receives positioning signals from a plurality of positioning satellites. The inertial sensor includes, for example, a gyro sensor and an acceleration sensor. The locator 1003 sequentially positions the vehicle position of the host vehicle (hereinafter referred to as a host vehicle position) on which the locator 1003 is mounted by combining the positioning signal received by the GNSS receiver and a measurement result of the inertial sensor. The position of the host vehicle is assumed to be represented by, for example, the coordinates of latitude and longitude. For the positioning of the host vehicle position, a configuration may be taken which uses the mileage obtained from signals sequentially output from the vehicle speed sensor mounted on the host vehicle.

The map DB 1004 is a non-volatile memory and stores map data such as link data, node data, road shapes, and structures. The map data may be a three-dimensional map comprised of a point cloud of feature points of road shapes and structures. When the three-dimensional map consisting of the point cloud of the feature points of the road shapes and structures is used as the map data, the locator 1003 may be configured to specify the host vehicle position by using the three-dimensional map and the result of detection of the point cloud by LIDAR (Light Detection and Ranging/Laser Imaging Detection and Ranging) or the peripheral monitoring sensor 1005 such as a vehicle external camera which detects the point cloud of the feature points of the road shapes and structures, without using the GNSS receiver. The three-dimensional map may be one generated by REM (Road Experience Management) based on a captured image.

The peripheral monitoring sensor 1005 is an autonomous sensor which monitors the surrounding environment of the host vehicle. As an example, the peripheral monitoring sensor 1005 is used for recognition of objects around the host vehicle, such as moving objects such as pedestrians, animals other than humans, vehicles or the like other than the host vehicle, and unmoving stationary objects such as guardrails, curbs, and trees. In addition to the above, the peripheral monitoring sensor is also used for recognizing road markings such as traveling lane markings around the host vehicle. The peripheral monitoring sensor 1005 includes, for example, a vehicle external camera which captures a predetermined range around the host vehicle, a millimeter-wave radar which transmits exploration waves to a predetermined range around the host vehicle, sonar, and a range-finding sensor such as LIDAR. Even other than the above, the peripheral monitoring sensor 1005 includes a sound collector or the like which collects sounds around the host vehicle. The present embodiment will be described by taking as an example, the case where the vehicle external camera 1051, millimeter wave radar 52, and LIDAR 53 are used as the peripheral monitoring sensor 1005.

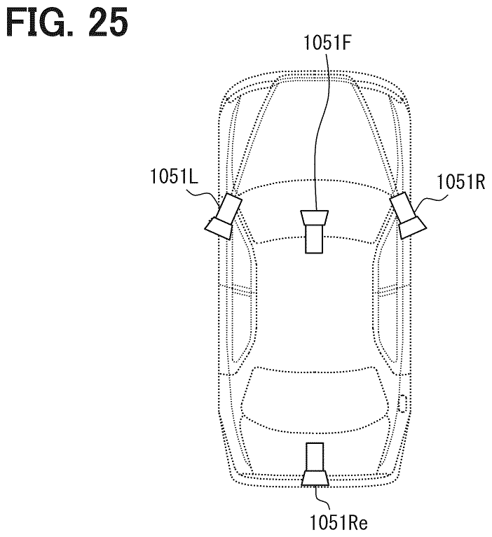

The vehicle external camera 1051 is an example of an in-vehicle camera and sequentially outputs images to be sequentially captured to the automatic driving device 1002 as sensing information. As an example, as the vehicle external camera 1051, as shown in FIG. 25, vehicle external cameras 1051F, 1051R, 1051L, and 1051Re are provided in the host vehicle.

The vehicle external camera 1051F is a camera in which a predetermined range in front of the own vehicle is taken as a shooting range. The vehicle external camera 1051F may be configured to be provided at a position which does not block the driver's view relative to the front of the vehicle, such as the vicinity of the rearview mirror in the vehicle interior of the host vehicle or the upper end of the windshield. Further, the vehicle external camera 1051F may be configured to be provided, for example, near the center of the front bumper of the host vehicle in the vehicle width direction.

The vehicle external camera 1051R is a camera in which a predetermined range on the right rear side of the host vehicle is taken as a shooting range. The vehicle external camera 1051R may be configured to be provided, for example, in the vicinity of the right side mirror of the host vehicle. The vehicle external camera 1051L is a camera in which a predetermined range on the left rear side of the host vehicle is taken as a shooting range. The vehicle external camera 1051L may be configured to be provided, for example, in the vicinity of the left side mirror of the host vehicle.

The vehicle external camera 1051 Re is a camera in which a predetermined range behind the host vehicle is taken as a shooting range. The vehicle external camera 1051 Re may be installed at a position which does not block the driver's view for rear confirmation, such as near the center of the rear bumper of the host vehicle in the vehicle width direction. Further, the vehicle external camera 1051Re may be configured to be provided, for example, near the upper end of the rear window.

The vehicle external cameras 1051F, 1051R, 1051L, and 1051Re may have overlapping shooting ranges. It is preferable to provide the vehicle external cameras 1051F, 1051R, 1051L, and 1051 Re as the vehicle external camera 1051 so that the entire circumference of the host vehicle is taken as the shooting range. The vehicle external camera 1051 is not limited to the configuration in which the entire circumference of the host vehicle is taken as the shooting range, but may be a configuration in which it is limited to a part of the shooting range.

The vehicle control ECU 1006 is an electronic control device which controls the traveling of the host vehicle. The traveling control includes acceleration/deceleration control and/or steering control. The vehicle control ECU 1006 includes a steering ECU which performs steering control, a power unit control ECU which performs acceleration/deceleration control, a brake ECU, and the like. The vehicle control ECU 1006 performs traveling control by outputting control signals to each traveling control device such as an electronically controlled throttle, a brake actuator, an EPS (Electric Power Steering) motor, etc. mounted on the host vehicle.

The vehicle sensor 1007 is a sensor group for detecting various states of the host vehicle. The vehicle sensor 1007 includes a vehicle speed sensor, a steering sensor, an acceleration sensor, a yaw rate sensor, a switch for operation switching, a brake pedal force sensor, a steering torque sensor, and the like. The vehicle speed sensor detects the vehicle speed of the host vehicle. The steering sensor detects the steering angle of the host vehicle. The acceleration sensor detects acceleration such as front-rear acceleration and lateral acceleration of the host vehicle. The acceleration sensor may also detect deceleration, which is acceleration in the negative direction. The yaw rate sensor detects the angular velocity of the host vehicle. The operation switching switch is a switch for setting switching between automatic driving and manual driving of the host vehicle. As the operation switching switch, for example, a steering switch or the like provided on a spoke portion of the steering may be used. The brake pedal force sensor detects the pedal force applied to the brake pedal. The steering torque sensor detects steering torque applied to the steering wheel.

The communication module 1008 communicates with a center outside the host vehicle via a public communication network. For example, the communication module may be configured to communicate with a server of an external center (hereinafter referred to as an external server). The communication module 1008 reports to an external server such as a police or an insurance company and transmits a video stored in the automatic driving device 1002. Further, the communication module 1008 may receive map data distributed from the external server which distributes the map data and store the same in the map DB 1004.

The automatic driving device 1002 which functions as an automatic driving system is provided with, for example, a processor, a memory, an I/O, and a bus which connects them, and executes various processing such as processing related to automatic driving, (hereinafter referred to as video storage-related processing) related to the storage of video around the host vehicle, etc. by executing a control program stored in a memory. The memory referred to here is a non-transitory tangible storage medium which non-temporarily stores programs and data that can be read by a computer. Further, the non-transitional tangible storage medium is realized by a semiconductor memory, a magnetic disk, or the like. The details of the automatic driving device 1002 will be described below.

### [Schematic Configuration of Automatic Driving Device 1002]

Subsequently, the schematic configuration of the automatic driving device 1002 will be described using FIG. 24. As shown in FIG. 24, the automatic driving device 1002 includes as functional blocks, a video processing device 1020, a recording device 1021, a traveling environment recognition unit 1022, an automatic driving unit 1023, and a driving switching control unit 1027. Some or all of the functions executed by the automatic driving device 1002 may be configured in hardware by one or a plurality of ICs or the like. Further, some or all of the functional blocks included in the automatic driving device 1002 may be realized by execution of software by a processor and a combination of hardware members.

The video processing device 1020 is an example of a video recording system, which includes, for example, a processor, a memory, an I/O, and a bus connecting these, and executes the video storage-related processing by executing a control program stored in the memory. In the video storage-related processing, the video processing device 1020 saves the video captured by the vehicle external camera 1051 in the recording device 1021 in response to a predetermined trigger. The details of the video processing device 1020 will be described later. The recording device 1021 is an electrically rewritable non-volatile memory. In the present embodiment, the recording device 1021 is configured to be provided in the automatic driving device 1002, but is not necessarily limited to this. For example, the recording device 1021 may be configured to be provided other than the automatic driving device 1002. The recording device 1021 may be configured to be mounted on the host vehicle, or may be configured to be provided in a server to which the video processing device 1020 is accessible via the communication module 1008.

The traveling environment recognition unit 1022 recognizes the traveling environment of the host vehicle from the position of the host vehicle acquired from the locator 1003, the map data acquired from the map DB 1004, the sensing information acquired from the peripheral monitoring sensor 1005, and the like. As an example, the traveling environment recognition unit 1022 recognizes the position, shape, and moving state of an object around the host vehicle by using these information, and generates a virtual space which reproduces the actual traveling environment. From the sensing information acquired from the peripheral monitoring sensor 1005, the traveling environment recognition unit 1022 may recognize the distance of the host vehicle from the peripheral vehicle, the relative speed of the peripheral vehicle relative to the host vehicle, and the like as the traveling environment. Further, when it is possible to acquire position information and speed information of each peripheral vehicle or the like via the communication module 1008, the traveling environment recognition unit 1022 may be configured to recognize the traveling environment by using these information as well.

The automatic driving unit 1023 performs processing related to the substitution of the driving operation by the driver. As shown in FIG. 24, the automatic driving unit 1023 includes a traveling planning unit 1024, a confirmation unit 1025, and an automatic driving function unit 1026 as sub-function blocks.

The traveling planning unit 1024 uses the traveling environment recognized by the traveling environment recognition unit 1022 to generate a traveling plan for driving the host vehicle by automatic driving. For example, as a mid to long-term traveling plan, route search processing is performed to generate a recommended route from the position of the host vehicle to the destination. Further, as a short-term traveling plan for driving according to the mid to long-term traveling plan, the execution of steering for changing lanes, acceleration/deceleration for speed adjustment, steering and braking for avoiding obstacles, etc. is determined. The traveling planning unit 1024 may be configured to generate the traveling plan by, for example, machine learning or the like.

The confirmation unit 1025 evaluates the safety of the traveling plan generated in the traveling planning unit 1024. As an example, in order to more facilitate the evaluation of the safety of the traveling plan, the confirmation unit 1025 may evaluate the safety of the traveling plan by using a mathematical formula model that mathematizes the concept of safe driving. As the mathematical formula model, for example, an RSS (Responsibility Sensitive Safety) model can be used. The confirmation unit 1025 may evaluate safety depending on whether or not the distance between the targets is equal to or greater than a reference distance for evaluating the safety between vehicles (hereinafter referred to as a safe distance), which is calculated by a preset mathematical formula model. The distance between the targets may be the distance between the targets in the front-rear direction or the distance between the targets in the left-right direction. The term “between the targets” referred to here means between the host vehicle and its peripheral obstacles, between vehicles around the host vehicle, and the like. The peripheral obstacles include, for example, stationary objects such as pedestrians and falling objects on the road, in addition to the vehicles around the host vehicle.

When the distance between the targets is equal to or greater than the safe distance, the confirmation unit 1025 may evaluate that the traveling plan generated by the traveling planning unit 1024 is safe. On the other hand, when the distance between the targets is less than the safe distance, the confirmation unit 1025 may evaluate that the traveling plan generated by the traveling planning unit 1024 is not safe. The confirmation unit 1025 may output the traveling plan evaluated as having safety to the automatic driving function unit 1026. On the other hand, the confirmation unit 1025 may modify the traveling plan evaluated as having no safety into the traveling plan evaluated as having safety and output the same to the automatic driving function unit 1026.

The mathematical formula model used for the safety evaluation by the confirmation unit 1025 does not guarantee that an accident will not occur completely, and is for guaranteeing that as long as appropriate action for avoiding a collision is taken where the distance is less than the safe distance, one will not be liable for the accident. For example, when the distance between the host vehicle and peripheral obstacles is less than the safe distance, even if the host vehicle takes appropriate action for avoiding the collision, there is room for an accident depending on the behavior of peripheral obstacles where the peripheral obstacles are moving objects. The peripheral obstacles may be configured to target only surrounding vehicles.

The automatic driving function unit 1026 causes the vehicle control ECU 1006 to automatically accelerate/decelerate and/or steer the host vehicle according to the traveling plan evaluated as having safety in the confirmation unit 1025 to thereby substitute the driving operation by the driver to perform automatic driving.

The driving switching control unit 1027 controls switching between automatic driving and manual driving. The driving switching control unit 1027 causes the automatic driving unit 1023 to start the automatic driving by detecting the operation of switching to the automatic driving by the driver in the area where the automatic driving is possible. Further, the driving switching control unit 1027 systematically switches from the automatic driving to the manual driving before the area where automatic driving is possible ends, with reference to the long to mid-term traveling plan. In addition, when the recognition of the traveling environment by the traveling environment recognition unit 1022 becomes suddenly difficult and it is difficult to continue the automatic driving, the driving switching control unit 1027 switches from the automatic driving to the manual driving. When switching from the automatic operation to the manual operation, a notification requesting a change of driving may be given in advance.

In addition, the driving switching control unit 1027 switches from the automatic driving to the manual driving by detecting the operation of switching to the automatic driving by the driver during the automatic driving. The operation of switching to the automatic driving by the driver includes an operation for switching the setting from the automatic driving to the manual driving with respect to the switch for driving switching. Further, the operation of switching to the automatic driving by the driver includes an override by the driver. As an example, when the pedal force detected by the brake pedal force sensor and the steering torque detected by the steering torque sensor exceed a threshold value, the driving switching control unit 1027 may detect it as an override.

### [Schematic Configuration of Video Processing Device 1020]

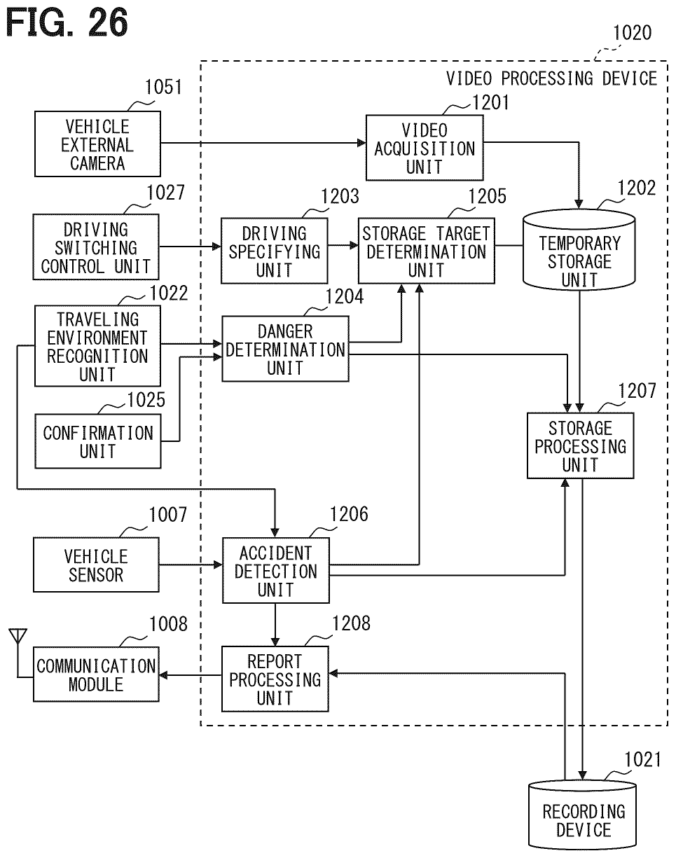

Subsequently, the schematic configuration of the video processing device 1020 will be described using FIG. 26. As shown in FIG. 26, the video processing device 1020 includes a video acquisition unit 1201, a temporary storage unit 1202, a driving specifying unit 1203, a danger determination unit 1204, a storage target determination unit 1205, an accident detection unit 1206, a storage processing unit 1207, and a report processing unit 1208 as functional blocks. Some or all of the functions executed by the automatic driving device 1002 may be configured in hardware by one or a plurality of ICs or the like. Further, some or all of the functional blocks included in the automatic driving device 1002 may be realized by execution of software by a processor and a combination of hardware members.

The video acquisition unit 1201 sequentially acquires a vehicle external image captured by the vehicle external camera 1051. The video acquisition unit 1201 corresponds to a vehicle external vide acquisition unit. Further, the vehicle external video may include an image that can confirm the situation of an accident that occurred in the host vehicle or an accident that occurred around the host vehicle. Accordingly, the vehicle external video is an accident confirmation image. The video acquisition unit 1201 stores the vehicle external images which are acquired sequentially, in the temporary storage unit 1202. The temporary storage unit 1202 is a volatile memory and temporarily stores the vehicle external images which are sequentially stored. The temporary storage unit 1202 may be a ring buffer which stores vehicle external images up to a certain past.

The video acquisition unit 1201 is not limited to the configuration in which the vehicle exterior image captured by the vehicle external camera 1051 is sequentially acquired, and may be configured to sequentially acquire indoor images each captured by an indoor camera photographing the interior of the host vehicle as well. As the indoor camera, a DSM (Driver Status Monitor) camera that monitors the driver of the host vehicle may be used. The DSM is comprised of a near-infrared light source, a near-infrared camera, a control unit for controlling them, and the like. As an example, the DSM may detect the driver's face orientation, arousal level, inoperable state, etc. from the captured image obtained by capturing the driver's face with the near-infrared camera.

The driving specifying unit 1203 specifies whether the host vehicle is in either an automatic driving state or a non-automatic driving state. By monitoring the driving switching control unit 1027, the driving specifying unit 1203 may specify whether the host vehicle is in either the automatic driving state or the non-automatic driving state. In the example of the present embodiment, when the host vehicle is in automatic driving or when the host vehicle is switched from the manual driving to the automatic driving, the driving state of the host vehicle is specified as the automatic driving. On the other hand, when the host vehicle is in manual driving or when the host vehicle is switched from the automatic driving to the manual driving, the driving state of the host vehicle is specified as the non-automatic driving.

The danger determination unit 1204 determines whether or not there is a collision risk between targets such as between the host vehicle and obstacles around the host vehicle and between vehicles around the host vehicle. When the distance between the targets is less than the safe distance calculated by the confirmation unit 1025, the danger determination unit 1204 may determine that there is a collision risk between the targets. On the other hand, when the distance between the targets is equal to or greater than the safe distance calculated by the confirmation unit 1025, the danger determination unit 1204 may determine that there is no collision risk between the targets. When the distance between the targets becomes less than the safe distance in either between the host vehicle and obstacles around the host vehicle or between vehicles around the host vehicle, the danger determination unit 1204 may determine that there is a collision risk.

The storage target determination unit 1205 triggers the danger determination unit 1204 to determine that there is a risk of collision between the targets, and determines the vehicle external image sequentially acquired in the video acquisition unit 1201 and information that can specify the driving state of the host vehicle at the time when the vehicle external image specified by the driving specifying unit 1203 is acquired, as targets to be stored in the recording device 1021 in association with each other (i.e., in correspondence with each other). The information that can identify the driving state of the host vehicle may be, for example, a flag indicating whether the driving state of the host vehicle is automatic driving or non-automatic driving (hereinafter referred to as driving state flag). The association between the vehicle external image and the driving state flag may be configured by, for example, a time stamp or the like.

As an example, the storage target determination unit 1205 determines as the target to be stored, the vehicle external image stored in the temporary storage unit 1202 after the time when the danger determination unit 1204 determines that there is a collision risk between the targets. Further, the storage target determination unit 1205 may be configured to store the driving state flag corresponding to the time when the vehicle external image is acquired, in the temporary storage unit 1202 in association with the vehicle external image. The driving state flag may be configured to be associated with each frame of the vehicle external image. In addition, one driving state flag may be configured to be associated with a plurality of consecutive frames to which the same type of driving state flag is associated. The driving state flag is not limited to the configuration stored in the temporary storage unit 1202 but may be stored in another memory as long as it is configured to be associated with the corresponding vehicle external image.

Further, the storage target determination unit 1205 triggers that the driving state of the host vehicle is switched from the automatic driving to the non-automatic driving, and determines the vehicle external image sequentially acquired in the video acquisition unit 1201 and information that can specify the driving state of the host vehicle at the time when the vehicle external image specified by the driving specifying unit 1203 is acquired, as targets to be stored in the recording device 1021 in association with each other. The storage target determination unit 1205 may determine that the driving state of the host vehicle is switched from the automatic driving to the non-automatic driving from, for example, the driving state of the host vehicle specified by the driving specifying unit 1203.

As an example, the storage target determination unit 1205 determines as a target to be stored, the vehicle external image stored in the temporary storage unit 1202 after the time when the driving state specified by the driving specifying unit 1203 is switched from the automatic driving to the non-automatic driving. Further, the storage target determination unit 1205 may be configured to store the driving state flag corresponding to the time when the vehicle external image is acquired, in the temporary storage unit 1202 in association with the vehicle external image.

The storage target determination unit 1205 is not limited to the configuration in which the vehicle external image and the driving state are associated and stored, but may be configured to store in association with the vehicle external image and the driving state, the indoor image corresponding to the time when the vehicle external image is acquired, information (hereinafter referred to as risk determination related information) used for determination of the presence or absence of a collision risk by the danger determination unit 1204, and the like as well. The danger determination related information referred to here includes, for example, the distance between the targets.

When the storage target determination unit 1205 determines that there is a risk of collision between the vehicles around the host vehicle, the storage target determination unit 1205 preferably also stores the danger determination-related information used to determine by the danger determination unit 1204, the presence or absence of the risk of collision between the peripheral vehicle included in these surrounding vehicles and the host vehicle. According to this, when an accident occurs between the surrounding vehicles, the danger determination-related information used to determine by the danger determination unit 1204, the presence or absence of the risk of collision between the peripheral vehicle included in these surrounding vehicles and the host vehicle can be left as a record. Thus, it becomes possible to verify the degree of proximity between the host vehicle and the peripheral vehicle before the accident occurs between the surrounding vehicles. It becomes easier to prove that the automatic driving of the host vehicle is not liable for the accident between the surrounding vehicles.

The accident detection unit 1206 detects the occurrence of an accident between targets. The accident detection unit 1206 detects the occurrence of an accident between the targets when it is determined by the danger determination unit 1204 that there is a risk of collision between the targets. If the accident is between the host vehicle and its peripheral obstacle, the accident detection unit 1206 may detect the occurrence of the accident from, for example, the signal of the acceleration sensor in the vehicle sensor 1007. In addition, the accident detection unit 1206 may perform detection of the occurrence of an accident between the host vehicle and its peripheral obstacle from an airbag deployment signal of an airbag device, etc. Further, in the case of an accident between the vehicles around the host vehicle, the accident detection unit 1206 may detect the occurrence of the accident from the overlap of the surrounding vehicles in the traveling environment recognized by the traveling environment recognition unit 1022, for example. In addition, the detection of the occurrence of an accident, and the like from information on the surrounding vehicles obtained by vehicle-to-vehicle communication may be performed.

When the occurrence of an accident between the targets is detected by the accident detection unit 1206, the storage processing unit 1207 reads the storage target determined to be stored in the storage target determination unit 1205 until at least the occurrence of this accident from the temporary storage unit 1202 and stores the same in the recording device 1021. That is, when the storage target determination unit 1205 determines the storage target with the trigger of determining by the danger determination unit 1204 that there is a collision risk between the targets, the vehicle external image sequentially acquired in the video acquisition unit 1201 from the time when it is determined that there is a collision risk between the targets to at least the occurrence of an accident between the targets, and the driving state flag or the like corresponding to the time when this vehicle external image is acquired, are stored in the recording device 1021 in association with each other.

According to this, the vehicle external image from the time when it is determined that there is a collision risk between the targets to at least the time when the accident occurs between the targets, and the driving state flag or the like corresponding to the time when this vehicle external image is acquired can be stored in the recording device 1021. Therefore, it is possible to verify the accident by using the vehicle external image at least from the time when the accident occurs to the time when it is determined that there is a risk of collision between the targets. Since it becomes possible to verify the accident by using each vehicle external image up to the time when it is determined that there is a risk of collision between the targets, it becomes easier to investigate the cause of the accident. Further, since the driving state flag corresponding to the time when the vehicle external image is acquired is associated with the vehicle external image, even if it is judged from the vehicle external image that the host vehicle is liable for the occurrence of the accident, it is possible to prove that the host vehicle is not liable for the automatic driving by distinguishing whether the vehicle external image is for the automatic driving or the non-automatic driving. As a result, in each vehicle that can switch between the automatic driving to the extent that it is legally liable for an accident and the non-automatic driving that does not perform this automatic driving, it becomes possible to make it easier to prove that the automatic driving is not liable for the occurrence of the accident.

On the other hand, when the storage target determination unit 1205 determines the target to store with the trigger of switching the driving state of the host vehicle from the automatic driving to the non-automatic driving, the vehicle external image sequentially acquired by the video acquisition unit 1201 from the time of switching from the automatic driving to the non-automatic driving to at least the occurrence of an accident between the targets, and the driving state flag or the like corresponding to the time when the vehicle external image is acquired are associated with each other and stored in the recording device 1021.

According to this, when an accident occurs between the targets, the vehicle external image from the time of switching from the automatic driving to the non-automatic driving to at least the time when the accident occurs between the targets, and the driving state flag or the like corresponding to the time when this vehicle external image is acquired can be stored in the recording device 1021. Thus, it becomes possible to verify the accident by using the vehicle external image at least from the time of the accident occurrence to the time of this switching. When the above-mentioned accident occurs after the degree of the automatic driving of the host vehicle is switched from the automatic driving to the non-automatic driving, the driver may mistakenly claim that the accident has occurred during the automatic driving. On the other hand, it becomes possible to store the vehicle external image during a period in which such a mistaken impression may occur, in the recording device. Further, the driving status flag corresponding to the time when the vehicle external image is acquired is associated with the vehicle external image. Therefore, even if it is judged from the vehicle external image that the host vehicle is liable for the occurrence of the accident, it becomes possible to prove that the host vehicle is not liable for the automatic driving, by distinguishing whether the vehicle external image is for the automatic driving or the non-automatic driving. Consequently, in each vehicle that can switch between the automatic driving to the extent that it is legally liable for an accident and the non-automatic driving that does not execute this automatic driving, it becomes possible to make it easier to prove that it is not liable for the automatic driving with respect to the occurrence of the accident.

When the accident detection unit 1206 detects the occurrence of an accident between the targets, the storage processing unit 1207 preferably stores in the recording device 1021, the storage target determined to be the storage target by the storage target determination unit 1205 until a predetermined time later from the occurrence of this accident. The predetermined time referred to here is a value that can be arbitrarily set. According to this, it becomes easier to investigate the cause of the accident as much as it becomes possible to verify the accident by using the vehicle external image after the occurrence of the accident as well.

The storage processing unit 1207 does not store the storage target determined by the storage target determination unit 1205 in the recording device 1021 where the result of determination by the danger determination unit 1204 between the targets judged to have the collision risk by the danger determination unit 1204 is switched from the presence to the absence of the accident, without detecting the occurrence of the accident between the targets by the accident detection unit 1206. The storage target stored in the temporary storage unit 1202, which is not stored in the recording device 1021, is sequentially deleted from the data that has become the past data above a certain level.

According to this, it makes it possible to save the vehicle external image that goes back to the time when it was judged that there was a risk of collision between the targets. Consequently, while it makes it easier to investigate the cause of the accident, the vehicle external image highly likely to be unrelated to the occurrence of the accident is prevented from being stored in the recording device 1021 more accurately, thereby making it possible to make it difficult to press the capacity of the recording device 1021.

When the storage target is determined by the storage target determination unit 1205 with the trigger of switching from the automatic driving to the non-automatic driving and when the elapsed time from the time of switching from the automatic driving to the non-automatic driving reaches the specified time without detecting the occurrence of the accident between the targets by the accident detection unit 1206, the storage processing unit 1207 may be configured not to store the storage target determined by the storage target determination unit 1205 in the recording device 1021. The specified time is a time that can be set arbitrarily. According to this, it becomes possible to make it difficult to press the capacity of the recording device 1021 without storing the vehicle external image which is highly likely to be unrelated to the occurrence of the accident, in the recording device 1021.

Even when the storage target determination unit 1205 determines the storage target with the trigger of switching from the automatic driving to the non-automatic driving, the above processing may be configured to be performed when it is determined by the danger determination unit 1204 that there is a risk of collision between the targets before the accident detection unit 1206 detects the occurrence of the accident between the targets.

When the accident detection unit 1206 detects the occurrence of an accident between the targets, the report processing unit 1208 notifies the occurrence of the accident to an external server such as the police or an insurance company via the communication module 1008. Also, the report processing unit 1208 reports the occurrence of the accident and transmits the storage target stored in the recording device 1021 to the external server. According to this, the police and the insurance company are capable of responding to the occurrence of the accident, and it becomes possible to determine where the responsibility for the accident lies, based on the information to be stored. Further, when the occurrence of the accident is detected, the storage target is transmitted to the external server, so that it becomes difficult to falsify the information to be stored. Therefore, it becomes easier to prove from the information to be stored that the automatic driving is not liable for the occurrence of the accident. When the accident detection unit 1206 detects the occurrence of the accident between the targets, the report processing unit 1208 may be configured to transmit the storage target to the external server before storing it in the recording device 1021.

### [Video Storage-Related Processing in Video Processing Device 1020]

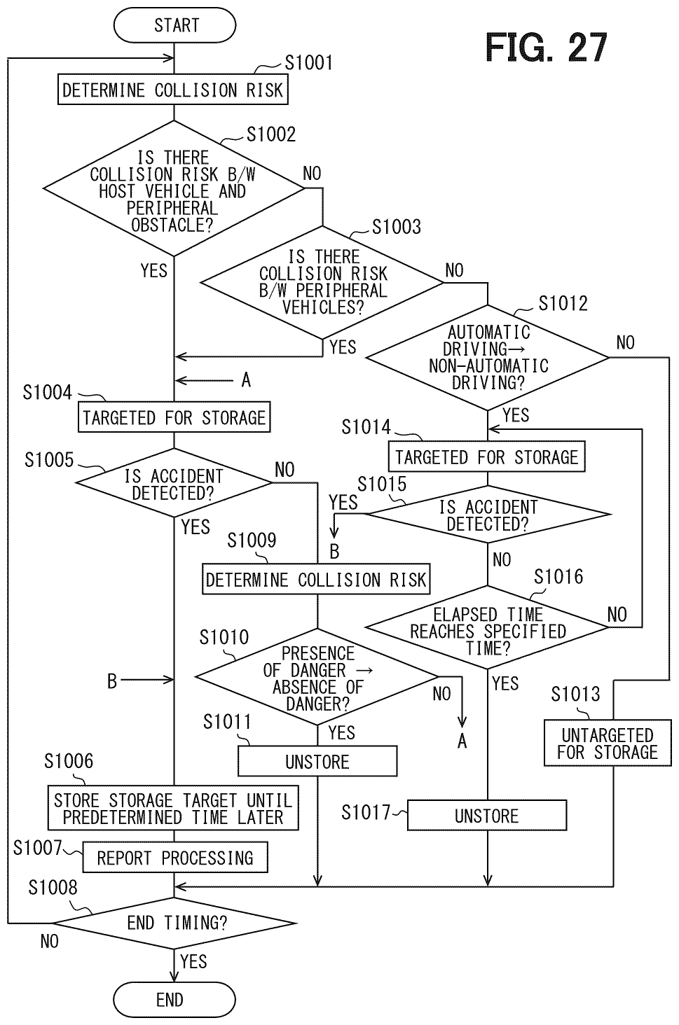

Here, description will be made as to an example of the flow of video storage-related processing in the video processing device 1020 by using a flowchart of FIG. 27. The execution of Steps included in the video storage-related processing by a computer corresponds to the execution of a video recording method. The flowchart of FIG. 27 may be configured to start when a switch for starting an internal combustion engine or a motor generator of the host vehicle (hereinafter referred to as power switch) is turned on. In the example of FIG. 27, it is assumed that the traveling environment recognition unit 1022 sequentially recognizes the traveling environment of the host vehicle. In the example of FIG. 27, it is assumed that the video acquisition unit 1201 sequentially acquires the vehicle external image captured by the vehicle external camera 1051 and sequentially stores the same in the temporary storage unit 1202.

First, in Step S1001, the danger determination unit 1204 determines whether or not there is a collision risk between targets such as between the host vehicle and obstacles around the host vehicle and between vehicles around the host vehicle. In Step S1002, when it is determined that there is a risk of collision between the host vehicle and the obstacles around the host vehicle (YES in S1002), the processing proceeds to Step S1004. On the other hand, when it is determined that there is no risk of collision between the host vehicle and the obstacles around the host vehicle (NO in S1002), the processing proceeds to Step S1003.

In Step S1003, when it is determined that there is a risk of collision between the vehicles around the host vehicle (YES in S1003), the processing proceeds to Step S1004. On the other hand, when it is determined that there is no risk of collision between the vehicles around the host vehicle (NO in S1003), the processing proceeds to Step S1012. The order of the processing of S1002 and S1003 may be changed.

In Step S1004, the storage target determination unit 1205 sets the vehicle external image sequentially acquired by the video acquisition unit 1201 from the time when it is determined that there is a collision risk between the targets, and the driving state flag at the time when the vehicle external image specified by the driving specifying unit 1203 is acquired, as storage targets to be stored in the recording device 1021 in association with each other. The determination of the storage targets by the storage target determination unit 1205 is taken to be continued until the storage processing unit 1207 determines whether or not each storage target is stored in the recording device 1021.

In Step S1005, when the accident detection unit 1206 detects the occurrence of an accident between the targets determined to have the collision risk in the previous Step (YES in S1005), the processing proceeds to Step S1006. On the other hand, when the accident detection unit 1206 does not detect the occurrence of the accident between the targets determined to have the collision risk in the previous Step (NO in S1005), the processing proceeds to Step S1009.

In Step S1006, the storage processing unit 1207 reads the storage target determined to be the storage target by the storage target determination unit 1205 from the temporary storage unit 1202 and stores it in the recording device 1021 at least until the occurrence of the accident detected in S1005. For example, the storage processing unit 1207 may read from the temporary storage unit 1202, the storage target determined to be the storage target by the storage target determination unit 1205 until a predetermined time later from the occurrence of the accident detected in S1005 and store it in the recording device 1021. In Step S1007, the report processing unit 1208 notifies the external server of the police, the insurance company, or the like of the occurrence of the accident via the communication module 1008, and transmits the storage target saved in the recording device 1021 in S1006 to this external server.

In Step S1008, when the video storage-related processing is the end timing (YES in S1008), the video storage-related processing is ended. On the other hand, when the end timing of the video storage-related processing is not taken (NO in S1008), the processing returns to S1001 and the processing is repeated. As an example of the end timing of the video storage-related processing, there is a case where the power switch of the host vehicle is turned off.

In Step S1009, the danger determination unit 1204 determines whether or not there is a collision risk between the targets. In Step S1010, when the determination result of the collision risk between the targets determined to have the collision risk in the previous Step is switched from the collision risk to the non-collision risk (YES in S1010), the processing proceeds to Step S1011. On the other hand, when the collision risk remains as it is (NO in S1010), the processing returns to S1004 to continue determining the storage target and repeat the processing.

In Step S1011, the storage processing unit 1207 does not store the storage target determined to be the storage target by the storage target determination unit 1205 in the recording device 1021, and the processing proceeds to Step S1008. As described above, the storage target stored in the temporary storage unit 1202, which is not stored in the recording device 1021, is sequentially deleted from the data that has become the past data above a certain level.

In Step S1012, when the driving state specified by the driving specifying unit 1203 is switched from the automatic driving to the non-automatic driving (YES in S1012), the processing proceeds to Step S1014. On the other hand, when the driving state specified by the driving specifying unit 1203 has not been switched from the automatic driving to the non-automatic driving (NO in S1012), the processing proceeds to Step S1013.

In Step S1013, the storage target determination unit 1205 moves to Step S1008 without setting the vehicle external image sequentially acquired by the video acquisition unit 1201 as the storage target. On the other hand, in Step S1014, the storage target determination unit 1205 sets the vehicle external image sequentially acquired by the video acquisition unit 1201 from the time when the driving state specified by the driving specifying unit 1203 is switched from the automatic driving to the non-automatic driving, and the driving state flag at the time when the vehicle external image specified by the driving specifying unit 1203 is acquired, as storage targets to be saved in the recording device 1021 in association with each other. The determination of the storage target by the storage target determination unit 1205 is also continued until it is determined by the storage processing unit 1207 whether or not the storage target is stored in the recording device 1021.

In Step S1015, when the accident detection unit 1206 detects the occurrence of an accident between the targets (YES in S1015), the processing proceeds to Step S1006. On the other hand, when the accident detection unit 1206 has not detected the occurrence of the accident between the targets (NO in S1015), the processing proceeds to Step S1016. The accident detection unit 1206 may be configured to detect the occurrence of the accident between the targets determined to have the collision risk by the danger determination unit 1204 after the driving state specified by the driving specifying unit 1203 is switched from the automatic operation to the non-automatic driving.

In Step S1016, when the elapsed time from the time when the driving state is switched from the automatic driving to the non-automatic driving in S1012 reaches the specified time (YES in S1016), the storage processing unit 1207 moves to Step S1017. On the other hand, when the elapsed time has not reached the specified time (NO in S1016), the processing returns to S1014 to continue determining the storage target and repeat the processing. In Step S1017, the storage processing unit 1207 does not store the storage target determined to be the storage target by the storage target determination unit 1205 in the recording device 1021, and proceeds to Step S1008.

### Summary of Sixteenth Embodiment

According to the configuration of the present embodiment as described above, in the vehicle capable of switching between the automatic driving to the extent that it is stipulated to be legally liable for the accident and the non-automatic driving which does not perform this automatic driving, it becomes possible to make it easier to prove that the automatic driving is not liable for the occurrence of the accident.

Further, according to the configuration of the present embodiment, the vehicle external image and the driving state are associated with each other and set as the targets to be saved with the trigger of determining by the danger determination unit 1204 that there is the collision risk between the vehicles around the host vehicle. Thus, even if it is not determined that there is the risk of collision with the host vehicle, it is possible to store the vehicle external image and make it easier to investigate the cause of the accident when the accident occurs between the vehicles around the host vehicle. Further, it is possible to make it easier to determine whether or not the host vehicle is liable for the accident.

### Seventeenth Embodiment

In the sixteenth embodiment, the danger determination unit 1204 determines that there is the risk of collision between the host vehicle and the peripheral obstacles (hereinafter referred to as the first condition), the danger determination unit 1204 determines that there is the risk of collision between the vehicles around the host vehicle (hereinafter referred to as the second condition), and the driving state of the host vehicle is switched from the automatic driving to the non-automatic driving (hereinafter referred to as the third condition). The configuration is shown in which these conditions are taken to be the trigger for determining the storage target, but is not necessarily limited to it. For example, some of the first to third conditions may be configured to be a trigger for determining the storage target.

As an example, when adopting a configuration in which only the first condition of the first to third conditions is taken as the trigger described above, the processing of S1003, S1012, and S1014 to S1017 in the flowchart of FIG. 27 is omitted, and in the case of NO in S1002, the processing may move to S1013. When adopting a configuration in which only the second condition of the first to third conditions is taken as the trigger described above, the processing of S1002, S1012, and S1014 to S1017 in the flowchart of FIG. 27 is omitted, and S1001 is followed by moved to S1003. In the case of NO in S1003, the processing may move to S1013. When adopting a configuration in which only the third condition of the first to third conditions is taken as the trigger described above, the processing of S1001 to 1005 and S1009 to S1011 in the flowchart of FIG. 27 is omitted, and S1001 is followed by moved to S1012. In the case of NO in S1008, the processing may move to S1012.

When adopting a configuration in which only the first condition of the first to third conditions is not included in the trigger described above, the processing of S1002 in the flowchart of FIG. 27 is omitted, and S1001 may be followed by moved to S1003. When adopting a configuration in which only the second condition of the first to third conditions is not included in the trigger described above, the processing of S1003 in the flowchart of FIG. 27 is omitted, and when NO in S1002, the processing may proceed to S1012. When adopting a configuration in which only the third condition of the first to third conditions is not included in the above-mentioned trigger, the processing of S1012 and S1014 to S1017 in the flowchart of FIG. 27 is omitted, and when NO in S1003, the processing may move to S1013.

With any configuration, as in the sixteenth embodiment, it is possible to distinguish whether the vehicle external image is during the automatic driving or during the non-automatic driving. Therefore, in the vehicle that can switch between the automatic driving to the extent that it is legally liable for the accident and the non-automatic driving that does not perform this automatic driving, it becomes possible to make it easier to prove that the automatic driving is not liable for the occurrence of the accident.

### Eighteenth Embodiment

The sixteenth embodiment has shown the configuration in which the temporary storage unit 1202 temporarily stores the storage target determined by the storage target determination unit 1205, and the storage processing unit 1207 saves the storage target in the recording device 1021 so that the storage target is stored in the recording device 1021, but is not necessarily limited to it. For example, a configuration may be adopted in which the storage target determined by the storage target determination unit 1205 is stored in the recording device 1021, and the storage target is stored in the recording device 1021 by not erasing the storage target from the recording device 1021 by the storage processing unit 1207.

In this case, the storage processing unit 1207 reads the storage target from the temporary storage unit 1202 and stores it in the recording device 1021 regardless of whether or not the accident detection unit 1206 detects the occurrence of the accident between the targets. Then, when the accident detection unit 1206 detects the occurrence of the accident between the targets, the storage processing unit 1207 stores the storage target in the recording device 1021 by not erasing the storage target stored in the recording device 1021. On the other hand, when the storage processing unit 1207 satisfies the same condition as the condition that the storage target is not stored in the recording device 1021 in the sixteenth embodiment, the storage processing unit 1207 erases the storage target stored in the recording device 1021 not to store the storage target in the recording device 1021.

Even with the above configuration, it is possible to distinguish whether the vehicle external image is during the automatic driving or during the non-automatic driving, as with the sixteenth embodiment. Therefore, in each vehicle that can switch between the automatic driving to the extent that it is stipulated to be legally liable for the accident and the non-automatic driving that does not execute this automatic driving, it becomes possible to make it easier to prove that the automatic driving is not liable for the occurrence of the accident.

### Nineteenth Embodiment

The sixteenth embodiment has shown the configuration in which when the determination result by the danger determination unit 1204 for the targets determined to have the collision risk by the danger determination unit 1204 is switched from the presence of the collision risk to its absence, without detecting the occurrence of the accident between the targets by the accident detection unit 1206, the storage target determined by the storage target determination unit 1205 is not stored in the recording device 1021, but is not necessarily limited to it. For example, a configuration may be taken in which when the elapsed time since the danger determination unit 1204 determines that there is a collision risk reaches a specified time without the accident detection unit 1206 detecting the occurrence of an accident between the targets, the storage target determined by the storage target determination unit 1205 is not stored in the recording device 1021. The specified time referred to here is a time that can be arbitrarily set.

Even with the above configuration, it makes it possible to save the vehicle external image that goes back to the time when it was judged that there was a risk of collision between the targets. Consequently, while it makes it easier to investigate the cause of the accident, it becomes possible to make it difficult to press the capacity of the recording device 1021 without storing the vehicle external image highly likely to be unrelated to the occurrence of the accident in the recording device 1021.

### Twentieth Embodiment

The sixteenth embodiment has shown the configuration in which when the accident detection unit 1206 detects the occurrence of the accident, the storage processing unit 1207 stores the storage target at least until the occurrence of the accident in the recording device 1021, but is not necessarily limited to it. For example, a configuration (hereinafter referred to as the twentieth embodiment) may be adopted in which a storage target for a certain period of time is stored in the recording device 1021 regardless of whether or not the occurrence of an accident is detected. Here, the configuration of the twentieth embodiment will be described using the drawings.

A vehicle system 1001 of the twentieth embodiment is the same as the vehicle system 1001 of the sixteenth embodiment except that an automatic driving device 1002 includes a video processing device 1020a instead of the video processing device 1020. The automatic driving device 1002 of the twentieth embodiment is also the same as the automatic driving device 1002 of the sixteenth embodiment, except that the video processing device 1020a is included instead of the video processing device 1020.

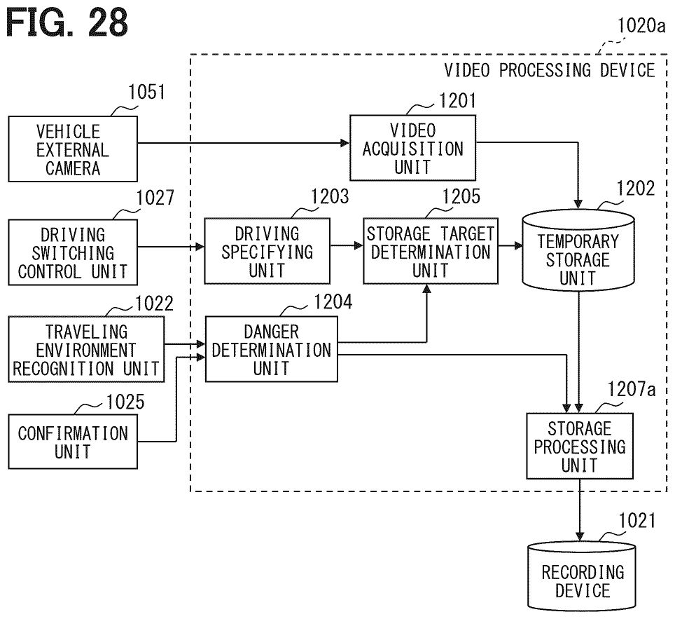

Here, description will be made as to an example of a schematic configuration of the video processing device 1020a using FIG. 28. The video processing device 1020a includes a video acquisition unit 1201, a temporary storage unit 1202, a driving specifying unit 1203, a danger determination unit 1204, a storage target determination unit 1205, and a storage processing unit 1207a as functional blocks. The video processing device 1020a is the same as the video processing device 1020 of the sixteenth embodiment, except that the storage processing unit 1207a is provided instead of the storage processing unit 1207 and the accident detection unit 1206 and the report processing unit 1208 are not provided.

The storage processing unit 1207a stores the storage target for the certain period of time determined to be the storage target by the storage target determination unit 1205 in the recording device 1021. The certain period of time referred to here is assumed to be a period that can be arbitrarily set. When the storage target determination unit 1205 starts determining the storage target, the storage processing unit 1207a stores the storage target in the recording device 1021 every time the storage target is determined for a certain period of time after the determination of the storage target is started. Thus, the storage target for the certain period of time may be stored in the recording device 1021.

According to the configuration of the twentieth embodiment, the vehicle external image for the certain period from the time when it is determined that there is a collision risk between the targets and the driving state flag or the like corresponding to the time when the vehicle external image is acquired can be stored in the recording device 1021. Therefore, when an accident occurs between the targets, it is possible to verify the accident using the vehicle external image for a certain period from the time when it is determined that there is a risk of collision between the targets. By making it possible to verify the accident using the vehicle external image up to the time when it is determined that there is a risk of collision between the targets, it becomes easier to investigate the cause of the accident. Further, the driving status flag corresponding to the time when the vehicle external image is acquired is associated with the vehicle external image. Therefore, even if it is judged from the vehicle external image that the host vehicle is liable for the occurrence of the accident, it is possible to prove that the host vehicle is not liable for the automatic driving by distinguishing whether the vehicle external image is during the automatic driving or during the non-automatic driving, As a result, in each vehicle that can switch between the automatic driving to the extent that it is stipulated to be legally liable for the accident and the non-automatic driving that does not carry out this automatic driving, it becomes possible to make it easier to prove that the automatic driving is not liable for the occurrence of the accident.

Further, according to the configuration of the twentieth embodiment, it is possible to store in the recording device 1021, the vehicle external image for the certain period from the time of switching from the automatic driving to the non-automatic driving, and the driving state flag or the like corresponding to the time when the vehicle external image is acquired. Therefore, it is possible to verify the accident by using the vehicle external image for the certain period from the time of this switching. When the above-mentioned accident occurs after the degree of the automatic driving of the host vehicle is switched from the automatic driving to the non-automatic driving, the driver may mistakenly claim that the accident has occurred during the automatic driving. On the other hand, it becomes possible to store the vehicle external image during a period in which such a misunderstanding may occur, in the recording device. Further, since the driving status flag corresponding to the time when the vehicle external image is acquired is associated with the vehicle external image, even when it is judged from the vehicle external image that the host vehicle is liable for the occurrence of the accident, it becomes possible to prove that the host vehicle is not liable for the automatic driving by distinguishing whether the vehicle external image is during the automatic driving or during the non-automatic driving. As a result, in each vehicle that can switch between the automatic driving to the extent that it is stipulated to be legally liable for the accident and the non-automatic driving that does not carry out this automatic driving, it becomes possible to make it easier to prove that the automatic driving is not liable for the occurrence of the accident.

### Twenty First Embodiment

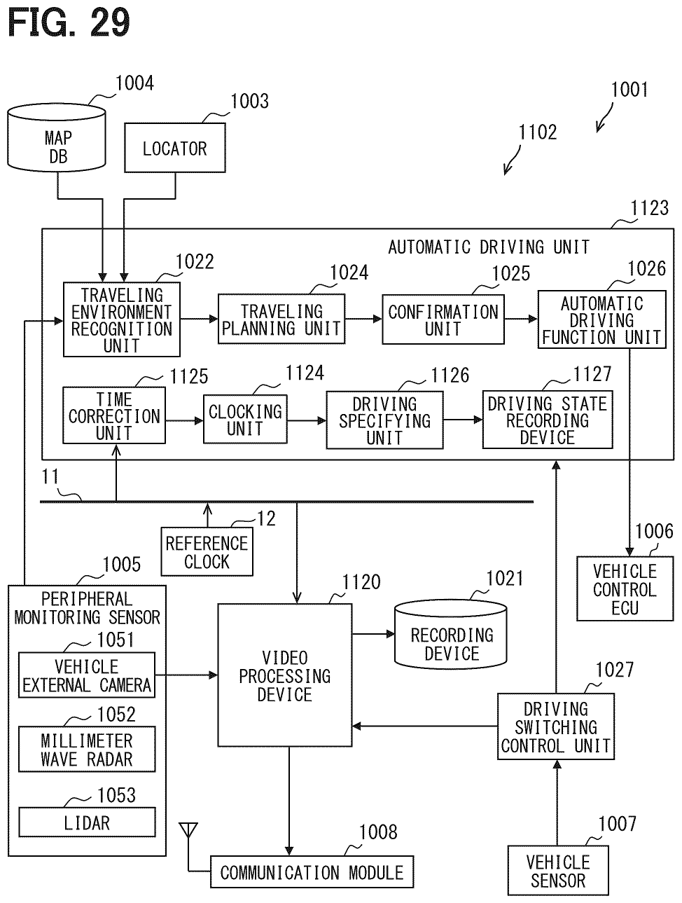

Next, a twenty first embodiment will be described. FIG. 29 shows a configuration of a vehicle system 1101 of the twenty first embodiment. The vehicle system 1101 includes an automatic driving device 1102 instead of the automatic driving device 1002. The automatic driving device 1102 includes an automatic driving unit 1123 in place of the automatic driving unit 1023, and a video processing device 1120 in place of the video processing device 1020.

In the sixteenth embodiment, the vehicle external image and the information that can specify the driving state of the host vehicle are associated with other and targeted for storage. On the other hand, in the twenty first embodiment, the vehicle external image and the information that can specify the driving state of the host vehicle are separately stored while enabling the ex post facto association.

Further, the vehicle system 1101 continuously stores the vehicle external image and the information that can specify the driving state of the host vehicle while the host vehicle is traveling. That is, the vehicle system 1101 continuously stores the vehicle external image and the information capable of specifying the driving state of the host vehicle regardless of the presence or absence of a collision risk and whether or not the vehicle is in automatic driving.

In order to separately store the vehicle external image and the information that can specify the driving state of the host vehicle while enabling the ex post facto association, the automatic driving unit 1123 has a clocking unit 1124, a time correction unit 1125, and a driving specifying unit 1126, and a driving state recording device 1127. Further, the host vehicle equipped with the vehicle system 1101 is provided with an in-vehicle LAN 11 and a reference clock 12. The in-vehicle LAN 11 and the reference clock 12 are the same as those described in the seventh embodiment.

In the twenty first embodiment, as shown in FIG. 29, the time correction unit 1125 and the video processing device 1120 are also connected to the in-vehicle LAN 11 in addition to the reference clock 12. The elements other than the time correction unit 1125 and the video processing device 1120 shown in FIG. 29 may also be connected to the in-vehicle LAN 11.

The clocking unit 1124 is the same as the clocking unit 743 in FIG. 17 and measures the current time (that is, the measurement time). The time correction unit 1125 has the same function as the time correction unit 744 of FIG. 17, acquires a reference time from the reference clock 12, and corrects the measurement time measured by the clocking unit 1124 to the reference time acquired from the reference clock 12. Further, the time correction unit 1125 sequentially updates a time error and time accuracy of the clocking unit 1124 in the same manner as the time correction unit 744.

In the sixteenth embodiment, the driving specifying unit 1126 is configured to be included in the video processing device 1020. In this embodiment, the automatic driving unit 1123 is provided with the driving specifying unit. The driving specifying unit 1126 is the same as the driving specifying unit 1203 included in the video processing device 1020 and specifies whether the host vehicle is in a driving state of either automatic driving or non-automatic driving. Further, the measurement time, time error, and time accuracy are acquired from the clocking unit 1124. Then, the specified driving state is stored in the driving state recording device 1127 together with the measurement time measured by the clocking unit 1124, the time error of the clocking unit 1124, and the time accuracy thereof.

The driving state recording device 1127 is an electrically rewritable non-volatile memory. The driving state recording device 1127 is hardware different from the recording device 1021. The driving state recording device 1127 outputs the information that can specify the driving state and the stored information such as the measurement time to a device outside the vehicle by a wired means or a wireless means.

### [Schematic Configuration of Video Processing Device 1120]

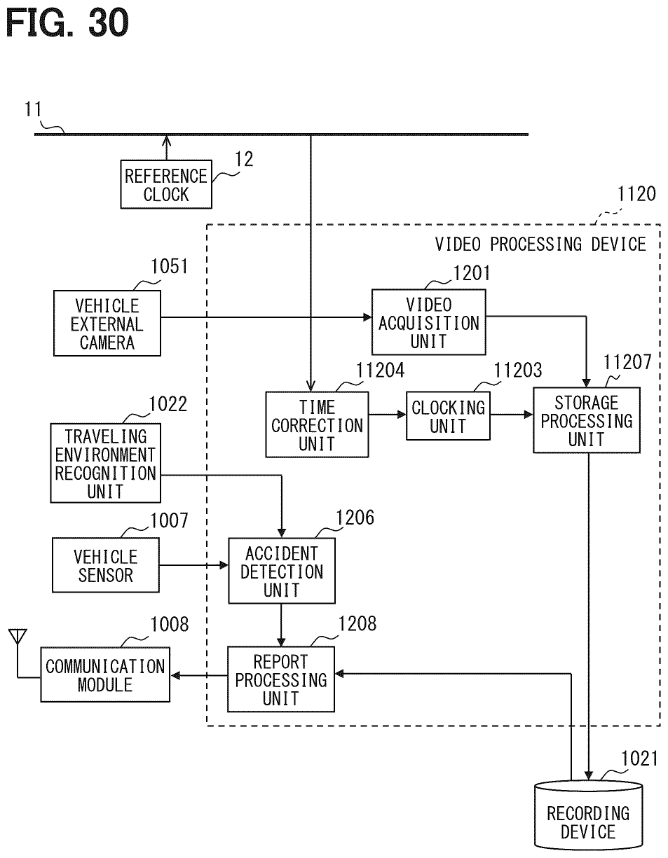

FIG. 30 shows a configuration of the video processing device 1120. As shown in FIG. 30, the video processing device 1120 includes the same video acquisition unit 1201, accident detection unit 1206, and report processing unit 1208 as in FIG. 26. Further, the video processing device 1120 includes a clocking unit 11203, a time correction unit 11204, and a storage processing unit 11207. The video processing device 1120 does not include the driving specifying unit 1203, the danger determination unit 1204, the storage target determination unit 1205, and the temporary storage unit 1202 included in the video processing device 1020 of FIG. 26.

The reason why the driving specifying unit 1203 is not provided is that the automatic driving unit 1123 is provided with the driving specifying unit 1126 in the present embodiment. The reason why the danger determination unit 1204, the storage target determination unit 1205, and the temporary storage unit 1202 are not provided is that the vehicle external image is always stored in the present embodiment.

The clocking unit 11203 is the same as the clocking unit 1124, and measures the current time (that is, the measurement time). The time correction unit 11204 has the same function as the time correction unit 1125, acquires a reference time from the reference clock 12, and corrects the measurement time measured by the clocking unit 11203 to the reference time acquired from the reference clock 12. Further, the time correction unit 11204 sequentially updates a time error and time accuracy of the clocking unit 11203 in the same manner as the time correction unit 1125.

The storage processing unit 11207 acquires the measurement time, the time error, and the time accuracy from the clocking unit 11203, and acquires the vehicle external image from the video acquisition unit 1201. Then, the vehicle external image, the measurement time, the time error, and the time accuracy are sequentially stored in the recording device 1021. In this embodiment, the recording device 1021 functions as a video recording device.

In this embodiment, the driving state is stored in the driving state recording device 1127 together with the measurement time. The vehicle external image is stored together with the measurement time in the recording device 1021 which is a storage unit different from the driving state recording device 1127. The driving state and the vehicle external image are stored together with the measurement time, so that a time stamp is given. The driving state and the vehicle external image which are stored in the storage devices different from each other, can be associated ex post by the time stamp. By associating the driving state and the vehicle external image with each other ex post, the vehicle system 1101 of the present embodiment can also obtain various effects described in the sixteenth embodiment.

Also, in this embodiment, in addition to the time stamp (that is, the measurement time) being given to the driving state, the time error and the time accuracy of the measurement time are also stored in the driving state recording device 1127. Further, in addition to the time stamp (that is, the measurement time) being given even to the vehicle external image, the time error and the time accuracy of the measurement time are also stored in the recording device 1021. Considering these time error and accuracy, it is possible to investigate the cause of the accident, which vehicle being liable for the accident, etc. with higher reliability.

### Twenty Second Embodiment

In the twenty first embodiment, the driving state recording device 1127 has stored the time error and the time accuracy with respect to the measurement time when the driving state is specified. However, only one of the time error and the time accuracy may be saved, or both the time error and the time accuracy may be prevented from being saved.

Further, even in regard to the time error and the time accuracy with respect to the measurement time when the vehicle external image is acquired, only one of the time error and the time accuracy may be saved, or both the time error and the time accuracy may be prevented from being stored.

### Twenty Third Embodiment

In the sixteenth, twentieth, and twenty first embodiments, the vehicle external image is stored as the accident confirmation image. However, in the event of an accident, it may be necessary to confirm the conditions inside the vehicle. In other words, each of the indoor images is also an accident confirmation image that may be able to confirm the situation of the accident. Therefore, instead of the vehicle external image, the vehicle interior image may be stored. The interior images can include photographed images of various parts in the interior of the vehicle, such as photographed images of the vicinity of the driver's seat, photographed images of the rear seats, photographed images of the driver's seat and passenger's seat, and images obtained by combining these images, etc. Further, both the vehicle external image and the interior image may be stored.

### Twenty Fourth Embodiment

The sixteenth embodiment has shown the configuration that the automatic driving device 1002 and the vehicle control ECU 1006 are separate bodies, but is not necessarily limited to it. For example, the automatic driving device 1002 may be configured to bear the function of the vehicle control ECU 1006 as well. Further, the automatic driving device 1002 may be configured to bear the function of the locator 1003 as well.

### Twenty Fifth Embodiment

The above-described embodiment has shown the configuration in which the video processing devices 1020 and 1020a are included in the automatic driving device 1002, but is not necessarily limited to it. For example, the video processing devices 1020 and 1020a may be configured not to be included in the automatic driving device 1002.

### Twenty Sixth Embodiment

The sixteenth embodiment has shown the configuration in which the danger determination unit 1204 determines whether or not there is a collision risk between targets depending on whether or not the distance between the targets is equal to or greater than the safety distance calculated by a preset mathematical formula model, but is not necessarily limited to it. For example, the danger determination unit 1204 may be configured to determine the presence or absence of a collision risk between the targets by another index such as TTC (Time To Collision).

### Twenty Seventh Embodiment

The sixteenth embodiment has shown the configuration in which the automatic driving device 1002 is provided with the confirmation unit 1025, but is not necessarily limited to it. For example, the automatic driving device 1002 may be configured not to include the confirmation unit 1025.

### Twenty Eighth Embodiment

Further, when an abnormal behavior of an occupant is detected from an indoor image acquired by the video acquisition unit 1201, the video processing devices 1020 and 1020a may be configured to notify it to the external server via the communication module 1008. The detection of the abnormal behavior of the occupant from the indoor image may be detected by an image recognition technology. Examples of the abnormal behavior of the occupant include a driver's inoperable state, a driver's doze, and driver's looking away, etc.

### Twenty Ninth Embodiment

In addition, the video processing devices 1020 and 1020a may be configured to be capable of outputting the information to be saved stored in the recording device 1021 to the outside other than the communication via the communication module 1008. For example, by using the recording device 1021 as a removable recording medium, the information to be saved stored in the recording device 1021 may be output to the outside.

### Thirtieth Embodiment

In the embodiments up to here after the sixteenth embodiment, the automatic driving in the driving state has been defined as the automatic driving to the extent that it is stipulated to be legally liable for the accident. However, the automatic driving in the driving state may include lower levels of automatic driving. Further, the level of automatic driving may be stored as the driving state.

### Thirty First Embodiment

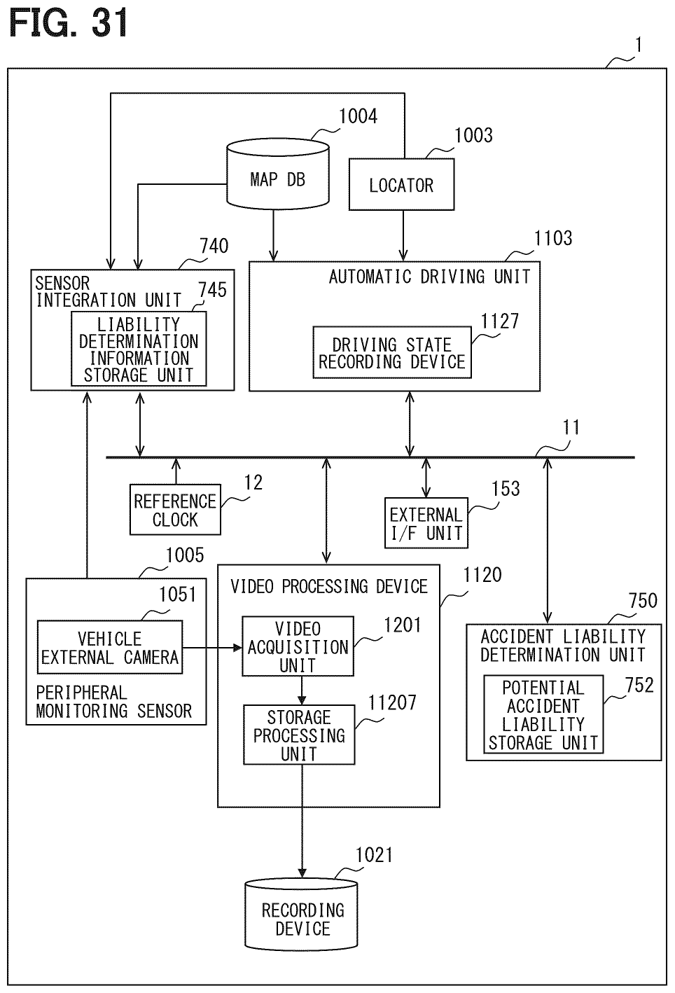

The first to fifteenth embodiments and the sixteenth to thirtieth embodiments are combined, and in addition to the liability determination information, the potential accident liability information and the accident confirmation image may be stored in association with each other or in associable with each other. FIG. 31 shows a travel storage system in which the potential accident liability value determination device 700 of the seventh embodiment and the vehicle system 1101 of the twenty first embodiment are combined. However, in FIG. 31, for convenience of illustration, the internal configurations respectively included in the sensor integration unit 740, the accident liability determination unit 750, the peripheral monitoring sensor 1005, the automatic driving unit 1103, and the video processing device 1120 are partially omitted in illustration.

In this embodiment, the liability determination information, the potential accident liability information, the driving state, and the accident confirmation image are respectively stored in different storage units or storage devices so that they can be associated with each other ex post.

The present disclosure is not limited to the above-described embodiments, and various modifications can be made within the scope of the claims. Embodiments obtained by appropriately combining the technical means disclosed in the different embodiments are also included in the technical scope of the present disclosure. Further, the control unit and the method thereof described in the present disclosure may be realized by a dedicated computer constituting a processor programmed to execute one or a plurality of functions embodied by a computer program. Alternatively, the device and method thereof described in the present disclosure may be realized by a dedicated hardware logic circuit. As an alternative to that, the device and method thereof described in the present disclosure may be realized by one or more dedicated computers configured by a combination of a processor that executes a computer program and one or more hardware logic circuits. Further, the computer program may be stored in a computer-readable non-transitional tangible recording medium as an instruction executed by the computer.

In view of the above-described embodiments, the present disclosure also includes the following technical aspects.

First aspect: A potential accident liability determination device comprising:
a liability determination information acquisition unit (253, 453) which acquires liability determination information being information used to determine potential accident liability information indicating the presence or absence of liability of a liability determination vehicle being a vehicle to determine the potential accident liability information with respect to a potentially assumed accident between the liability determination vehicle and a target vehicle selected from surrounding vehicles existing around the liability determination vehicle; and
a potential accident liability information determination unit (251, 451) which determines the potential accident liability information, based a preset relationship which determines the potential accident liability information from the liability determination information, and the liability determination information acquired by the liability determination information acquisition unit,
wherein the potential accident liability determination device is installed outside the liability determination vehicle.

Second aspect: The potential accident liability determination device according to the first aspect, wherein the liability determination information acquisition unit acquires as the liability determination information, a sensor value which is detected by a sensor provided in the liability determination vehicle and indicates the behavior of the peripheral vehicle,
wherein the liability determination information acquisition unit includes a target vehicle behavior determination unit (241) which sequentially determines the relative behavior of the target vehicle selected from the surrounding vehicles with respect to the liability determination vehicle, based on the sensor value, and
a rule acquisition unit (242) which acquires an accident liability rule at a position where it is necessary to determine the potential accident liability information, and
wherein the potential accident liability information determination unit sequentially determines the potential accident liability information, based on the relative behavior of the target vehicle and the accident liability rule acquired by the rule acquisition unit.

Third aspect: The potential accident liability determination device according to the first aspect, wherein the liability determination information acquisition unit (453) acquires the relative behavior of the target vehicle as the liability determination information, and
wherein the potential accident liability information determination unit (451) sequentially determines the potential accident liability information, based on the relative behavior of the target vehicle and the accident liability rule at the position where it is necessary to determine the potential accident liability information.

Fourth aspect: The potential accident liability determination device according to the first aspect, wherein the liability determination information acquisition unit acquires the liability determination information from each peripheral vehicle existing around the liability determination vehicle.

Fifth aspect: A potential accident liability determination device comprising:
a liability determination information acquisition unit (541) which acquires liability determination information being information used to determine potential accident liability information indicating the presence or absence of liability of a liability determination vehicle being a vehicle to determine the potential accident liability information with respect to a potentially assumed accident between the liability determination vehicle and a target vehicle selected from surrounding vehicles existing around the liability determination vehicle;
a potential accident liability information determination unit (551) which determines the potential accident liability information, based a preset relationship which determines the potential accident liability information from the liability determination information, and the liability determination information acquired by the liability determination information acquisition unit; and
a peripheral information acquisition unit (570) which acquires from each of the related surrounding vehicles each being the peripheral vehicle other than the target vehicle among the surrounding vehicles, peripheral liability determination information used to determine peripheral potential accident liability information indicating the presence or absence of liability of the related peripheral vehicle for a potentially assumed accident between the related peripheral vehicle and each vehicle existing around the related peripheral vehicle.

Sixth aspect: A potential accident liability determination method executed outside a liability determination vehicle, comprising the steps of:
acquiring liability determination information being information used to determine potential accident liability information indicating the presence or absence of liability of the liability determination vehicle for a potentially assumed accident between the liability determination vehicle and a target vehicle selected from surrounding vehicles existing around the liability determination vehicle; and
determining the potential accident liability information, based on a preset relationship which determines the potential accident liability information from the liability determination information, and the acquired liability determination information.

Seventh aspect: A potential accident liability determination method comprising the steps of:
acquiring liability determination information being information used to determine potential accident liability information indicating the presence or absence of liability of the liability determination vehicle for a potentially assumed accident between the liability determination vehicle and a target vehicle selected from surrounding vehicles existing around the liability determination vehicle;
determining the potential accident liability information, based on a preset relationship which determines the potential accident liability information from the liability determination information, and the acquired liability determination information; and
acquiring from each of the related surrounding vehicles each being the peripheral vehicle other than the target vehicle among the surrounding vehicles, peripheral liability determination information used to determine peripheral potential accident liability information indicating the presence or absence of liability of the related peripheral vehicle for a potentially assumed accident between the related peripheral vehicle and each vehicle existing around the related peripheral vehicle.

Eighth aspect: The video recording system includes:
as the video acquisition unit, a vehicle external video acquisition unit (1201) which is provided in the vehicle and sequentially acquires a vehicle external image being an image taken by a vehicle external camera (1051) photographing the periphery of the vehicle, as the accident confirmation image, and further including:
a danger determination unit (1204) which determines the presence or absence of a collision risk between at least any targets between the vehicle and obstacles around the vehicle and between vehicles around the vehicle, and
a storage target determination unit (1205) which triggers the danger determination unit to determine that there is the collision risk between the targets exist, and thereby sets the vehicle external image sequentially acquired by the external video acquisition unit and information capable of specifying the driving state of the vehicle at the time when the vehicle external image specified by the driving specifying unit is acquired, as storage targets to be stored in the recording device.

Ninth aspect: The video recording system according to the eighth aspect, wherein even when the danger determination unit does not determine that there is the collision risk between the targets, the storage target determination unit triggers that the driving state of the host vehicle is switched from the automatic driving to the non-automatic driving, and thereby sets the vehicle external image sequentially acquired in the external video acquisition unit and information capable of specifying the driving state of the vehicle at the time when the vehicle external image specified by the driving specifying unit is acquired, as the targets to be stored.

Tenth aspect: The video recording system according to the eighth aspect, including an accident detection unit (1206) which detects the occurrence of an accident between targets determined by the danger determination unit to have the collision risk between the targets,
wherein when the accident detection unit detects the occurrence of the accident, the storage processing unit stores the storage targets at least until the occurrence of the accident in the recording device.

Eleventh aspect: The video recording system according to the tenth aspect, wherein when the accident detection unit detects the occurrence of the accident, the storage processing unit stores the storage targets up to a predetermined time later from the occurrence of the accident in the recording device.

Twelfth aspect: The video recording system according to the tenth aspect, wherein the storage processing unit does not store the storage targets in the recording device when the result of determination by the danger determination unit between the targets judged to have the collision risk by the danger determination unit is switched from the presence of the collision risk to the absence of the collision risk, without detecting the occurrence of the accident by the danger determination unit.

Thirteenth aspect: The video recording system the tenth aspect, including a report processing unit (1208) which, when the accident detection unit detects the occurrence of the accident, notifies the occurrence of the accident to a center outside the vehicle via communication and transmits the storage target to the center via communication.

Fourteenth aspect: The video recording system the tenth aspect, wherein the danger determination unit also determines whether or not there is a collision risk between any targets between the vehicle and each obstacle around the vehicle and between the vehicles around the vehicle, and
wherein when the danger determination unit determines that there is a collision risk between the vehicles around the vehicle, the storage target determination unit also sets as the storage target, information used to determine by the danger determination unit whether or not there is a collision risk between the peripheral vehicle included in these surrounding vehicles and the vehicle.

Fifteenth aspect: The video recording system according to the tenth aspect, wherein when the distance between the targets is less than a safety distance which is a reference distance for evaluating the safety between the targets, which is calculated by a preset mathematical formula model, the danger determination unit determines that there is the collision risk and determines that there is no collision risk when the distance is equal to or greater than the safety distance.

Sixteenth aspect: The video recording system, including:
as the video acquisition unit, a vehicle external video acquisition unit (1201) which is provided in the vehicle and sequentially acquires a vehicle external image being an image taken by a vehicle external camera (1051) photographing the periphery of the vehicle, as the accident confirmation image, and further including:
a storage target determination unit (1205) which triggers the driving state of the vehicle to be switched from the automatic driving to the non-automatic driving and thereby determines the vehicle external image sequentially acquired by the external video acquisition unit and information capable of specifying the driving state of the vehicle at the time when the vehicle external image specified by the driving specifying unit is acquired, as storage targets to be stored in the recording device.

Seventeenth aspect: The video recording system according to the sixteenth aspect, including an accident detection unit (1206) which detects at least either of an accident between the vehicle and the obstacle around the vehicle and an accident between the vehicles around the vehicle,
wherein when the accident detection unit detects the occurrence of the accident, the storage processing unit stores the storage target at least until the occurrence of the accident in the recording device.

Eighteenth aspect: The video recording system according to the seventeenth aspect, including a danger determination unit (1204) which determines the presence or absence of a collision risk between at least any targets between the vehicle and each obstacle around the vehicle and between vehicles around the vehicle,
wherein the accident detection unit detects the occurrence of an accident between the targets determined by the danger determination unit to have the collision risk between the targets to thereby detect at least either of the accident between the vehicle and each obstacle around the vehicle and the accident between the vehicles around the vehicle, and
wherein the storage processing unit does not store the storage targets in the recording device when the result of determination by the danger determination unit between the targets judged to have the collision risk by the danger determination unit is switched from the presence of the collision risk to the absence of the collision risk, without detecting the occurrence of the accident by the danger determination unit.

Nineteenth aspect: The video recording system according to the seventeenth aspect, including a report processing unit (1208) which, when the accident detection unit detects the occurrence of the accident, notifies the occurrence of the accident to a center outside the vehicle via communication and transmits the storage target to the center via communication.

Twentieth aspect: The video recording system according to the seventeenth aspect, including a storage processing unit (1207a) which stores the storage target for a certain period of time from the trigger in the recording device when the storage target is determined by the storage target determination unit.

Twenty first aspect: An automatic driving system used in a vehicle capable of switching between automatic driving and non-automatic driving which does not perform the automatic driving, comprising:
a video recording system according to any one of claims 22 to 40;
a traveling environment recognition unit (1022) which recognizes a traveling environment of the vehicle by using the result of detection by a peripheral monitoring sensor (1005) monitoring the periphery of the vehicle;
a traveling planning unit (1024) which, using the traveling environment recognized by the traveling environment recognition unit, generates a traveling plan for driving the vehicle in the automatic driving; and
an automatic driving function unit (1026) which causes driving control of the vehicle to be performed according to the traveling plan generated by the traveling planning unit.

Twenty second aspect: A video recording method used in a vehicle capable of switching between automatic driving and non-automatic driving which does not perform the automatic driving, comprising the steps of:
sequentially acquiring an accident confirmation image from an in-vehicle camera which shoots the accident confirmation image being an image having a possibility of being capable of, when an accident occurs in or around the vehicle, confirming the situation of the accident;
specifying whether or not the vehicle is in a driving state of either the automatic driving or the non-automatic driving; and
storing the sequentially-acquired accident confirmation image and information capable of specifying the driving state of the vehicle at the time when the accident confirmation image is acquired, in association with each other or in associable with each other in a recording device.

1. A potential accident liability determination device, comprising:
a liability determination information acquisition unit configured to acquire liability determination information being information used to determine potential accident liability information indicating whether a liability determination vehicle being a vehicle for which the potential accident liability information is determined is liable for a potentially assumed accident between the liability determination vehicle and a target vehicle selected from surrounding vehicles existing around the liability determination vehicle; and
a potential accident liability information determination unit configured to determine the potential accident liability information based on (i) a preset relationship for determining the potential accident liability information from the liability determination information and (ii) the liability determination information acquired by the liability determination information acquisition unit, wherein
the potential accident liability determination device is installed outside of the liability determination vehicle.

2. The potential accident liability determination device according to claim 1, wherein
the liability determination information acquisition unit is configured to acquire, as the liability determination information, a sensor value that is detected by a sensor provided in the liability determination vehicle and indicates a behavior of the peripheral vehicle,
the potential accident liability determination device further comprises:
a target vehicle behavior determination unit that is configured to sequentially determine, based on the sensor value, a relative behavior of the target vehicle selected from the surrounding vehicles with respect to the liability determination vehicle; and
a rule acquisition unit configured to acquire an accident liability rule at a position where the potential accident liability information is determined, and
the potential accident liability information determination unit is configured to sequentially determine the potential accident liability information based on the relative behavior of the target vehicle and the accident liability rule acquired by the rule acquisition unit.

3. The potential accident liability determination device according to claim 1, wherein
the liability determination information acquisition unit is configured to acquire a relative behavior of the target vehicle as the liability determination information, and
the potential accident liability information determination unit is configured to sequentially determine the potential accident liability information based on the relative behavior of the target vehicle and an accident liability rule at a position where the potential accident liability information is determined.

4. The potential accident liability determination device according to claim 1, wherein
the liability determination information acquisition unit is configured to acquire the liability determination information from each peripheral vehicle existing around the liability determination vehicle.

5. A potential accident liability determination device, comprising:
at least one processor; and
at least one memory storing computer readable program code, wherein
the computer readable program code, when executed by the at least one processor, causes the potential accident liability determination device to:
acquire liability determination information being information used to determine potential accident liability information indicating whether a liability determination vehicle being a vehicle for which the potential accident liability information is determined is liable for a potentially assumed accident between the liability determination vehicle and a target vehicle selected from surrounding vehicles existing around the liability determination vehicle; and
determine the potential accident liability information based on (i) a preset relationship for determining the potential accident liability information from the liability determination information and (ii) the acquired liability determination information, wherein
the potential accident liability determination device is installed outside of the liability determination vehicle.

6. The potential accident liability determination device according to claim 5, wherein
the computer readable program code further causes the potential accident liability determination device to:
acquire, as the liability determination information, a sensor value that is detected by a sensor provided in the liability determination vehicle and indicates a behavior of the peripheral vehicle;
sequentially determine, based on the sensor value, a relative behavior of the target vehicle selected from the surrounding vehicles with respect to the liability determination vehicle;
acquire an accident liability rule at a position where the potential accident liability information is determined; and
sequentially determine the potential accident liability information based on the relative behavior of the target vehicle and the acquired accident liability rule.

7. The potential accident liability determination device according to claim 5, wherein
the computer readable program code further causes the potential accident liability determination device to:
acquire a relative behavior of the target vehicle as the liability determination information; and
sequentially determine the potential accident liability information based on the relative behavior of the target vehicle and an accident liability rule at a position where the potential accident liability information is determined.

8. The potential accident liability determination device according to claim 5, wherein
the computer readable program code further causes the potential accident liability determination device to acquire the liability determination information from each peripheral vehicle existing around the liability determination vehicle.
